(19) United States
(12) Patent Application Publication
(10) Pub. No.: US 2026/0192463 A1
(43) Pub. Date: Jul. 9, 2026

(54) INFORMATION PROCESSING DEVICE AND NURSING CARE ROBOT CONTROL METHOD

(71) Applicant: Sony Group Corporation, Tokyo (JP)

(72) Inventor: Yoshinao SODEYAMA, Tokyo (JP)

(73) Assignee: Sony Group Corporation, Tokyo (JP)

(21) Appl. No.: 19/128,570

(22) PCT Filed: Feb. 19, 2024
(86) PCT No.: PCT/JP2024/005797

§ 371 Date: May 9, 2025

(30) Foreign Application Priority Data
Mar. 10, 2023 (JP) 2023-037368

(51) Int. Cl. B25J 11/00; A61G 12/00; B25J 9/16

(52) U.S. Cl. CPC B25J 11/009; A61G 12/00; B25J 9/163

(57) ABSTRACT

There is provided an information processing device and a nursing care robot control method capable of appropriately providing a content to a nursing care target person. The information processing device according to an embodiment of the present technology includes: an action control unit that controls at least one of a provision method or a material of a content to be provided in an application for a nursing care robot to care for a nursing care target person on the basis of target person data including data regarding a characteristic of the target person. The present technology can be applied to, for example, a nursing care robot.

### TECHNICAL FIELD

The present technology relates to an information processing device and a nursing care robot control method, and particularly relates to an information processing device and a nursing care robot control method suitable for use in a case of executing various types of care for a nursing care target person.

### CROSS REFERENCE TO RELATED APPLICATIONS

This application claims the benefit of Japanese Priority Patent Application JP 2023-037368 filed on Mar. 10, 2023, the entire contents of which are incorporated herein by reference.

### BACKGROUND ART

Hitherto, a system has been proposed in which a user views a content together with a home device such as a robot according to a situation of the content, a situation of the user, and a preference of the user (see, for example, PTL 1).

In addition, in the future, it is expected that various types of contents will be provided to a nursing care target person such as a dementia patient by using a nursing care robot not only in home but also in a nursing care facility such as a nursing home.

### CITATION LIST

### Patent Literature

PTL 1: JP 2006-245941 A

### SUMMARY OF INVENTION

### Technical Problem

However, a nursing care target person has a large individual difference in cognitive function, physical function, and audiovisual function. In addition, there is a wide range of age groups among the nursing care target persons, and there is a large individual difference in preference for contents. Moreover, a state of the nursing care target person changes over time, and there is a large difference between time zones and days. Therefore, in a technology according to the related art, it is difficult to provide an appropriate content to a nursing care target person.

The present technology has been made in view of such a situation, and it is desirable to appropriately provide a content to a nursing care target person.

### Solution to Problem

An information processing device according to one aspect of the present technology includes: an action control unit that controls at least one of a provision method or a material of a content to be provided in an application for a nursing care robot to care for a nursing care target person on the basis of target person data including data regarding a characteristic of the target person.

A nursing care robot control method according to one aspect of the present technology includes: controlling at least one of a provision method or a material of a content to be provided in an application for a nursing care robot to care for a nursing care target person on the basis of target person data including data regarding a characteristic of the target person.

In one aspect of the present technology, at least one of a provision method or a material of a content to be provided in an application for a nursing care robot to care for a nursing care target person is controlled on the basis of target person data including data regarding a characteristic of the target person.

### BRIEF DESCRIPTION OF DRAWINGS

FIG. 1 is a front view and a left side view of a nursing care robot to which the present technology is applied.

FIG. 2 is a rear view of the nursing care robot.

FIG. 3 is a perspective view of the nursing care robot as viewed in a diagonally front right direction.

FIG. 4 is a perspective view of the nursing care robot as viewed in a diagonally rear left direction.

FIG. 5 is a diagram comparing sizes of the nursing care robot and a general table.

FIG. 6 is an enlarged view of a head portion of the nursing care robot.

FIG. 7 is an exploded view illustrating an internal configuration example of an eyeball portion of the nursing care robot.

FIG. 8 is an external view of an arm portion of the nursing care robot.

FIG. 9 is an external view of a hand of the nursing care robot.

FIG. 10 is a front view of the nursing care robot on which a hand display is mounted.

FIG. 11 is a right side view of the nursing care robot on which the hand display is mounted.

FIG. 12 is an external view of an upper body of the nursing care robot on which the hand display is mounted.

FIG. 13 is a block diagram schematically illustrating a configuration example of a robot operation system to which the present technology is applied.

FIG. 14 is a block diagram schematically illustrating functional configurations of the nursing care robot and a controller.

FIG. 15 is a block diagram schematically illustrating a functional configuration of a server.

FIG. 16 is a view illustrating an example of arrangement of a table and a chair in a living room.

FIG. 17 is a view illustrating the example of arrangement of the table and the chair in the living room.

FIG. 18 is a view illustrating an example of a movement position of the nursing care robot.

FIG. 19 is a flowchart illustrating a basic flow of application execution processing executed by the nursing care robot.

FIG. 20 is a view for describing an example of a method of presenting image information by the hand display of the nursing care robot.

FIG. 21 is a view for describing the example of the method of presenting image information by the hand display of the nursing care robot.

FIG. 22 is a view for describing the example of the method of presenting image information by the hand display of the nursing care robot.

FIG. 23 is a flowchart for describing a specific example of the application execution processing executed by the nursing care robot.

FIG. 24 is a flowchart for describing the specific example of the application execution processing executed by the nursing care robot.

FIG. 25 is a diagram illustrating examples of a type of a content.

FIG. 26 is a flowchart for describing a first embodiment of content provision processing.

FIG. 27 is a flowchart for describing details of branching interaction motion processing,

FIG. 28 is a flowchart for describing a second embodiment of the content provision processing.

FIG. 29 is a flowchart for describing a specific example of the content provision processing.

FIG. 30 is a diagram for describing an example of a method of handing over a user database.

FIG. 31 is a diagram for describing the example of the method of handing over the user database.

FIG. 32 is a diagram for describing a middle-term development example of the user database.

FIG. 33 is an external view schematically illustrating a first modification of the hand of the nursing care robot.

FIG. 34 is an external view schematically illustrating the first modification of the band of the nursing care robot.

FIG. 35 is an external view schematically illustrating the first modification of the hand of the nursing care robot.

FIG. 36 is an external view schematically illustrating a second modification of the hand of the nursing care robot.

FIG. 37 is an external view schematically illustrating a third modification of the hand of the nursing care robot.

FIG. 38 is an external view schematically illustrating the third modification of the hand of the nursing care robot.

FIG. 39 is a view illustrating an example of installation of a sensor in the third modification of the hand of the nursing care robot.

FIG. 40 is an external view schematically illustrating a fourth modification of the hand of the nursing care robot.

FIG. 41 is an external view schematically illustrating a fifth modification of the hand of the nursing care robot.

FIG. 42 is an external view schematically illustrating a sixth modification of the hand of the nursing care robot.

FIG. 43 is an external view schematically illustrating a seventh modification of the hand of the nursing care robot.

FIG. 44 is a front view of the nursing care robot on which the hand display is mounted.

FIG. 45 is a diagram for illustrating an outline of the present technology.

FIG. 46 is a block diagram illustrating a configuration example of a remote operation control system to which the present technology is applied.

FIG. 47 is a block diagram illustrating a functional configuration example of the robot.

FIG. 48 is a block diagram illustrating a configuration example of an appearance of the robot.

FIG. 49 is a block diagram illustrating a functional configuration example of the server.

FIG. 50 is a flowchart for describing processing in the robot.

FIG. 51 is a flowchart for describing details of task execution control processing.

FIG. 52 is a flowchart for describing processing in the server.

FIG. 53 is a view for describing an example in which the robot executes an action of measuring a vital value of a nursing care target person.

FIG. 54 is a diagram for describing an example in which the robot executes the action of measuring the vital value of the nursing care target person.

FIG. 55 is a diagram for describing an example in which the robot executes the action of measuring the vital value of the nursing care target person.

FIG. 56 is a diagram for describing an example in which the robot executes the action of measuring the vital value of the nursing care target person.

FIG. 57 is a diagram illustrating a calculation formula of an operation effect of the remote operation control system.

FIG. 58 is a diagram illustrating an example of calculation of the operation effect of the remote operation control system.

FIG. 59 is a block diagram illustrating a configuration example of a computer.

### DESCRIPTION OF EMBODIMENTS

Hereinafter, embodiments of the present technology will be described in detail with reference to the drawings. Note that, the description will be given in the following order.
0. Background of First Embodiment of Present Technology
1. First Embodiment of Present Technology
2. Modifications of First Embodiment of Present Technology
3. Background of Second Embodiment of Present Technology
4. Second Embodiment of Present Technology
5. Modifications of Second Embodiment of Present Technology
6. Others

### 0. Background of First Embodiment of Present Technology

First, a background of a first embodiment of the present technology will be described.

In a nursing care facility such as a nursing home for the aged, for example, a nursing care target person (hereinafter, simply referred to as the target person or user) tends to be mentally unstable during a time for which a staff is absent in a living room and a time for which the target person such as a dementia patient waits, which are mainly caused by a labor shortage. For example, the target person tends to be restless, feel lonely, or angry.

In addition, since a work load is high, it is difficult for a care worker to individually execute various types of care such as music therapy and conversation for the purpose of preventing the progression of dementia of the target person, preventing an instable state, improving the quality of life (QOL), and the like in a sufficiently long time. Moreover, in the nursing care facility, an activity for improving the QOL of the target person is insufficient due to a labor shortage, limitation of meeting due to COVID-19 pandemnic, and the like.

On the other hand, for example, even in a case of reproducing only music by using karaoke, a music player, a TV, a tablet terminal, or the like as music therapy, it is difficult for a dementia patient to accept the music therapy as described above. On the other hand, although it is also possible to describe a musical piece with a video, it is difficult for a dementia patient to perceive an entity in the video as a conversation partner.

In addition, it is also difficult for a dementia patient to operate a video phone or the like by himself/herself.

On the other hand, the present technology can improve acceptability for the target person with respect to various types of care such as music therapy by a nursing care robot.

Specifically, for example, as will be described later, the nursing care robot executes an application for caring for the target person by using humanitude. For example, the nursing care robot executes physical humanitude and cognitive humanitude before caring for the target person.

The physical humanitude is a physical approach in which a physical distance between the nursing care robot and the target person is gradually reduced.

The cognitive humanitude is a cognitive approach in which a cognitive distance of the target person to a content provided in the application for caring for the target person is gradually reduced.

Here, the content provided to the target person includes specific care to be executed on the target person and a content used for care. Examples of the content used for care include a moving image in music therapy, a content such as a musical piece, and a device used for care. Furthermore, for example, the content may be provided to the target person by the nursing care robot itself executing the content, or the content may be provided to the target person by the nursing care robot presenting the content.

### 1. First Embodiment of Present Technology

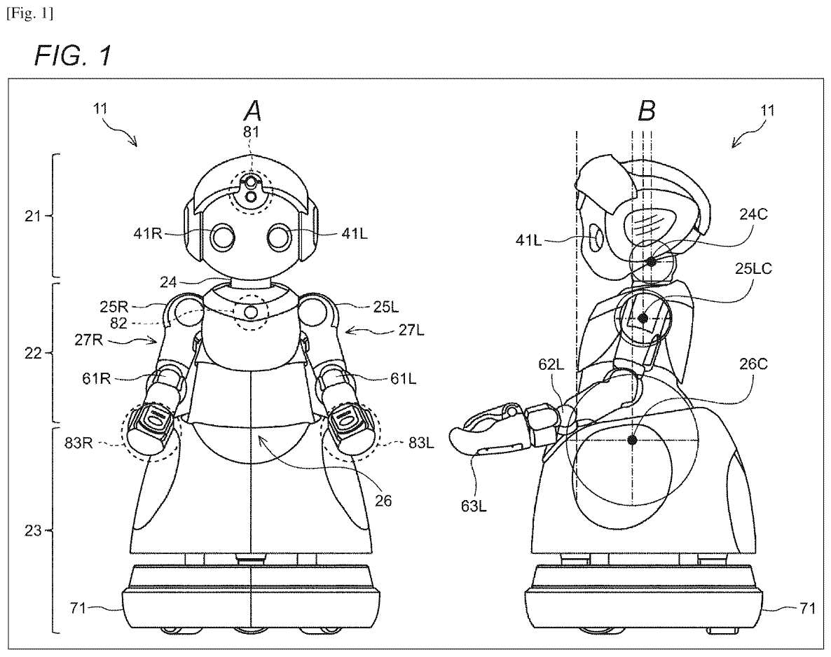

Next, the first embodiment of the present technology will be described with reference to FIGS. 1 to 32.

### Configuration Example of Nursing Care Robot 11

First, a configuration example of a nursing care robot 11 according to an embodiment of the present technology will be described with reference to FIGS. 1 to 12.

The nursing care robot 11 is a humanoid mobile manipulator robot capable of executing various applications for various types of care, state observation, communication, peripheral tasks, and the like with highly acceptable quality to the target person.

For example, the nursing care robot 11 executes various applications for executing a care action according to a scheduler created based on determination by a care staff and individual setting of robot operation for each target person. Examples of the application that can be executed by the nursing care robot 11 include greeting the target person, relaxing the target person, vital measurement, music therapy, a phone call, and the like. The nursing care robot 11 is configured to be able to execute an application aiming at an effect of preventing an instable state of the target person and adjusting daily rhythm.

### Configuration Example of Appearance of Nursing Care Robot 11

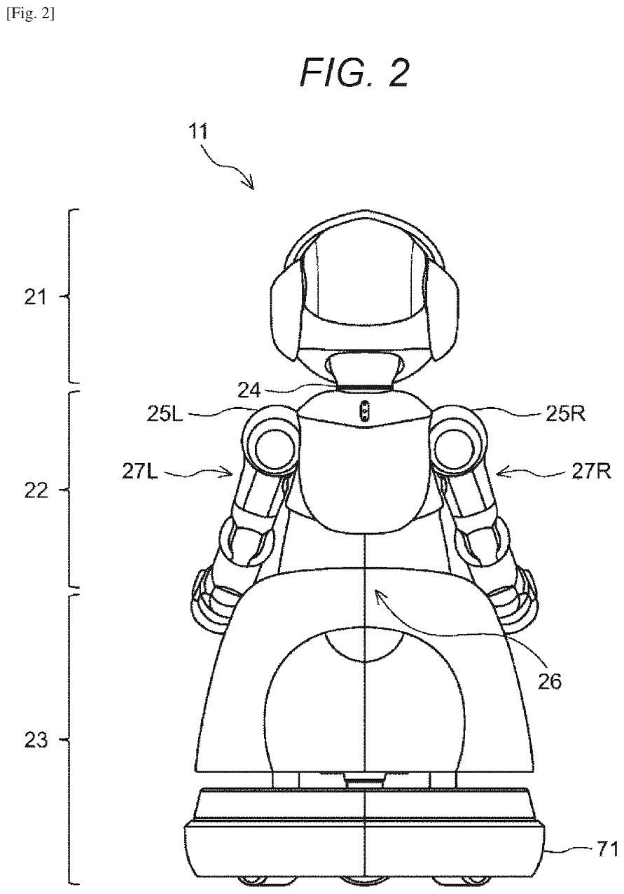

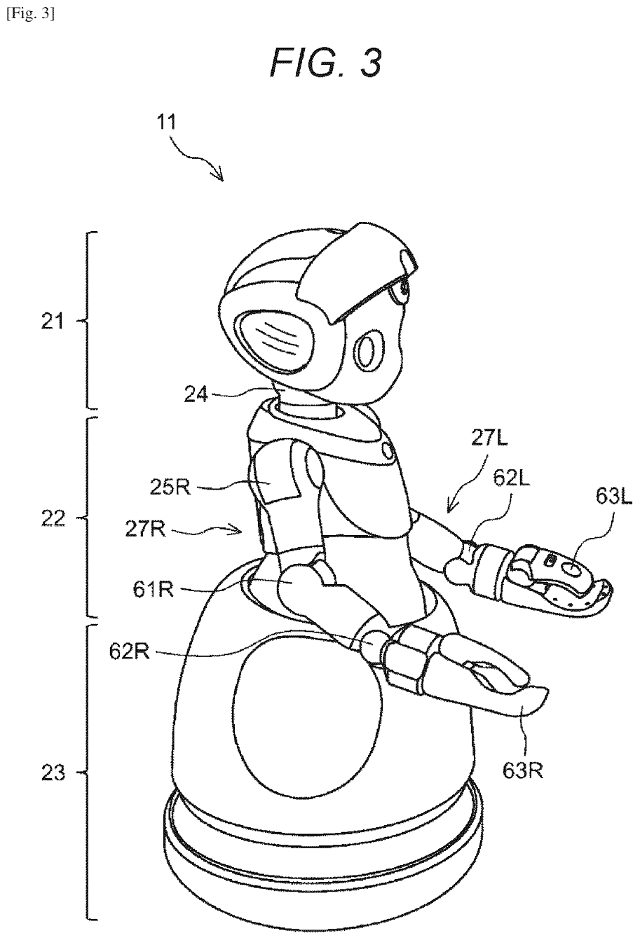

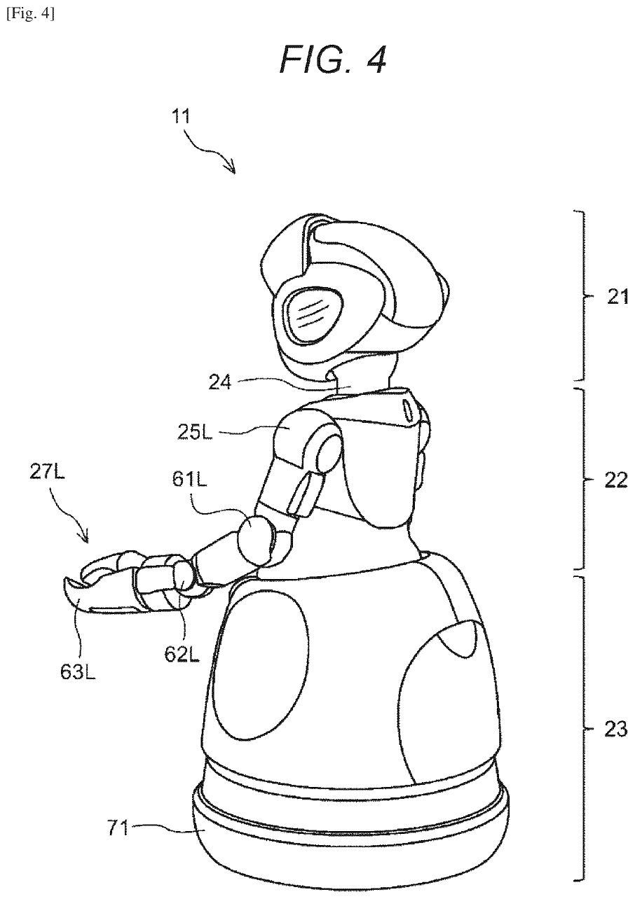

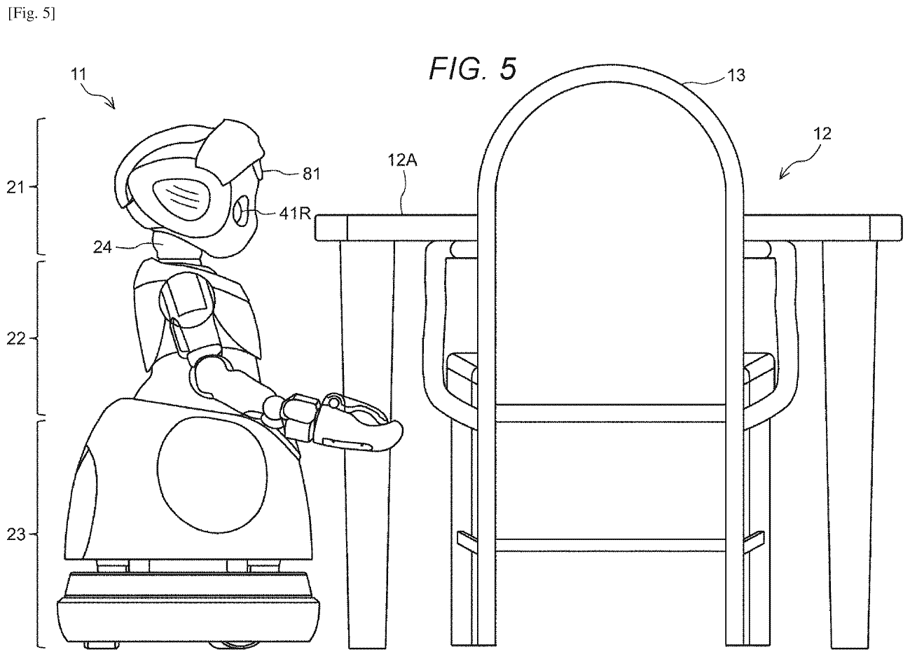

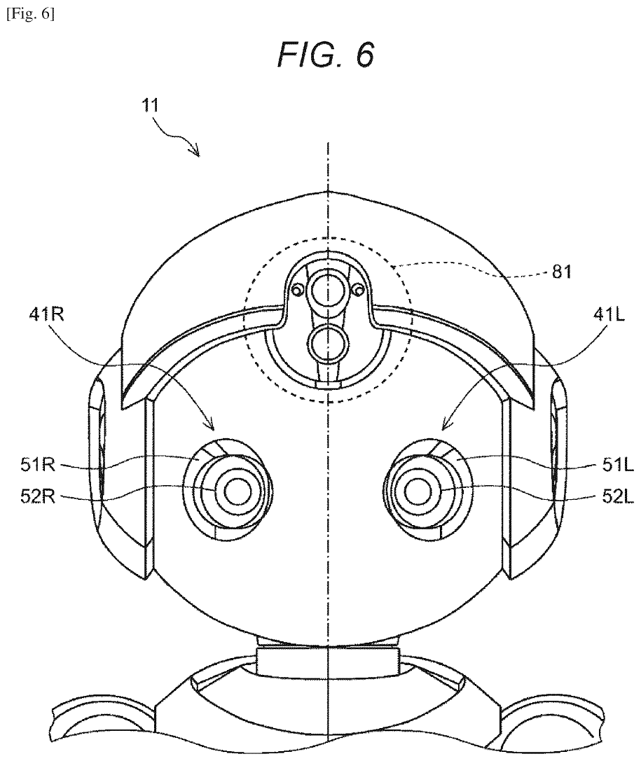

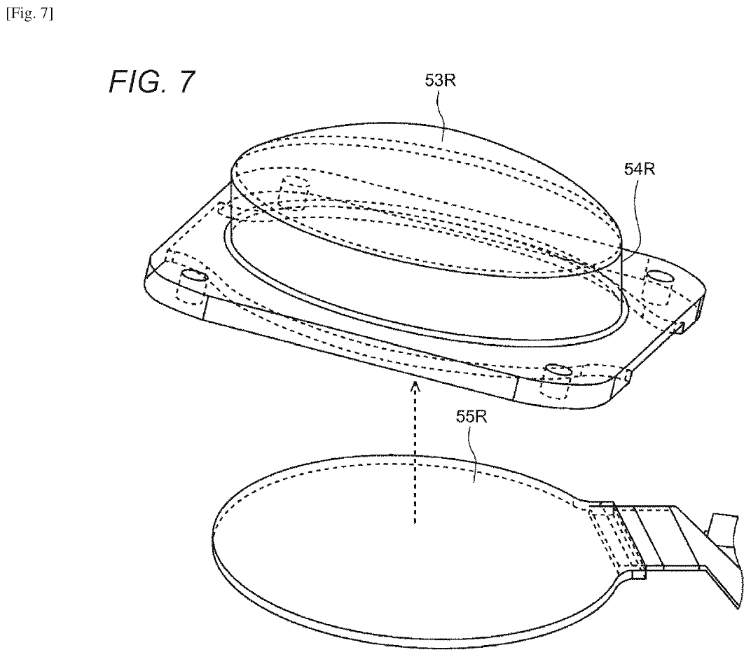

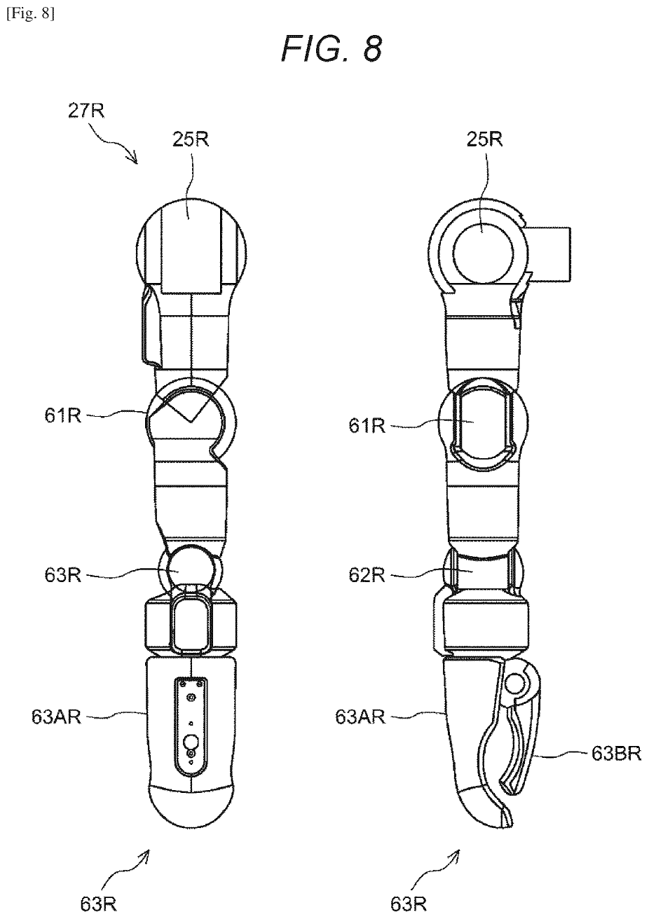

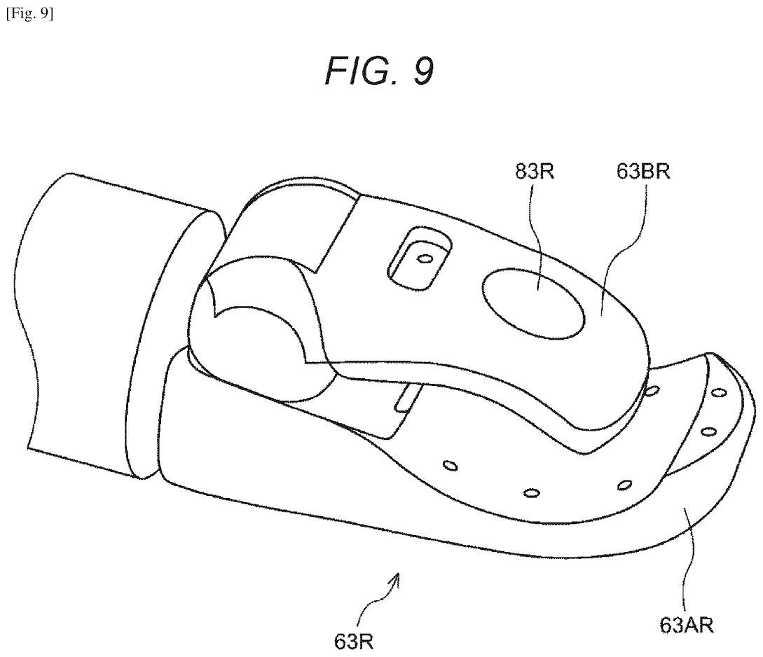

FIGS. 1 to 9 illustrate a configuration example of the appearance of the nursing care robot 11 and the like. A of FIG. 1 is a front view of the nursing care robot 11. B of FIG. 1 is a left side view of the nursing care robot 11 FIG. 2 is a rear view of the nursing care robot 11. FIG. 3 is a perspective view of the nursing care robot 11 as viewed in a diagonally front right direction. FIG. 4 is a perspective view of the nursing care robot 11 as viewed in a diagonally rear left direction. FIG. 5 is a diagram comparing sizes of the nursing care robot 11 and a general table 12. FIG. 6 is an enlarged view of a head portion 21 of the nursing care robot 11. FIG. 7 is an exploded view illustrating an internal configuration example of an eyeball portion 41R of the nursing care robot 11. FIG. 8 is an external view of an arm portion 27R of the nursing care robot 11. FIG. 9 is an external view of a hand 63R of the nursing care robot 11.

The nursing care robot 1 has an appearance modeled on a child, for example, on the basis of a concept of a grandchild robot.

The nursing care robot 11 includes the head portion 21, a chest portion 22, and a base portion 23 that supports the chest portion 22. The base portion 23 includes, for example, a carriage 71 that is movable in all directions and is provided at a lower portion of the base portion 23. As a result, the nursing care robot 11 can move in all directions.

The nursing care robot 11 includes an arm portion 271L attached to an upper-left portion of the chest portion 22, and the arm portion 27R attached to an upper-right portion of the chest portion 22. The nursing care robot 11 includes a movable neck 24 provided between the head portion 21 and the chest portion 22 and including a neck joint shaft 24C. The nursing care robot 11 includes a movable shoulder 25L provided between the chest portion 22 and the arm portion 27L and including a shoulder joint shaft 25LC, and a movable shoulder 25R provided between the chest portion 22 and the arm portion 27R and including a shoulder joint shaft 25RC. In addition, the nursing care robot 11 includes a movable waist 26 provided tinder the chest portion 22 and including a waist joint shaft 26C.

The height of the nursing care robot 11 is a height at which the target person in a sitting posture in which the target person is sitting on a chair can look down the nursing care robot 11. In addition, as illustrated in FIG. 5, the height of the nursing care robot 11 is a height at which the general table 12 can be viewed from above.

As illustrated in FIG. 6, the head portion 21 includes an eyeball portion 41L and the eyeball portion 41R. The eyeball portion 41L includes a white portion 51L and a black portion 52L arranged in the white portion 51L. Similarly to the eyeball portion 41L, the eyeball portion 41R includes a white portion 51R and a black portion 52R arranged in the white portion 51R.

As illustrated in FIG. 7, the eyeball portion 41R includes a transparent solid cylindrical portion 54R having a first end surface and a second end surface. The eyeball portion 41R includes a flat eyeball display 55R that is provided on a first end surface side (a lower side in FIG. 7) of the cylindrical portion 54R and displays a motion of the black portion 52R. The eyeball portion 41 includes a hemispherical transparent spherical portion 53R that is provided on a second end surface side (an upper side in FIG. 7) of the cylindrical portion 54R and emits display light from the eyeball display 55R incident via the cylindrical portion 54R. The spherical portion 53R is configured as a hemispherical transparent spherical lens. An outer peripheral shape of the spherical portion 53R is configured as the white portion 51R.

An outer peripheral surface of the cylindrical portion 54R is non-transmissive to prevent light from entering, and a display image of the eyeball display 55R viewed through the spherical portion 53R becomes clear without distortion. Further, since the spherical portion 53R is arranged in such a way as to be spaced apart from the eyeball display 55R, three-dimensionality for a sense of depth is obtained. Furthermore, the center of the sphere of the spherical portion 53R is designed as the virtual rotation center of the eyeball, and the motion of the black portion 52R displayed on the eyeball display 55R is controlled with reference to the center of the sphere of the spherical portion 53R.

As described above, unlike the flat display, the eyeball portion 42R is displayed on a built-in sphere having good visibility from any angle, or appears to be moving, and can implement likeness to an actual eyeball without distortion. In addition, the center of the black portion 52R matches the center of the sphere of the spherical portion 53R, and there is no discomfort in the thickness and shape of the spherical surface. Moreover, reflected light of ambient light is reflected on the surface of the spherical portion 53R, whereby highlight of a pupil is naturally expressed in real time.

Although not illustrated, the eyeball portion 41L also includes a spherical portion 53L, a cylindrical portion 54L, and an eyeball display 55L, and is configured to be bilaterally symmetrical with the eyeball portion 41R.

For example, the nursing care robot 11 performs human recognition and face recognition by using a head sensor 81, and controls the position of the black portion 52L of the eyeball portion 41L, the position of the black portion 52R of the eyeball portion 41R, and the axis of the neck 24 (roll, pitch, and yaw) to gaze at the target person. Specifically, the black portion 521L and the black portion 52R vertically and horizontally follow the position of the target person to gaze at the target person. In addition, a distance to the target person is expressed using a convergence angle (esotropia or exotropia) between the black portion 521 and the black portion 52R. As a result, the target person can easily recognize where a line-of-sight of the nursing care robot 11 is directed (particularly also in a depth direction).

Note that, hereinafter, in a case where it is not necessary to individually distinguish the eyeball portion 41L and the eyeball portion 41R, they are simply referred to as the eyeball portion 41. In a case where it is not necessary to individually distinguish the white portion 51L and the white portion 51R, they are simply referred to as the white portion 51. In a case where it is not necessary to individually distinguish the black portion 52L and the black portion 52R, they are simply referred to as the black portion 52. In a case where it is not necessary to individually distinguish the spherical portion 53L and the spherical portion 53R, they are simply referred to as the spherical portion 53. In a case where it is not necessary to individually distinguish the cylindrical portion 54L and the cylindrical portion 54R, they are simply referred to as the cylindrical portion 54. In a case where it is not necessary to individually distinguish the eyeball display 55L and the eyeball display 55R, they are simply referred to as the eyeball display 55.

As illustrated in FIG. 8, the arm portion 277R includes an elbow portion 61R, a wrist 62R, and the hand 63R. The elbow portion 611R has a pitch axis. The wrist 62R has a yaw axis.

The hand 63R includes a part 63AR corresponding to a portion other than a thumb and a part 63BR corresponding to the thumb. The part 63BR faces the part 63AR and is movable, so that an object can be pinched by the hand 63R.

Note that, although not illustrated, the arm portion 27L is configured similarly to the arm portion 27R, and includes an elbow portion 61L, a wrist 62L, and a hand 63L. Furthermore, similarly to the hand 63R, the hand 63L includes a part 63A L and a part 63BL.

In addition, hereinafter, in a case where it is not necessary to individually distinguish the arm portion 27L and the arm portion 27R, they are simply referred to as the arm portion 27. Hereinafter, in a case where it is not necessary to individually distinguish the elbow portion 611L and the elbow portion 61R, they are simply referred to as the elbow portion 61. Hereinafter, in a case where it is not necessary to individually distinguish the wrist 62L and the wrist 62R, they are simply referred to as the wrist 62. Hereinafter, in a case where it is not necessary to individually distinguish the hand 63L and the hand 63R, they are simply referred to as the hand 63.

The head sensor 81 is provided at an upper front portion of the head portion 21. The head sensor 81 includes, for example, a distance image sensor, a microphone, a light detection and ranging (LiDAR), and the like.

The head sensor 81 is configured in such a way that a sensing direction is substantially the same as a line-of-sight direction of the nursing care robot 11 to enable execution of a humanitude motion, execution of a face tracking motion, and the like.

For example, the nursing care robot 11 can perform human recognition and face recognition by the head sensor 81, and can perform an interaction in which the pupil of the target person is tracked.

Here, the height of the general table 12 is, for example, about 700 mm, and the height of the general table 12 of the nursing care facility is, for example, about 660 mm. For example, as illustrated in FIG. 5, the head sensor 81 is arranged at a position where a top plate 12A of the table 12 can be viewed from above. The head portion 21 is arranged at a position to look up the face of the target person in a state where the target person is sitting on a chair 13 (sitting posture). The head sensor 81 is installed in such a way as to face upward by, for example, about 5 degrees at a high position (for example, the position of about 760 mm in height) of the head portion 21. Furthermore, the head sensor 81 is arranged in such a way as not to protrude too much from an outer diameter line of the head portion 21.

As a result, for example, as illustrated in FIG. 5, the nursing care robot 11 can recognize an object on the standard table 12 and recognize the face of the target person in a sitting posture over the table 12. The nursing care robot 11 can recognize the face of the target person in a sitting posture on a standard bed or the face of the target person in an upward facing posture on the standard bed. The nursing care robot 11 can perform face recognition at an angle for looking up the close target person in a sitting posture, face recognition at an angle for looking up the close target person in a standing posture, and the like.

A chest sensor 82 is provided at an upper front portion of the chest portion 22. The chest sensor 82 includes, for example, a non-contact type vital sensor. Examples of the non-contact type vital sensor include a body temperature sensor, a heart rate sensor, and a respiration sensor.

The chest sensor 82 is installed in such a way as to face upward by, for example, about 10 degrees at a position (for example, a position of a height of about 537 mm) at the upper front portion of the chest portion 22. Therefore, the chest sensor 82 can perform measurement without being affected by a motion of the head portion 21. The chest sensor 82 can reduce the occurrence of blind spots due to the arm portion 27 during manipulation. The chest sensor 82 can perform vital sensing from the face of the target person in a sitting posture, the face of the distant target person (for example, about 2 m) in a standing posture, the face of the close target person in an upward facing posture, and the like. The chest sensor 82 can constantly sense a state change of the target person during execution of the application.

A hand sensor 83R is provided in the hand 63R. The hand sensor 83R includes, for example, a contact type vital sensor or the like. Examples of the contact type vital sensor include a heart rate sensor, a blood pressure sensor, and an oxygen saturation measurement sensor.

For example, as illustrated in FIG. 9, the hand sensor 83R is arranged on an outer side of the part 63BR of the hand 63R. Therefore, the hand 63R is prevented from pinching the hand of the target person at the time of vital sensing.

In addition, vital sensing can be performed in a manner in which the target person places his/her hand on or holds the hand sensor 83R, instead of a manner in which the nursing care robot 11 touches the target person with the hand sensor 83R by itself. This is an interface familiar to a dementia patient, and acceptability for the target person is high. In addition, a sensor or the like for gripping force control can be separately provided inside the hand 63R.

Note that, although not illustrated, a hand sensor 83L including a vital sensor similar to the hand sensor 83R is provided on an outer side of the part 63BL of the hand 63L.

Note that, hereinafter, in a case where it is not necessary to individually distinguish the hand sensor 83L and the hand sensor 83R, they are simply referred to as the hand sensor 83.

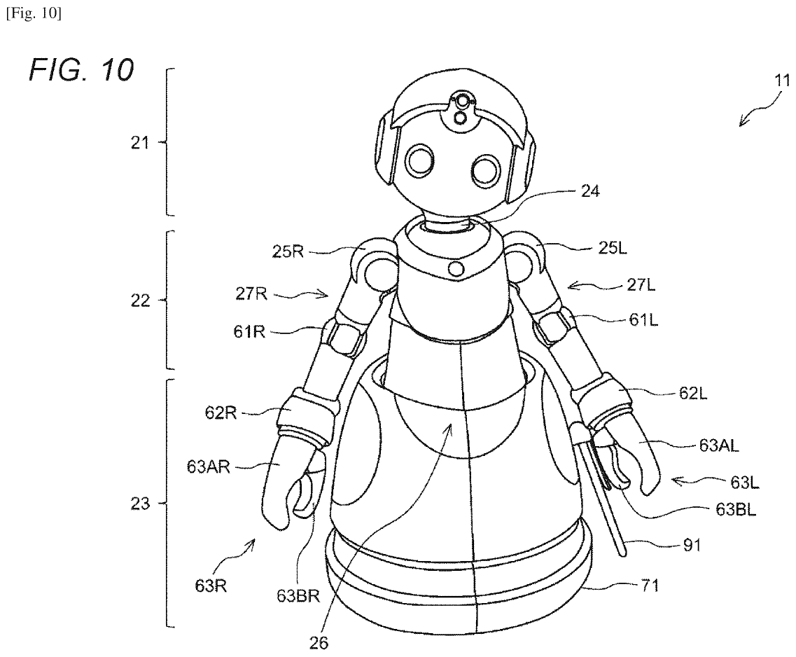

As illustrated in FIGS. 10 to 12, a hand display 91 can be mounted on the hand 63L of the nursing care robot 11. The hand display 91 is mounted on an outer side of the part 63BL of the hand 63L, for example. The hand display 91 includes, for example, an 8-inch display unit.

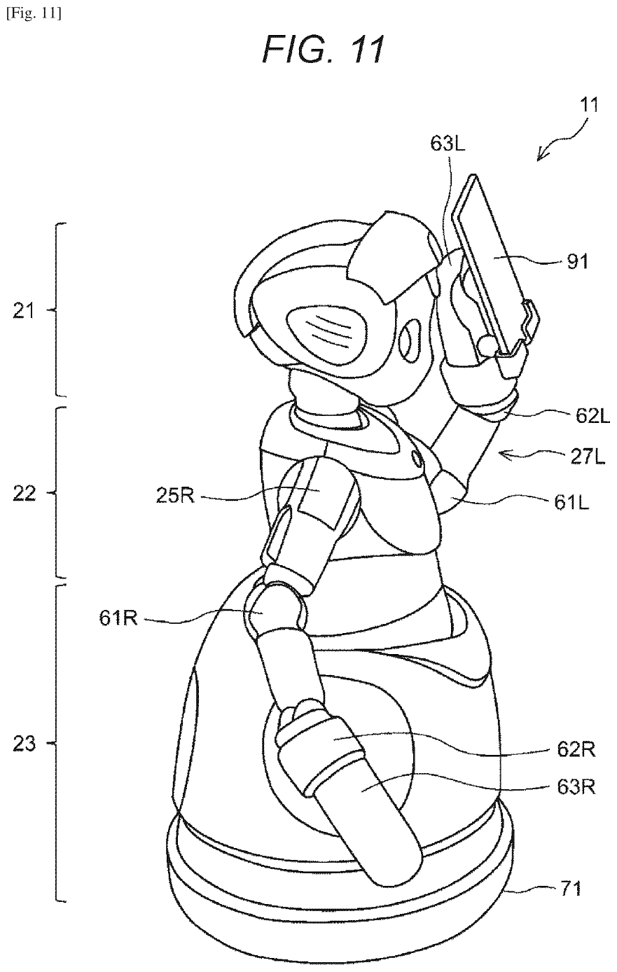

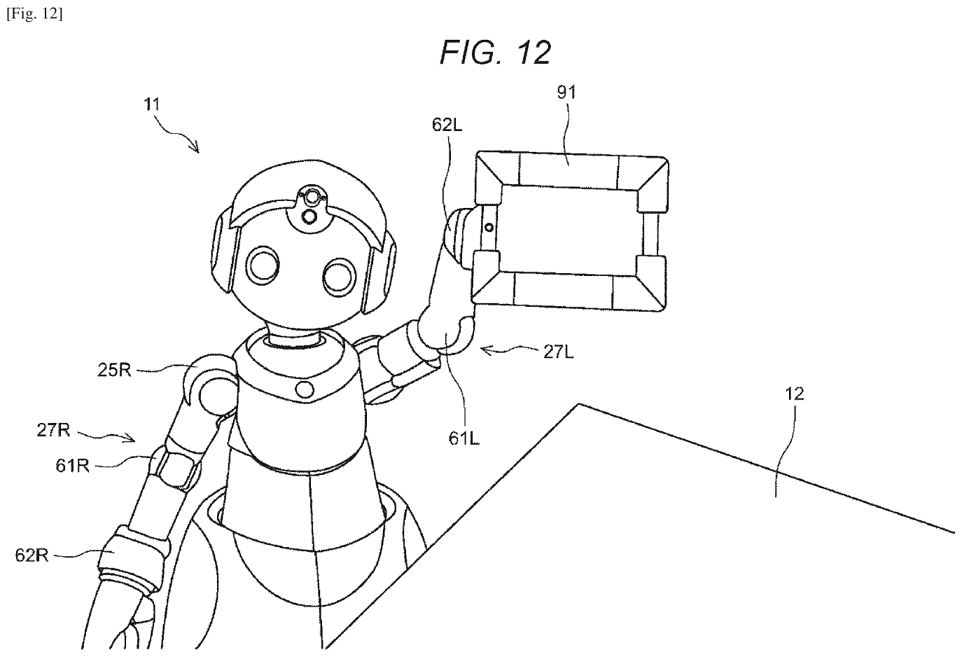

For example, as illustrated in FIGS. 11 and 12, the nursing care robot 11 controls the movable axis of the arm portion 27L to perform tracking control in such a way that a screen of the hand display 91 faces the head of the target person. As a result, the hand display 91 can be moved to a position where the target person can easily view regardless of the sitting posture of the target person.

Note that, although not illustrated, the hand display 91 can also be mounted on the hand 63R of the nursing care robot 11.

In addition, for example, a handle type gripping portion may be provided on a back surface of the hand display 91, and the nursing care robot 11 may grip the hand display 91 with the hand 63L or the hand 63R.

As described above, the nursing care robot 11 has a realistic feeling corresponding to a 2-year-old child, is appropriately small, and has a size at which an elderly person in a sitting position can look down the nursing care robot 11. The form of the nursing care robot 11 has a large head and a shape similar to that of a cute grandchild. The eyeball portion 41 is arranged at a height at which the eyeball portion 41 easily meets the eyes of the target person, so that the target person can easily recognize the line-of-sight or an image displayed on the eyeball portion 41. Since the nursing care robot 11 does not have an axis with the degree of freedom and a movable range different from those of a human, the motion of the nursing care robot 11 is natural, and the target person can easily understand the motion of the nursing care robot 11.

The head portion 21 is arranged at a height at which the general table 12 can be viewed from above, and the shoulder 25 is high enough and the arm portion 27 is long enough to approach an end portion of the general table 12.

Therefore, the nursing care robot 11 is easily accepted without giving the target person a sense of intimacy and a sense of fear. Furthermore, the nursing care robot 11 can execute the humanitude motion or execute a basic application in an active watching robot, for example.

### Configuration Example of Robot Operation System 101

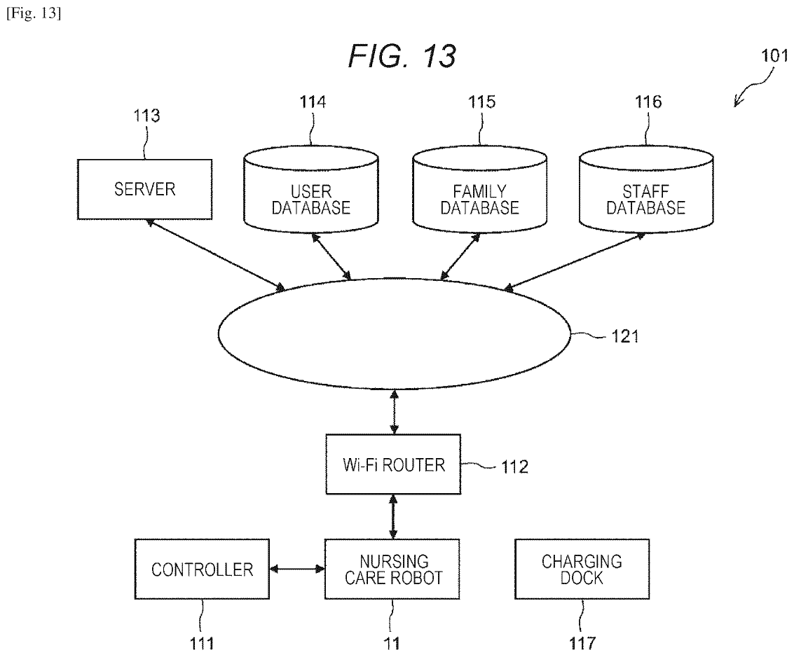

FIG. 13 illustrates a configuration example of a robot operation system 101 that operates the above-described nursing care robot 11.

The robot operation system 101 includes the nursing care robot 11, a controller 111, a Wi-Fi router 112, a server 113, a user database 114, a family database 115, a staff database 116, and a charging dock 117. The Wi-Fi router 112, the server 113, the user database 114, the family database 115, and the staff database 116 are interconnected via a network 121.

The nursing care robot 11 receives data (hereinafter, referred to as target person data) including data regarding a characteristic of each target person via the network 121 and the Wi-Fi router 112. The nursing care robot 11 controls an application execution method and a material of a content to be provided to each target person on the basis of the target person data. The application execution method includes a provision method of the content.

The nursing care robot 11 learns the characteristic of each target person on the basis of a reaction or the like of each target person at the time of execution of the application, and transmits information indicating a learning result (hereinafter, referred to as characteristic learning information) to the server 113 via the Wi-Fi router 112 and the network 121.

The controller 111 is a robot controller device that can be carried by or worn by the staff of the nursing care facility. The controller 111 is used, for example, to set an individual operation parameter for each target person at the time of execution of each application and schedule information of each application. Note that a plurality of controllers 111 may be provided, and a plurality of staffs may carry or wear the controllers 111.

The Wi-Fi router 112 is arranged in the nursing care facility and is used by the nursing care robot 11 to connect to the network 121. Note that a plurality of Wi-Fi routers 112 may be arranged in the nursing care facility.

The server 113 executes processing such as learning of the characteristic of each target person, provision of the target person data of each target person to the nursing care robot 11, and management of the user database 114, the family database 115, and the staff database. The server 113 links the user database 114, the family database 115, and the staff database 116. As a result, the user database 114, the family database 115, and the staff database 116 are updated with the latest data, or consistency is established between the databases.

The user database 114 is a database that stores the target person data including data regarding an attribute of each target person (hereinafter, referred to as attribute data), identification information, and data regarding the characteristic (hereinafter, referred to as characteristic data).

Examples of the attribute data include an identification number, a name, an appellation (for example, a name, a nickname, or the like), an age, a sex, and the like of each target person.

The identification information includes information for identifying each target person. For example, the identification information includes image data of the face of each target person or a feature amount extracted from the image data. The identification information may be used for authentication of each target person.

The characteristic data includes, for example, data regarding a taste, a preference, a feature, a personality, a temperament, a state (including a health state), a medical history, a behavior history, and the like of each target person.

For example, the characteristic data includes data regarding a preference of each target person for a content. The data regarding the preference for the content includes, for example, one or more of the type of a content preferred by each target person, a history of providing a content to each target person, and a reaction of each target person to a provided content.

For example, the characteristic data includes an operation parameter of the application for each target person. The application execution method (including the provision method of the content) for each target person is controlled by the operation parameter. The operation parameter includes, for example, one or more of whether or not conversation is possible, whether or not body contact is possible, a feature amount of an uttered voice of the nursing care robot 11 at the time of execution of the application, an interaction speed, a gaze fixation region, a motion speed, a relative position with respect to the target person, and the size of a character to be displayed on the hand display 91. The feature amount of the uttered voice includes, for example, one or more of a volume, a speed, and a pitch. The interaction speed includes, for example, an interaction interval (an interval between the previous utterance and the next utterance). The gaze fixation region includes, for example, one or more of the face orientation and the line-of-sight direction of the nursing care robot 11. The operation speed includes, for example, at least one of a movement speed of the nursing care robot 11 or a speed for moving each portion. The relative position with respect to the target person includes, for example, an approachable distance and a relative direction.

The family database 115 is a database created or used by a family member of each target person, and stores the target person data of each target person.

Note that the family database 115 is provided for each family member of each target person, for example.

The staff database 116 is a database created or used by the staff of the nursing care facility, and stores the target person data of each target person.

Note that the numbers of items and the types of items of the target person data of each target person stored in the user database 114, the family database 115, and the staff database 116 do not necessarily have to match.

The charging dock 117 is arranged in the nursing care facility and is used for standby charging of power of the nursing care robot 11. Note that a plurality of charging docks 117 may be arranged in the nursing care facility.

The network 121 is implemented by a local area network (LAN) or the like and is arranged in the nursing care facility or the like. Various communication devices and information processing devices such as the nursing care robot 11 and the server 113 are connected to the network 121. In addition, the nursing care robot 11 and the server 113 can communicate with the outside of the nursing care facility via the network 121.

### Functional Configuration Examples of Nursing Care Robot 11 and Controller 111

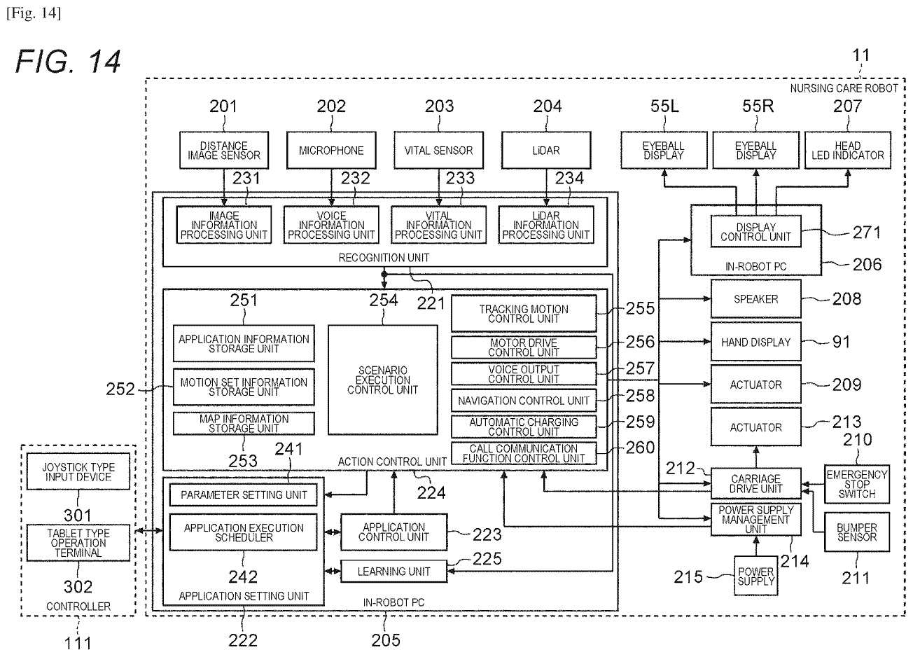

FIG. 14 schematically illustrates functional configuration examples of the nursing care robot 11 and controller 111 described above.

The nursing care robot 11 includes, in addition to the eyeball display 55L, the eyeball display 55R, and the hand display 91 described above, a distance image sensor 201, a microphone 202, a vital sensor 203, a LiDAR 204, an in-robot personal computer (PC) 205, an in-robot PC 206, a head portion light emitting diode (LED) indicator 207, a speaker 208, an actuator 209, an emergency stop switch 210, a bumper sensor 211, a carriage drive unit 212, an actuator 213, a power supply management unit 214, and a power supply 215.

The distance image sensor 201 is provided, for example, in the head sensor 81 of the nursing care robot 11. The distance image sensor 201 images the surroundings of the nursing care robot 11 and supplies distance image data obtained by imaging to the in-robot PC 205. The distance image data indicates, for example, a captured image and a depth value (distance) of each pixel.

Note that the distance image sensor 201 may include a plurality of sensors. For example, the distance image sensor 201 may include two types of sensors, an image sensor and a distance sensor. In this case, for example, the image sensor is provided in the head sensor 81, and the distance sensor is provided in the head sensor 81 or the chest sensor 82.

The microphone 202 is provided, for example, in the head sensor 81 of the nursing care robot 11. The microphone 202 collects a voice around the nursing care robot 11 and supplies voice data indicating the collected voice to the in-robot PC 205.

The vital sensor 203 is provided in, for example, the chest sensor 82 and the hand sensor 83 of the nursing care robot 11. The vital sensor 203 includes, for example, one or more sensors that measure vital values of the target person, such as a body temperature, a heart rate, SpO2, a blood pressure, and a respiratory rate. The vital sensor 203 supplies the vital data indicating a vital value measurement result to the in-robot PC 205.

The LiDAR 204 is provided, for example, in the head sensor 81 of the nursing care robot 11. The LiDAR 204 detects a distance to each point around the nursing care robot 11, generates point cloud data indicating a detection result, and supplies the point cloud data to the in-robot PC 205.

The in-robot PC 205 includes, for example, a computer including a central processing unit (CPU), a read only memory (ROM), a random access memory (RAM), and the like. The in-robot PC 205 controls each unit of the nursing care robot 11 and executes various types of processing. The in-robot PC 205 includes a recognition unit 221, an application setting unit 222, an application control unit 223, an action control unit 224, and a learning unit 225.

The recognition unit 221 executes target person recognition (identification) processing and processing of recognizing a state of each target person and a state around the nursing care robot 11 on the basis of information detected by various sensors of the nursing care robot 11. For example, the recognition unit 221 recognizes a reaction of each target person at the time of execution of the application. The recognition unit 221 includes an image information processing unit 231, a voice information processing unit 232, a vital information processing unit 233, and a LiDAR information processing unit 234.

The image information processing unit 231 executes various types of image processing on the basis of the distance image data, and recognizes the state of each target person and the state around the nursing care robot 11. For example, the image information processing unit 231 executes processing of detecting the position, the shape, the type, the motion, or the like of an object around the nursing care robot 11. For example, the image information processing unit 231 executes authentication processing for a person around the nursing care robot 11, line-of-sight or face orientation detection processing, gesture detection processing, facial expression recognition processing, state recognition processing, and the like. The image information processing unit 231 supplies information indicating a result of the image processing to the action control unit 224 and the learning unit 225.

The voice information processing unit 232 executes various types of voice processing on the basis of the voice data. For example, the voice information processing unit 232 executes speech recognition processing and recognizes an utterance content uttered by the target person. The voice information processing unit 232 supplies information indicating a result of the voice processing to the action control unit 224 and the learning unit 225.

The vital information processing unit 233 executes processing of detecting the vital value of the target person on the basis of the vital data. The vital information processing unit 233 supplies vital information indicating a vital value detection result to the action control unit 224 and the learning unit 225.

The LiDAR information processing unit 234 executes processing of detecting the position, the shape, the motion, or the like of an object around the nursing care robot 11 on the basis of the point cloud data. The LiDAR information processing unit 234 supplies information indicating a result of the processing of detecting the position, the shape, or the motion of an object around the nursing care robot 11 to the action control unit 224 and the learning unit 225.

The application setting unit 222 sets various types of information for executing the application on the basis of at least one of an instruction from the controller 111, the characteristic learning information of each target person from the learning unit 225, or the target person data of each target person supplied from the action control unit 224. The application setting unit 222 includes a parameter setting unit 241 and an application execution scheduler 242.

The parameter setting unit 241 generates and stores an individual operation parameter for each target person in a case of executing each application on the basis of at least one of the instruction from the controller 111, the characteristic learning information of each target person from the learning unit 225, or the target person data of each target person supplied from the action control unit 224. The operation parameter is set on the basis of, for example, information regarding acceptability of the nursing care robot 11 for each target person. The operation parameter includes, for example, parameters regarding whether or not conversation is possible, whether or not body contact is possible, a feature amount of an uttered voice, an interaction speed, a gaze fixation region, a motion speed, a relative position, a taste, a preference, the size of a character to be displayed on the hand display 91, and other special items.

The application execution scheduler 242 generates and stores the schedule information regarding a schedule for executing the application according to the instruction from the controller 111. The schedule information includes, for example, information regarding a date and time when the application is executed, the type of the application to be executed, the target person who is a target for executing the application, and the like.

The application control unit 223 controls the action control unit 224 on the basis of at least one of the operation parameter stored in the parameter setting unit 241, the schedule information stored in the application execution scheduler 242, or a result of recognizing each target person and the state of the surroundings by the recognition unit 221, thereby controlling the execution of the application of the nursing care robot 11. For example, the application control unit 223 controls the type of the application executed by the nursing care robot 11, a timing for executing the application, and the target person who is the target for executing the application. For example, the application control unit 223 controls the application execution method or the like of the nursing care robot 11 in such a way as to enhance acceptability of the application for each target person on the basis of the operation parameter.

The action control unit 224 controls each unit of the nursing care robot 11 in order to cause the nursing care robot 11 to execute actions such as various applications. The action control unit 224 includes an application information storage unit 251, a motion set information storage unit 252, a map information storage unit 253, a scenario execution control unit 254, a tracking motion control unit 255, a motor drive control unit 256, a voice output control unit 257, a navigation control unit 258, an automatic charging control unit 259, and a call communication function control unit 260.

The application information storage unit 251 stores application information regarding each application executed by the nursing care robot 11. The application information includes, for example, a scenario for executing the application. The scenario includes information regarding a content of an utterance motion, the order in which the utterance motions are executed, a branch condition of the utterance motion, and the like.

The utterance motion indicates a combination of an utterance and a motion of the nursing care robot 11. That is, the utterance motion indicates a combination of a content (line) of the utterance output by the nursing care robot 11 and the motion of the nursing care robot 11 at the time of outputting the utterance.

Note that, in a case where the nursing care robot 11 does not move and outputs only the utterance, the utterance motion indicates only the utterance output by the nursing care robot 11. In addition, in a case where the nursing care robot 11 executes only the motion without outputting the utterance, the utterance motion indicates only the motion executed by the nursing care robot 11.

For example, the nursing care robot 11 executes each application by sequentially executing a plurality of utterance motions according to the scenario. In addition, the nursing care robot 11 determines whether or not to execute the utterance motion or changes the execution order or the like according to the situation.

The motion set information storage unit 252 stores motion set information used for executing each utterance motion indicated in the scenario of each application. The motion set information includes, for example, a content of the line uttered by the nursing care robot 11 in the utterance motion or the voice data, and motion data indicating a motion of each unit of the nursing care robot 11.

The map information storage unit 253 stores map information of the nursing care facility or the like in which the nursing care robot 11 is used. The map information includes, for example, information regarding the position of a room or a seat of each target person.

The scenario execution control unit 254 controls execution of the scenario corresponding to the application to be executed on the basis of a processing result of the recognition unit 221 or the like. For example, the scenario execution control unit 254 detects a trigger that is a scenario branch condition. For example, the scenario execution control unit 254 detects a person, the face orientation of the target person, an utterance volume of the target person, an utterance content of the target person, and the like as triggers. The scenario execution control unit 254 controls whether or not to execute the utterance motion included in the scenario, the execution order, repetition, pause, stop, or the like on the basis of the trigger detection result or the like.

The tracking motion control unit 255 controls execution of a tracking motion on the basis of a result of detecting at least one of the face orientation or the line-of-sight direction of the target person by the recognition unit 221. The tracking motion is, for example, processing of tracking the face orientation and the line-of-sight direction of the target person and directing the face of the nursing care robot 11, the screen of the hand display 91, and the like toward the face orientation of the target person.

The motor drive control unit 256 controls the actuator 209 that drives each joint of the nursing care robot 11 to drive each joint of the nursing care robot 11, thereby controlling the motion and posture of the nursing care robot 11.

The voice output control unit 257 controls output of a sound such as the uttered voice of the nursing care robot 11 or a musical piece from the speaker 208.

Note that, in the nursing care robot 11, the uttered voice is set to, for example, a voice of a child (for example, a 4 to 8 year-old child) from the concept of a grandchild robot. However, it is difficult for a person with hearing loss to hear a high-frequency sound included in a voice of a child.

On the other hand, the voice output control unit 257 corrects a frequency characteristic of the uttered voice in accordance with the hearing of the target person, for example. For example, in a case where it is difficult for the target person to bear a standard uttered voice of the nursing care robot 11, the voice output control unit 257 amplifies a low frequency band (100 to 1000 Hz) in which an elderly person can easily hear, and attenuates a high frequency band (2000 Hz or higher). As a result, the target person can easily hear the uttered voice of the nursing care robot 11.

Note that, by leaving a high-frequency component without modulating the entire uttered voice, the uttered voice does not become too low, and a sense of discomfort can be reduced as compared with the standard uttered voice.

Note that, for example, the voice output control unit 257 may correct the frequency characteristic of the uttered voice on the basis of a user setting. Furthermore, for example, in a case where it is necessary to reliably transmit an utterance content, such as in a case of calling an attention of the target person, the voice output control unit 257 may correct the frequency characteristic of the uttered voice in such a way that the person with hearing loss can easily hear the utterance content.

Furthermore, recorded voice is mainly used as the uttered voice. As a result, the uttered voice of the nursing care robot 11 becomes more natural, and the acceptability of the nursing care robot 11 for the target person is improved.

However, in a case where all the uttered voices are recorded voices, a data amount of the uttered voices increases. On the other hand, a synthesized voice or a converted voice is used for some of the uttered voices.

For example, it is difficult to record all the appellations (for example, a name, a nickname, and the like) of a person in advance. Therefore, for example, the voice output control unit 257 generates a synthesized voice based on a recorded voice for an appellation having no uttered voice data, and causes the speaker 208 to output the synthesized voice.

For example, in a case where a remote operation of the nursing care robot 11 is performed, when a remote operator needs to intervene and utter a voice, the voice output control unit 257 modulates the uttered voice of the remote operator to a tone (a tone similar to the recorded voice) that is consistent with the recorded voice, and outputs the voice from the speaker 208.

The navigation control unit 258 controls the carriage drive unit 212 on the basis of the map information and the like stored in the map information storage unit 253 to control the movement direction, the movement speed, and the movement route of the nursing care robot 11.

The automatic charging control unit 259 performs automatic charging control of the power supply 215 on the basis of information indicating the state of the power supply 215 supplied from the power supply management unit 214. For example, in a case where it is determined that it is necessary to charge the power supply 215, the automatic charging control unit 259 instructs the navigation control unit 258 to move the nursing care robot 11 to the charging dock 117. In addition, after the nursing care robot 11 moves to the charging dock 117, the automatic charging control unit 259 controls the power supply management unit 214 to charge the power supply 215.

The call communication function control unit 260 controls a call function and a communication function for another communication device, the server 113, or the like via the Wi-Fi router 112 and the network 121. For example, the call communication function control unit 260 controls a video call function by using the hand display 91.

The learning unit 225 learns the characteristic of each target person on the basis of a reaction or the like of each target person at the time of execution of each application, recognized by the recognition unit 221. The learning unit 225 supplies the characteristic learning information indicating a result of learning the characteristic of each target person to the application setting unit 222 and the action control unit 224. The characteristic learning information of each target person supplied to the action control unit 224 is transmitted from the call communication function control unit 260 to the server 113 via the Wi-Fi router 112 and the network 121.

The in-robot PC 206 includes, for example, a computer including a CPU, a ROM, a RAM, and the like. The in-robot PC 206 performs display control and the like of the nursing care robot 11. The in-robot PC 206 includes a display control unit 271.

The display control unit 271 controls a display function of the nursing care robot 11. For example, the display control unit 271 controls display of the black portion 52L by the eyeball display 551L and display of the black portion 52R by the eyeball display 55R. In addition, the display control unit 271 controls blinking of the head LED indicator 207.

The head LED indicator 207 is provided at the head of the nursing care robot 11, and displays information regarding the state of the nursing care robot 11 and the like by an LED.

The speaker 208 outputs the sound of the nursing care robot 11 such as an uttered voice and a musical piece under the control of the voice output control unit 257.

The actuator 209 drives each joint of the nursing care robot 11 under the control of the motor drive control unit 256.

The emergency stop switch 210 is a switch for emergency stop of the nursing care robot 11. In a case where the emergency stop switch 210 is operated, the emergency stop switch 210 supplies an operation signal to the carriage drive unit 212.

The bumper sensor 211 is provided, for example, on a front surface of the carriage 71, executes detection processing such as collision with an object in front of the carriage 71, and supplies sensor data indicating a detection result to the carriage drive unit 212.

The carriage drive unit 212 controls the actuator 213 of the carriage 71 under the control of the action control unit 224 to control the movement direction and the movement speed of the nursing care robot 11. In a case where the operation signal is input from the emergency stop switch 210, the carriage drive unit 212 controls the actuator 213 to stop the movement of the nursing care robot 11. Moreover, the carriage drive unit 212 controls the actuator 213 on the basis of the sensor data from the bumper sensor 211 to control the movement direction and the movement speed of the nursing care robot 11.

The actuator 213 drives a left wheel 1131L and a right wheel 113R, which are drive wheels of the carriage 71, under the control of the carriage drive unit 212.

The power supply management unit 214 manages the power supply 215. For example, the power supply management unit 214 monitors the state (for example, the remaining power of the power supply 215 or the like) of the power supply 215 and supplies information indicating the state of the power supply 215 to the action control unit 224. For example, the power supply management unit 214 controls charging of the power supply 215 using the charging dock 117.

The power supply 215 includes, for example, a battery, and supplies power to each unit of the nursing care robot 11.

The controller 111 includes a joystick type input device 301 and a tablet type terminal device 302.

The joystick type input device 301 is used, for example, to set the operation parameter of each target person and the schedule information of each application.

The tablet type terminal device 302 includes a display, an operation panel, a communication device, and the like. The tablet type terminal device 302 is used, for example, to set the operation parameter of each target person and the schedule information of each application. In addition, the tablet type terminal device 302 performs communication with the nursing care robot 11 and the like.

### Configuration Example of Server 113

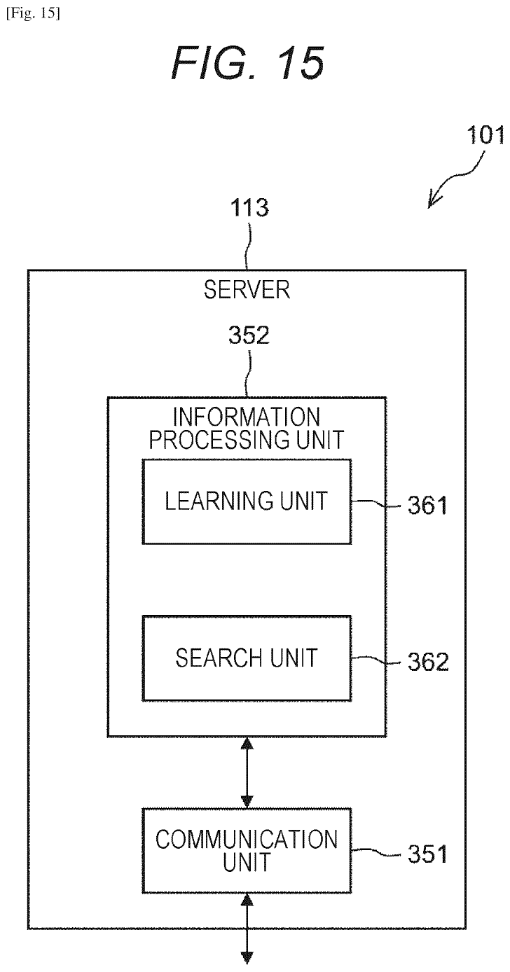

FIG. 15 illustrates a configuration example of the server 113.

The server 113 includes a communication unit 351 and an information processing unit 352.

The communication unit 351 communicates with the nursing care robot 11 via the network 121 and the Wi-Fi router 112. The communication unit 351 communicates with the user database 114, the family database 115, the staff database 116, and the like via the network 121.

The information processing unit 352 includes a learning unit 361 and a search unit 362.

The learning unit 361 learns the characteristic of each target person. The learning unit 361 executes learning processing on the basis of the characteristic learning information of each target person transmitted from the nursing care robot 11, and updates the target person data of each target person in the user database 114 on the basis of the learning result. Furthermore, the learning unit 361 executes processing of linking the user database 114, the family database 115, and the staff database 116.

The search unit 362 searches for the target person data of each target person in the user database 114. For example, the search unit 362 identifies the target person on the basis of feature amount information of the target person transmitted from the nursing care robot 11 and the identification information stored in the user database 114. The search unit 362 reads the target person data of the identified target person from the user database 114. The search unit 362 transmits the read target person data to the nursing care robot 11 via the network 121 and the Wi-Fi router 112.

### <Processing in Nursing Care Robot 11>

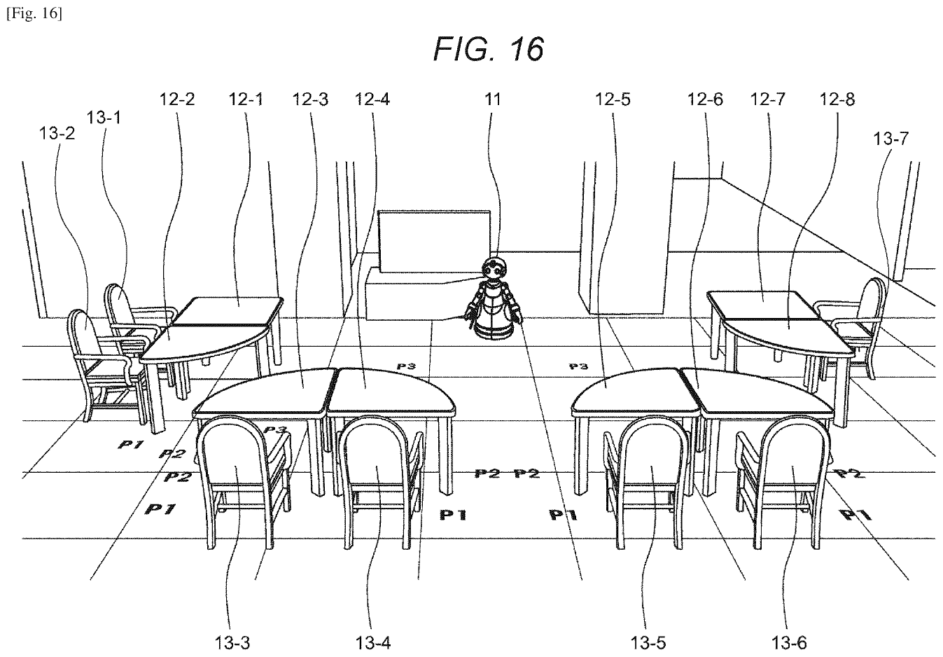

Next, processing in the nursing care robot 11 will be described with reference to FIGS. 16 to 29.

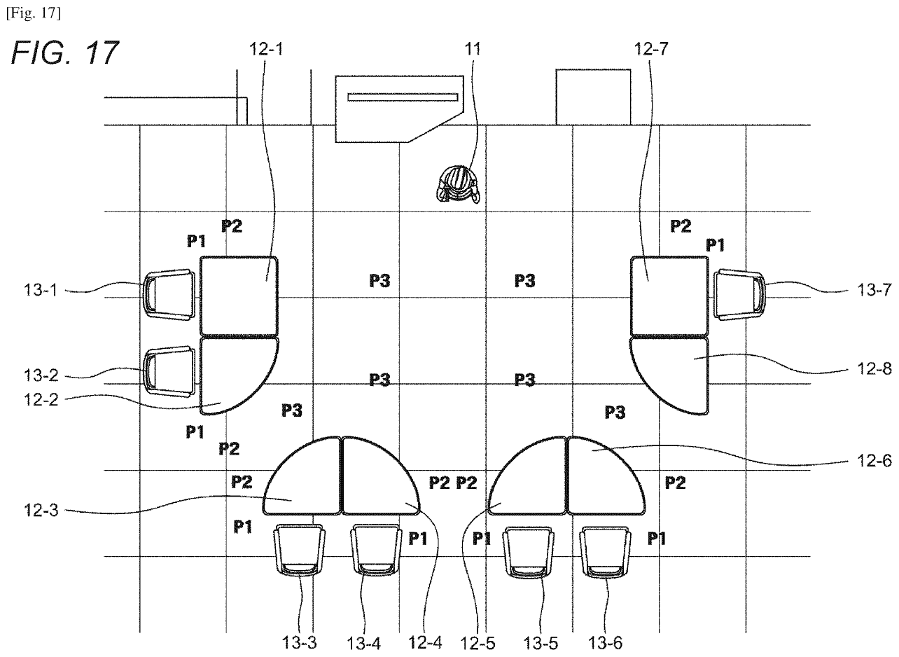

Note that, hereinafter, an example in which the nursing care robot 11 executes the application for caring for the target person in a living room illustrated in FIGS. 16 and 17 will be described.

In FIGS. 16 and 17, a position where the nursing care robot 11 is present is a home position P0, and for example, the charging dock 117 (not illustrated) is arranged. In addition, tables 12-1 to 12-8 and chairs 13-1 to 13-7 are arranged in the living room.

The tables 12-1 to 12-8 are arranged in a U shape. That is, a row of the tables 12-1 and 12-2, a row of the tables 12-3 to 12-6, and a row of the tables 12-7 and 12-S are arranged in a U shape. The row of the tables 12-3 to 12-6 is arranged in front of the nursing care robot 11. The row of the tables 12-1 and 12-2 and the row of the tables 12-7 and 12-8 are arranged in a direction perpendicular to the row of the tables 12-3 to 12-6 and face each other.

Furthermore, the chairs 13-1 to 13-7 are arranged for the tables 12-1 to 12-7, respectively. Note that no chair is arranged for the table 12-8.

Note that, hereinafter, in a case where it is not necessary to individually distinguish the tables 12-1 to 12-7, they are simply referred to as the table 12. Hereinafter, in a case where it is not necessary to individually distinguish the chairs 13-1 to 13-7, they are simply referred to as the chair 13.

Further, in FIGS. 16 and 17, a long-distance position P3, a middle-distance position P2, and a short-distance position P1 with respect to each chair 13 are illustrated.

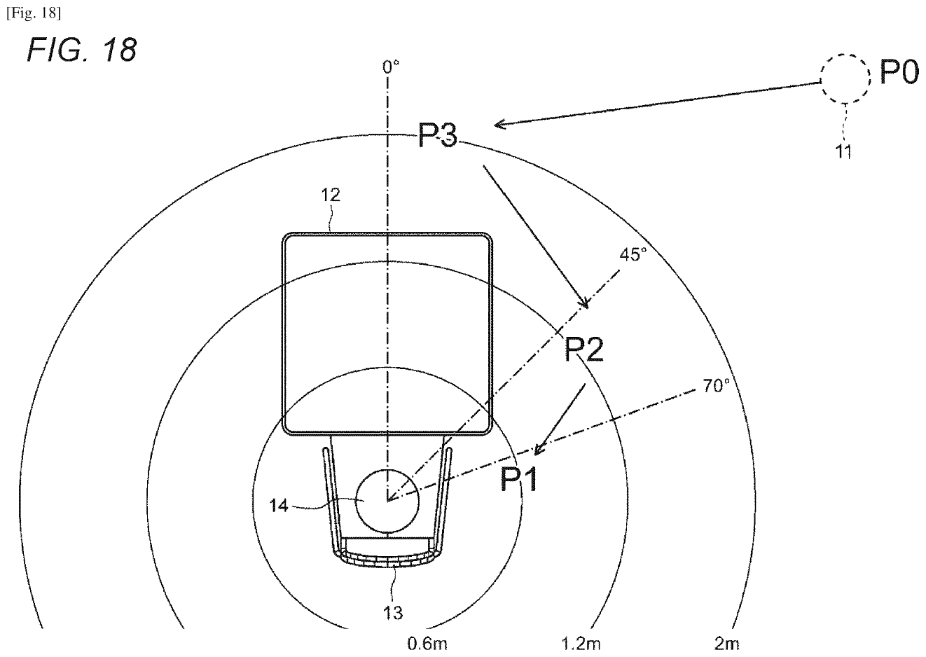

For example, as illustrated in FIG. 18, the long-distance position P3 is set to a position about 2 m away from the target person 14 in a direction of about 0 degrees with respect to the front of a target person 14 who is a target for the nursing care robot 11 to execute the application.

For example, the middle-distance position P2 is set to a position about 1.2 in away from the target person 14 in a direction of about 45 degrees with respect to the front of the target person 14.

For example, the short-distance position P1 is set to a position about 0.6 in away from the target person 14 in a direction of about 70 degrees with respect to the front of the target person 14.

### <Basic Flow of Application Execution Processing>

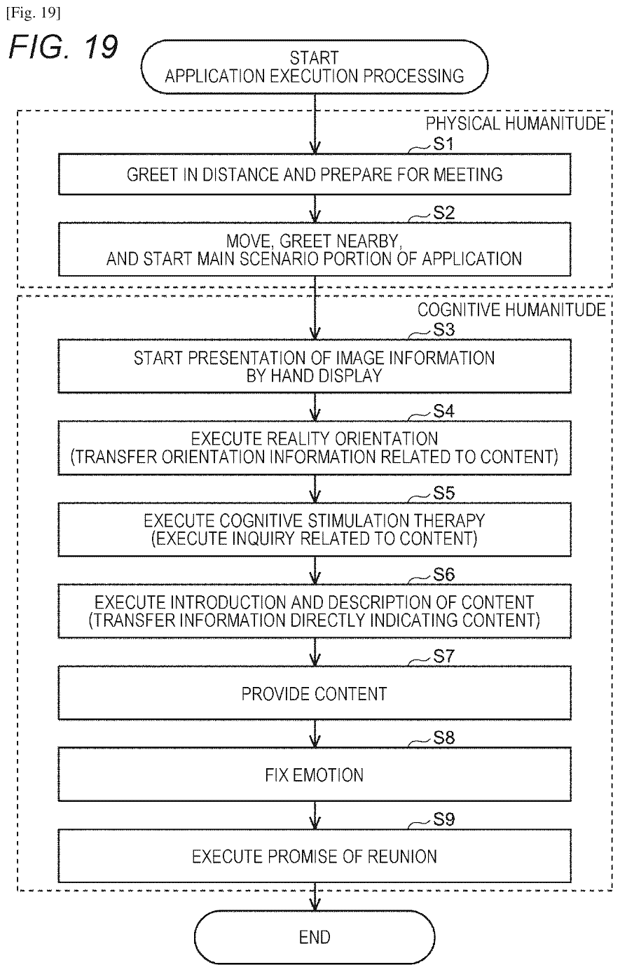

First, a basic flow of application execution processing executed by the nursing care robot 11 will be described with reference to the flowchart of FIG. 19.

This processing is started, for example, in a case where conditions for executing the application for executing predetermined care on the target person are satisfied and the application control unit 223 commands the action control unit 224 to execute the application.

For example, by executing the application, the nursing care robot 11 sequentially executes steps of preparing for meeting, preparing for care, connecting perceptions, fixing emotions, and making a promise of a reunion by using the humanitude, and performs care for the target person.

Specifically, in step S1, the nursing care robot 11 greets the user in a distance and prepares for meeting.

For example, the navigation control unit 258 controls the carriage drive unit 212 to move the nursing care robot 11 from the home position P0 to the long-distance position P3.

The nursing care robot 11 greets the target person at the long-distance position P3. Specifically, for example, the motor drive control unit 256 controls the actuator 209 to direct the face of the nursing care robot 11 toward the face of the target person under the control of the tracking motion control unit 255. In addition, the motor drive control unit 256 controls the actuator 209 to cause the nursing care robot 11 to execute a motion in a case of greeting the target person. The voice output control unit 257 causes the speaker 208 to output an uttered voice corresponding to the greeting in accordance with the motion of the nursing care robot 11.

In step S2, the nursing care robot 11 moves, greets the user nearby, and starts a main scenario portion of the application.

For example, the navigation control unit 258 controls the carriage drive unit 212 to move the nursing care robot 11 from the long-distance position P3 to the middle-distance position P2. The nursing care robot 11 greets the target person at the middle-distance position P2 by processing similar to step S1 described above.

Moreover, the navigation control unit 258 controls the carriage drive unit 212 as necessary to move the nursing care robot 11 from the middle-distance position P2 to the short-distance position P1 The nursing care robot 11 greets the target person at the short-distance position P1 by processing similar to step S1 described above.

Note that the middle-distance position P2 and the short-distance position P1 are desirably in a direction toward a dominant hand of the target person. In this case, for example, as the nursing care robot 11 approaches the target person, the nursing care robot approaches the target person in such a way that an angle with respect to the front of the target person becomes larger toward the dominant hand.

In this manner, the physical humanitude is executed on the target person. That is, an approach is executed in which a physical distance between the nursing care robot 11 and the target person is gradually reduced. As a result, the nursing care robot 11 can approach the target person while giving a sense of security without giving a negative feeling for example, fear or the like) to the target person, and acceptability of the nursing care robot 11 for the target person is improved.

Then, the nursing care robot 11 starts the main scenario portion of the application under the control of the scenario execution control unit 254.

In step S3, the nursing care robot 11 starts presentation of image information by the hand display 91. For example, the scenario execution control unit 254 causes the hand display 91 to display the image information regarding a content provided by the application.

At this time, for example, the tracking motion control unit 255 controls execution of the tracking motion by the hand display 91 on the basis of a result of detecting at least one of the face orientation or the line-of-sight direction of the target person by the recognition unit 221 as necessary.

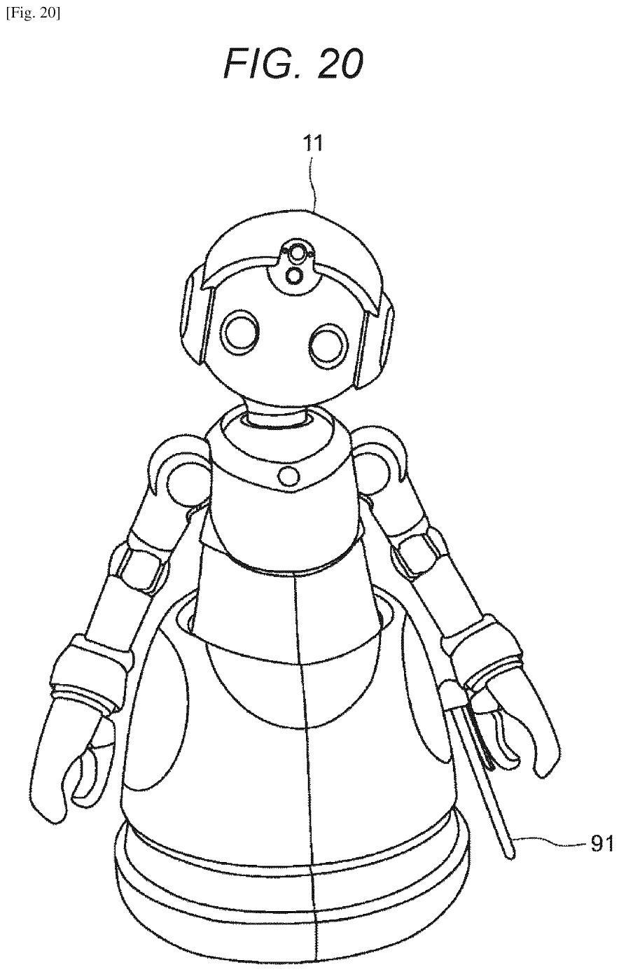

For example, the tracking motion control unit 255 controls the actuator 209 via the motor drive control unit 256 to control the positions and orientations of the head portion 21 and the hand display 91 as illustrated in FIGS. 20 to 22.

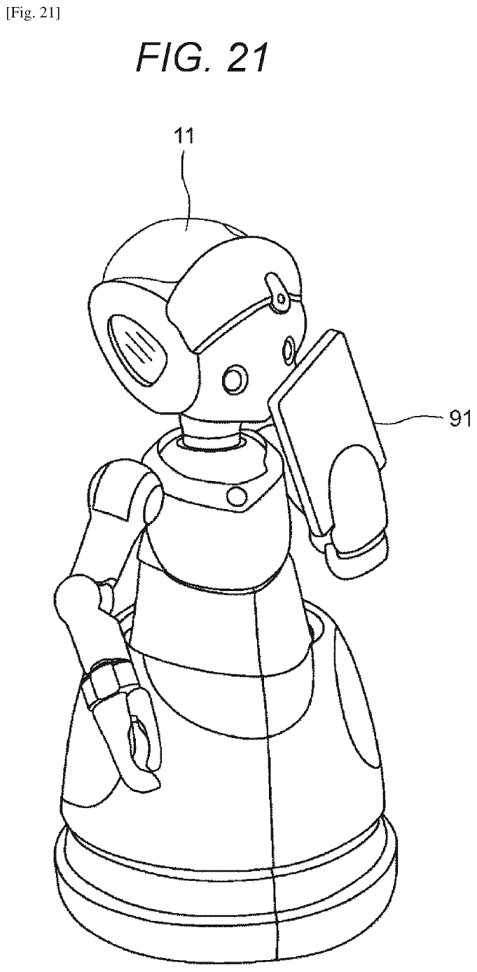

Specifically, for example, the nursing care robot 11 lifts the hand display 91 to the vicinity of a portion corresponding to the height of the head portion 21 as illustrated in FIG. 21 in a state where the hand display 91 is lowered as illustrated in FIG. 20. Here, the nursing care robot 11 directs the face and the line-of-sight toward the hand display 91. As a result, attention of the target person is attracted to the hand display 91.

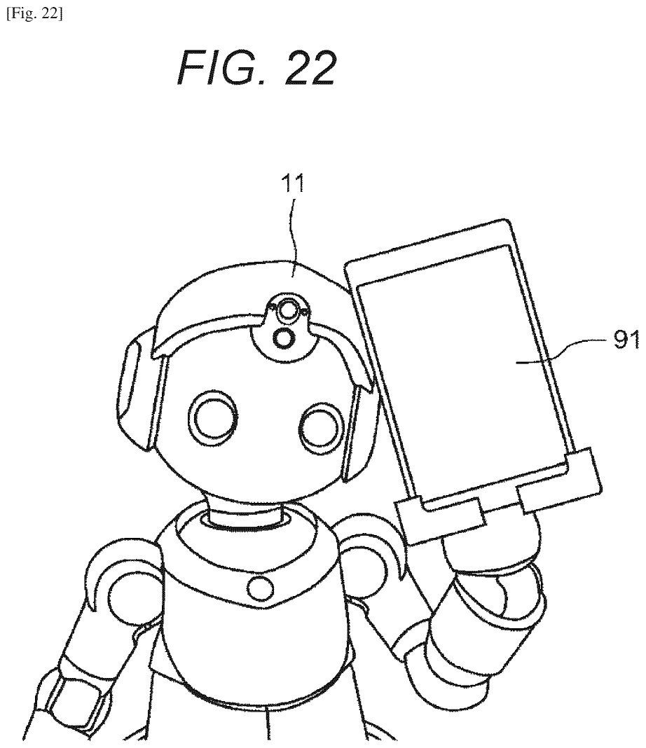

Next, as illustrated in FIG. 22, the nursing care robot 11 directs the screen of the hand display 91 toward the target person immediately beside the head portion 21. That is, the screen of the hand display 91 is directed to the target person in a state where attention of the target person is attracted to the band display 91.

As a result, the target person can easily focus on the hand display 91, and an interaction via the hand display 91 becomes smooth.

In step S4, the nursing care robot 11 executes reality orientation. Here, the reality orientation is, for example, processing of conveying orientation information related to the content provided by the application being executed to the target person.

For example, the motor drive control unit 256 controls the actuator 209 to cause the nursing care robot 11 to execute a motion for conveying the orientation information related to the content to the target person under the control of the scenario execution control unit 254. The voice output control unit 257 causes the speaker 208 to output a voice for conveying the orientation information related to the content to the target person under the control of the scenario execution control unit 254.

In step S5, the nursing care robot 11 performs cognitive stimulation therapy. For example, the nursing care robot 11 executes the cognitive stimulation therapy by executing an inquiry related to the content executed by the application being executed for the target person.

For example, the motor drive control unit 256 controls the actuator 209 to cause the nursing care robot 11 to execute a motion for executing the inquiry related to the content for the target person under the control of the scenario execution control unit 254. The voice output control unit 257 causes the speaker 208 to output a voice for executing the inquiry related to the content for the target person under the control of the scenario execution control unit 254.

In step S6, the nursing care robot 11 executes introduction and description of the content. For example, the nursing care robot 11 conveys information (for example, a title, a main detail, and the like of the content) directly indicating the content provided by the application being executed to the target person.

For example, the motor drive control unit 256 controls the actuator 209 to cause the nursing care robot 11 to execute a motion for conveying the information directly indicating the content to the target person under the control of the scenario execution control unit 254. The voice output control unit 257 causes the speaker 208 to output a voice for conveying the information directly indicating the content to the target person under the control of the scenario execution control unit 254.

Preparation of care in the humanitude is executed by the pieces of processing of steps S2 to S6, for example. That is, in a case where the nursing care robot 11 presents the information related to the content, the target person is guided to the content.

In step S7, the nursing care robot 11 provides the content. For example, the motor drive control unit 256 controls the actuator 209 to cause the nursing care robot 11 to execute a motion corresponding to the content under the control of the scenario execution control unit 254. The voice output control unit 257 causes the speaker 208 to output a voice corresponding to the content under the control of the scenario execution control unit 254.

Connection of perception in the humanitude is executed by the processing of step S7, for example.

In this way, the cognitive humanitude is executed for the target person. That is, an approach of gradually reducing a cognitive distance of the target person to the content provided by the application is performed. As a result, the nursing care robot 11 can provide the content after causing the target person to recognize the content to be provided while giving a sense of security without giving a negative feeling (for example, fear and the like) to the target person. As a result, the acceptability of the provided content for the target person is improved.

In step S8, the nursing care robot 11 fixes an emotion. For example, the motor drive control unit 256 controls the actuator 209 to cause the nursing care robot 11 to execute a motion for giving a positive feeling to the target person while looking back the provided content with the target person under the control of the scenario execution control unit 254. The voice output control unit 257 causes the speaker 208 to output a voice for giving a positive feeling to the target person while looking back the provided content with the target person under the control of the scenario execution control unit 254.

Note that, in a case where a plurality of contents is included in the application being executed, for example, the pieces of processing of steps S3 to S7 or the pieces of processing of steps S3 to S8 are repeatedly executed.

In addition, not all the pieces of processing of steps S3 to S6 are necessarily executed. For example, one or more pieces of processing are executed according to a characteristic of the content to be provided or the characteristic of the target person.

In step S9, the nursing care robot 11 executes a promise of a reunion. For example, the motor drive control unit 256 controls the actuator 209 to convey the next schedule to the target person and cause the nursing care robot 11 to execute a motion for bidding farewell under the control of the scenario execution control unit 254. The voice output control unit 257 conveys the next schedule to the target person and causes the speaker 208 to output a voice for bidding farewell under the control of the scenario execution control unit 254. The navigation control unit 258 controls the carriage drive unit 212 to move the nursing care robot 11 to a position away from the target person.

Thereafter, the application execution processing ends.

### Specific Example of Application Execution Processing

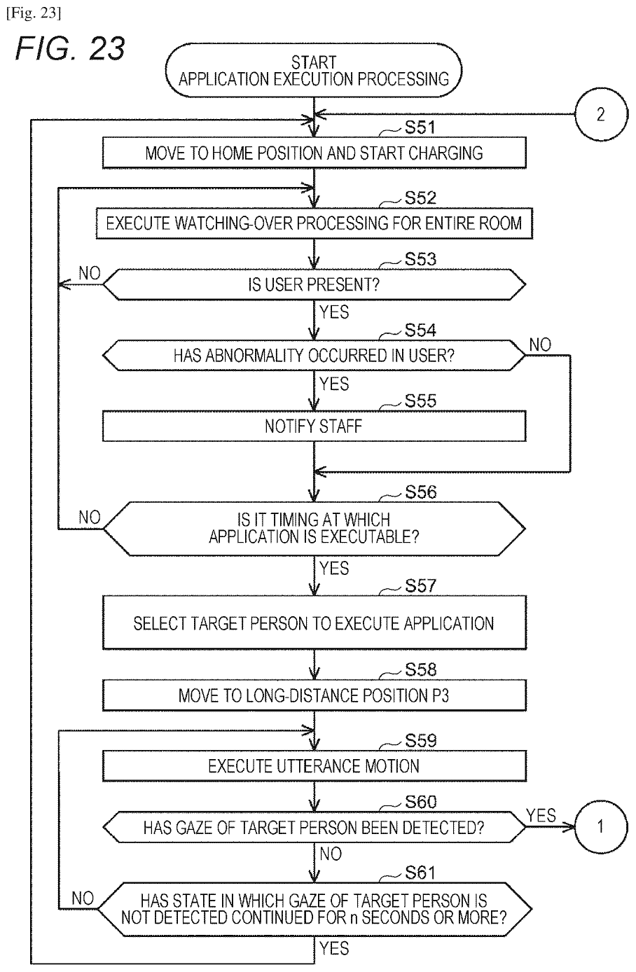

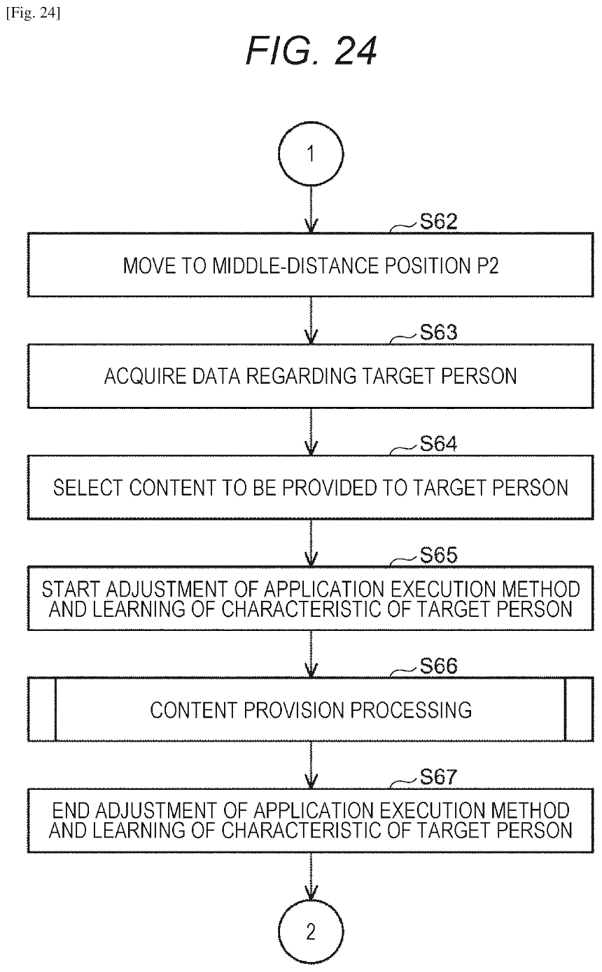

Next, a specific example of the application execution processing will be described with reference to the flowcharts of FIGS. 23 and 24.

Note that, in the application execution processing of FIGS. 23 and 24, the target person who is not an execution target of the application among the nursing care target persons is hereinafter referred to as a user (of the nursing care facility) as necessary in order to be distinguished from the target person who is the execution target.

For example, this processing starts when the power supply of the nursing care robot 11 is turned on, and ends when the power supply of the nursing care robot 11 is turned off.

In step S51, the nursing care robot 11 moves to the home position P0 and starts charging. For example, the navigation control unit 258 controls the carriage drive unit 212 to move the nursing care robot 11 to the borne position P0. The automatic charging control unit 259 controls the power supply management unit 214 to charge the power supply 215 by the charging dock 117.

In step S52, the nursing care robot 11 executes watching-over processing for the entire room. For example, the motor drive control unit 256 drives the actuator 109 to turn the neck joint shaft 24C under the control of the scenario execution control unit 254. As a result, the head portion 21 of the nursing care robot 11 is moved left and right, and the distance image sensor 201 images a region including each table 12 and each chair 13 in the living room. The distance image sensor 201 supplies the distance image data obtained by the imaging to the image information processing unit 231. The image information processing unit 231 executes processing of recognizing the state of the user in the living room or the like on the basis of the distance image data. As a result, the watching-over processing for the entire room is executed.

In step S53, the image information processing unit 231 determines whether or not the user is present on the basis of a result of the processing of step S52. In a case where it is determined that the user is not present, the processing returns to step S52.

Thereafter, the pieces of processing of steps S52 and S53 are repeatedly executed until it is determined in step S53 that the user is present.

Whereas, in a case where it is determined in step S53 that the user is present, the processing proceeds to step S54.

In step S54, the image information processing unit 231 determines whether or not an abnormality has occurred in the user on the basis of a result of the processing of step S52. For example, in a case where an abnormality such as sudden standing or falling of the user is detected, the image information processing unit 231 determines that an abnormality has occurred in the user, and the processing proceeds to step S55.

In step S55, the nursing care robot 11 notifies the staff. For example, the call communication function control unit 260 transmits information for notifying of an abnormality of the user to an external device (for example, an information terminal (for example, a smartphone or the like) carried by the staff or an information terminal in a staff room) via the Wi-Fi router 112 and the network 121.

Thereafter, the processing proceeds to step S56.

On the other hand, in a case where it is determined in step S54 that no abnormality has occurred in the user, the processing of step S55 is skipped, and the processing proceeds to step S56.

In step S56, the application control unit 223 determines whether or not it is a timing at which the application is executable. For example, in a case where the application control unit 223 determines that it is not the timing at which the application is executable on the basis of the schedule information stored in the application execution scheduler 242, the processing returns to step S52.

Thereafter, the pieces of processing of steps S52 to S56 are repeatedly executed until it is determined in step S56 that it is the timing at which the application is executable.

On the other hand, in a case where it is determined in step 356 that it is the timing at which the application is executable, the processing proceeds to step S57.

In step S57, the application control unit 223 selects the target person to execute the application from among the users. For example, the application control unit 223 randomly selects the target person from among the users in the living room in such a way as to have a similar probability.

In step S58, the nursing care robot 11 moves to the long-distance position P3. For example, the navigation control unit 258 controls the carriage drive unit 212 to move the nursing care robot 11 from the home position P0 to the long-distance position P3.

In step S59, the nursing care robot 11 executes the utterance motion. For example, the motor drive control unit 256 controls the actuator 209 to cause the nursing care robot 11 to execute a motion based on the scenario under the control of the scenario execution control unit 254. The voice output control unit 257 causes the speaker 208 to output an uttered voice based on the scenario under the control of the scenario execution control unit 254.

In step S60, the nursing care robot 11 determines whether or not the gaze of the target person has been detected. Specifically, the image information processing unit 231 detects at least one of the face orientation or the line-of-sight direction of the target person on the basis of distance image sensor data from the distance image sensor 201, and supplies information indicating the detection result to the action control unit 224.

In a case where the face or the line-of-sight of the target person is not directed toward the nursing care robot 11, the scenario execution control unit 254 determines that the gaze of the target person has not been detected, and the processing proceeds to step S61.

In step S61, the scenario execution control unit 254 determines whether or not a state in which the gaze of the target person is not detected has continued for n seconds or more. In a case where it is determined that the state in which the gaze of the target person is not detected has not continued for n seconds or more, the processing returns to step S59.

Thereafter, the pieces of processing of steps S59 to S61 are repeatedly executed until it is determined in step S60 that the gaze of the target person has been detected or it is determined in step S61 that the state in which the gaze of the target person is not detected has continued for n seconds or more. That is, the utterance motion in step S59 is repeatedly executed.

On the other hand, in a case where it is determined in step S61 that the state in which the gaze of the target person is not detected has continued for n seconds or more, the processing returns to step S51. This is, for example, a case where execution of the application is stopped before provision of a main content of the application because it is difficult to obtain a positive reaction of the target person.

Thereafter, the pieces of processing of steps S51 to S61 are repeatedly executed until it is determined in step S60 that the gaze of the target person has been detected.

On the other hand, in step S60, in a case where the face or the line-of-sight of the target person is directed toward the nursing care robot 11, the scenario execution control unit 254 determines that the gaze of the target person has been detected, and the processing proceeds to step S62.

In step S62, the nursing care robot 11 moves to the middle-distance position P2. For example, the navigation control unit 258 controls the carriage drive unit 212 to move the nursing care robot 11 from the long-distance position P3 to the middle-distance position P2.

In step S63, the image information processing unit 231 acquires data regarding the target person. For example, the image information processing unit 231 extracts a feature amount of the target person on the basis of the distance image sensor data from the distance image sensor 201, and supplies the feature amount information indicating the extracted feature amount of the target person to the action control unit 224. The call communication function control unit 260 transmits the feature amount information of the target person to the server 113 via the Wi-Fi router 112 and the network 121.

The communication unit 351 of the server 113 receives the feature amount information of the target person via the Wi-Fi router 112 and the network 121. The search unit 362 searches for a user whose feature amount matches from among the users registered in the user database 114 on the basis of the feature amount information. As a result of the search, the search unit 362 extracts data regarding a specified user (that is, the target person) from the user database 114. The communication unit 351 transmits the target person data related to the target person to the nursing care robot 11 via the network 121 and the Wi-Fi router 112.

The call communication function control unit 260 of the nursing care robot 11 receives the target person data via the network 121 and the Wi-Fi router 112.

The call communication function control unit 260 supplies the target person data to the application setting unit 222 and the application control unit 223.

In step S64, the scenario execution control unit 254 selects a content to be provided to the target person. For example, the scenario execution control unit 254 selects a content to be provided to the target person on the basis of a content preference of the target person included in the target person data in such a way that each type of content is selected from among types of contents preferred by the target person with a similar probability. That is, a material of the content is controlled on the basis of the target person data.

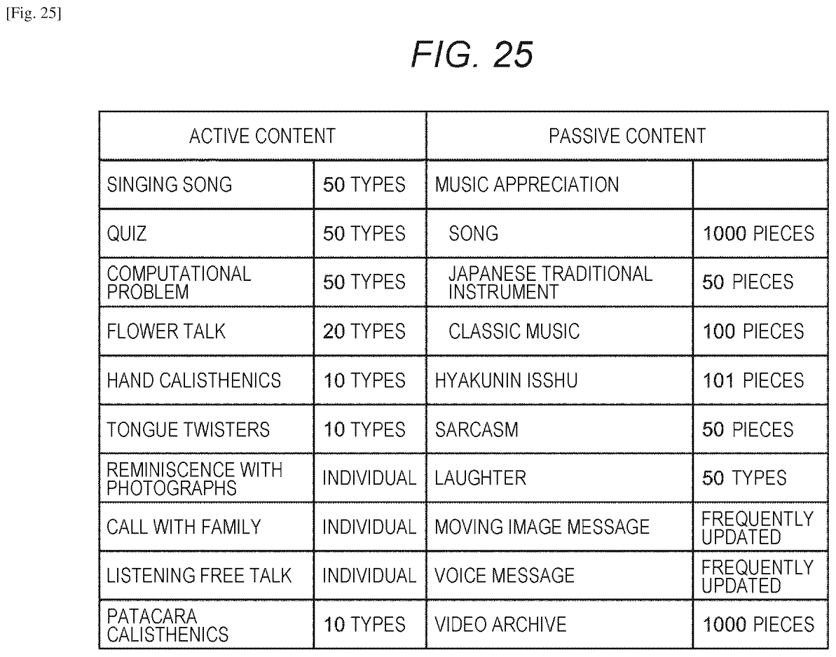

Note that FIG. 25 illustrates examples of the type of the content.

The content is largely classified into an active content and a passive content.

The active content is a content that the target person deals with together with the nursing care robot 11. For example, the active content includes singing a song, a quiz, a computational problem, a flower talk, hand calisthenics, tongue twisters, reminiscence with photographs, a call with a family, listening free talk, and PATACARA calisthenics (oral calisthenics).

The passive content is a content that the target person views or listens to together with the nursing care robot 11. For example, the passive content includes music appreciation, Hyakunin lsshu (a classical Japanese anthology of one hundred Japanese waka by one hundred poets), sarcasm, laughter, a moving image message, a voice message, and a video archive.

Note that the number of contents for each content type is an example.

For example, as illustrated in FIG. 25, the scenario execution control unit 254 selects an appropriate content from among a number of contents on the basis of the preference of the target person. As a result, a burden on the staff is reduced, and a satisfaction level of the target person is improved.

In step S65, the nursing care robot 11 starts adjustment of the application execution method and learning of the characteristic of the target person.

For example, the parameter setting unit 241 adjusts the operation parameter in a case of executing the application on the basis of the target person data acquired from the server 113. For example, the parameter setting unit 241 adjusts, on the basis of the target person data, whether or not conversation is possible, whether or not body contact is possible, a feature amount of an uttered voice of the nursing care robot 11, an interaction speed, a gaze fixation region (the face orientation or line-of-sight direction), a motion speed (the movement speed or a speed at which each portion is moved), the size of a character to be displayed on the hand display 91, and the like. For example, the parameter setting unit 241 adjusts the middle-distance position P2 and the short-distance position P1 with respect to the target person on the basis of the target person data.

In this manner, the operation parameter in a case of executing the application is adjusted on the basis of the target person data, whereby the provision method of the content is controlled. For example, whether or not conversation is possible, whether or not body contact is possible, a feature amount of an uttered voice of the nursing care robot 11, an interaction speed, a gaze fixation region, a motion speed, the size of a character displayed on the hand display 91, and the like at the time of providing the content are controlled.

For example, the image information processing unit 231 recognizes the state of the target person during execution of the application on the basis of the distance image data from the distance image sensor 201, and starts processing of supplying the recognition result to the learning unit 225 and the action control unit 224. The voice information processing unit 232 recognizes the state of the target person during execution of the application on the basis of the voice data from the microphone 202, and starts processing of supplying the recognition result to the learning unit 225 and the action control unit 224.

The learning unit 225 starts processing of learning the characteristic of the target person on the basis of the state of the target person during execution of the application. For example, the learning unit 225 starts processing of learning the characteristic (for example, the content preference of the target person) of the target person on the basis of a reaction of the target person to the content provided during execution of the application. Furthermore, the learning unit 225 starts processing of supplying, to the application setting unit 222, the characteristic learning information indicating a result of learning the characteristic of the target person.

The parameter setting unit 241 of the application setting unit 222 starts processing of adjusting the operation parameter of the application on the basis of the characteristic learning information.

Note that, for example, the scenario execution control unit 254 may start processing of controlling the material of the content to be provided on the basis of the state of the target person during execution of the application. For example, the scenario execution control unit 254 may start processing of controlling the material of the content on the basis of a reaction of the target person to the content provided during execution of the application.

In step S66, the nursing care robot 11 executes content provision processing. Details of the content provision processing will be described later.

In step S67, the nursing care robot 11 ends the adjustment of the application execution method and the learning of the characteristic of the target person. That is, the processing started in step S65 ends.

Furthermore, the learning unit 225 supplies the characteristic learning information indicating a result of learning the characteristic of the target person to the action control unit 224. The call communication function control unit 260 transmits the characteristic learning information to the server 113 via the Wi-Fi router 112 and the network 121.

On the other hand, the learning unit 361 of the server 113 receives the characteristic learning information via the network 121 and the communication unit 351. The learning unit 361 executes learning processing on the basis of the characteristic learning information as necessary, and updates the target person data of the target person in the user database 114 on the basis of the learning result.

Thereafter, the processing returns to step S51, and the pieces of processing of step S51 and subsequent steps are executed.

### First Embodiment of Content Provision Processing

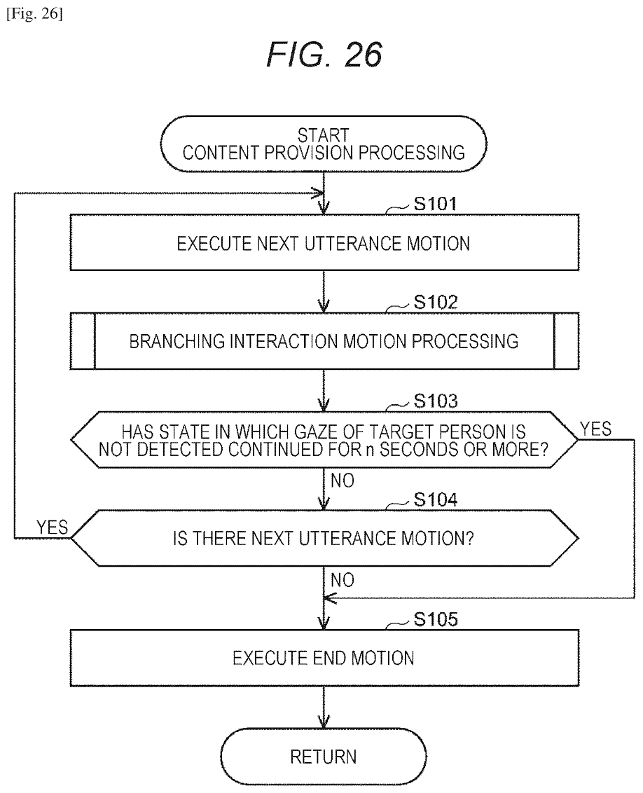

Next, a first embodiment of the content provision processing of step S66 in FIG. 24 will be described with reference to the flowchart of FIG. 26.

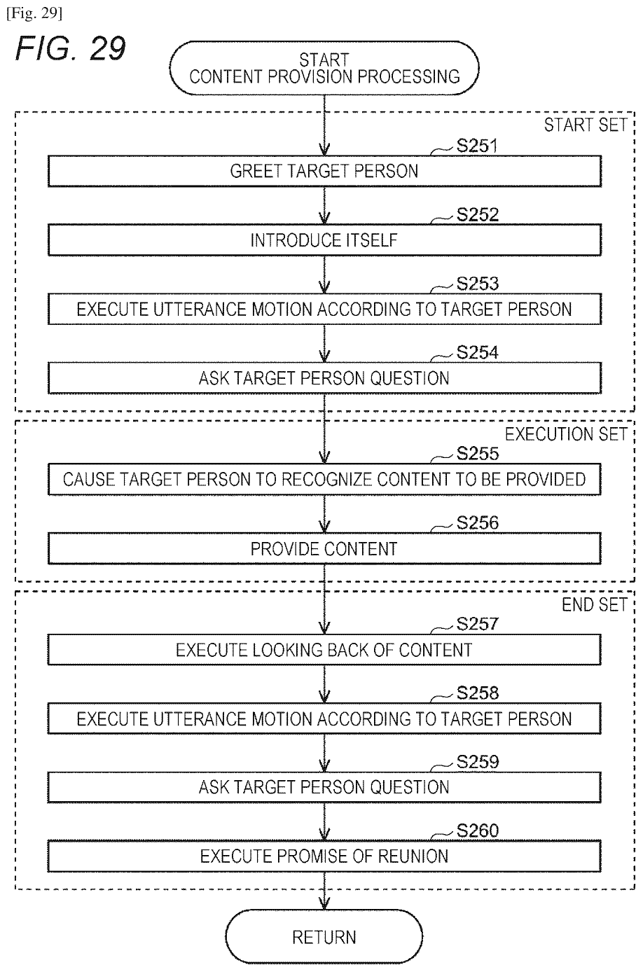

Note that, for example, the nursing care robot 11 provides the content to the target person by executing the processing of FIG. 29 to be described later while executing the processing of FIG. 26.

In the first embodiment of the content provision processing, the content is provided at the middle-distance position P2.

In step S101, the next utterance motion is executed by processing similar to step S59 in FIG. 23.

Note that the utterance motion executed in step S101 and the utterance motion executed in step S59 are normally different utterance motions.

Furthermore, the utterance content does not necessarily completely follow the scenario. For example, the nursing care robot 11 may utter an utterance whose content corresponds to the preference or state of the target person.

In step S102, the nursing care robot 11 executes branching interaction motion processing.

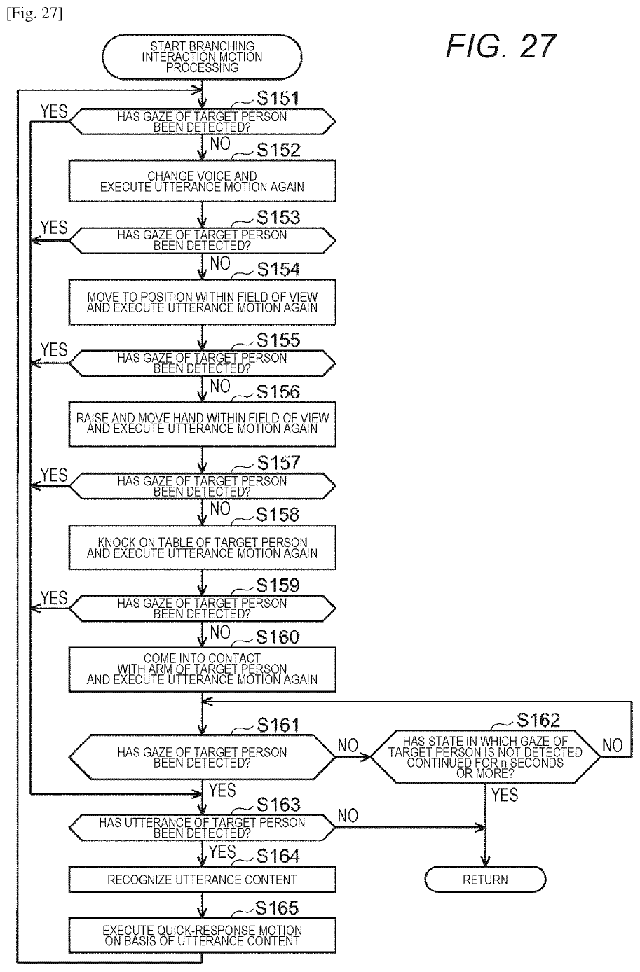

Here, details of the branching interaction motion processing will be described with reference to the flowchart of FIG. 27.

In step S151, it is determined whether or not the gaze of the target person has been detected, similarly to the processing of step S60 in FIG. 23. In a case where it is determined that the gaze of the target person has not been detected, the processing proceeds to step S152.

In step S152, the nursing care robot 11 changes the voice and executes the utterance motion again. Specifically, the nursing care robot 11 executes again at least some utterance motions executed in step S101 in FIG. 26. At this time, for example, the voice output control unit 257 increases the volume of the uttered voice output from the speaker 208 to emphasize a low frequency band. As a result, the target person can easily hear the uttered voice of the nursing care robot 11, and it is expected that the target person focuses on the utterance notion of the nursing care robot 11.

In step S153, it is determined whether or not the gaze of the target person has been detected, similarly to the processing of step S60 in FIG. 23. In a case where it is determined that the gaze of the target person has not been detected, the processing proceeds to step S154.

In step S154, the nursing care robot 11 moves to a position within the field of view and executes the utterance motion again. Specifically, the tracking motion control unit 255 moves the nursing care robot 11 to a position within the field of view of the target person by controlling the carriage drive unit 212 on the basis of the face orientation or the line-of-sight direction of the target person. Then, the nursing care robot 11 executes again at least some utterance motions executed in step S101 in FIG. 26.

In step S155, it is determined whether or not the gaze of the target person has been detected, similarly to the processing of step S60 in FIG. 23. In a case where it is determined that the gaze of the target person has not been detected, the processing proceeds to step S156.

In step S156, the nursing care robot 11 raises and moves the hand within the field of view, and executes the utterance motion again. For example, the tracking motion control unit 255 controls the actuator 209 to raise the hand 63 not holding the hand display 91 up to the height of the head portion 21 and execute an operation such as waving the hand 63 within the field of view of the target person. Then, the nursing care robot 11 executes again at least some utterance motions executed in step S101 in FIG. 26.

In step S157, it is determined whether or not the gaze of the target person has been detected, similarly to the processing of step S60 in FIG. 23. In a case where it is determined that the gaze of the target person has not been detected, the processing proceeds to step S158.

In step S158, the nursing care robot 11 knocks on the table 12 of the target person and executes the utterance motion again. For example, the tracking motion control unit 255 controls the actuator 209 to knocks on the top plate of the table 12 with the hand 63 not holding the hand display 91. Then, the nursing care robot 11 executes again at least some utterance motions executed in step S101 in FIG. 26.

In step S159, it is determined whether or not the gaze of the target person has been detected, similarly to the processing of step S60 in FIG. 23. In a case where it is determined that the gaze of the target person has not been detected, the processing proceeds to step S160.

In step S160, the nursing care robot 11 comes into contact with the arm of the target person and executes the utterance motion again. For example, the tracking motion control unit 255 controls the actuator 209 to bring the hand 63 not holding the hand display 91 into contact with the arm of the target person. Then, the nursing care robot 11 executes again at least some utterance motions executed in step S101 in FIG. 26.

In step S161, it is determined whether or not the gaze of the target person has been detected, similarly to the processing of step S60 in FIG. 23. In a case where it is determined that the gaze of the target person has not been detected, the processing proceeds to step S162.

In step S162, it is determined whether or not the state in which the gaze of the target person is not detected has continued for n seconds or more, similarly to the processing of step S61 in FIG. 23. In a case where it is determined that the state in which the gaze of the target person is not detected has not continued for n seconds or more, the processing returns to step S161.

Thereafter, the pieces of processing of steps S161 and S162 are repeatedly executed until it is determined in step S161 that the gaze of the target person has been detected or it is determined in step S162 that the state in which the gaze of the target person is not detected has continued for n seconds or more.

On the other hand, in a case where it is determined in step S151, step S153, step S155, step S157, step S159, or step S161 that the gaze of the target person has been detected, the processing proceeds to step S163.

In step S163, the voice information processing unit 232 determines whether or not utterance of the target person has been detected on the basis of the voice data supplied from the microphone 202. In a case where it is determined that the utterance of the target person has been detected, the processing proceeds to step S164.

In step S164, the voice information processing unit 232 recognizes the utterance content. For example, the voice information processing unit 232 recognizes a phrase registered in advance from the detected utterance of the target person. The registered phrase may be only one word or may be a combination of a plurality of words.

In step S165, the nursing care robot 11 executes a quick-response motion according to the utterance content. Specifically, the voice information processing unit 232 notifies the action control unit 224 of a result of recognizing the utterance content. That is, the voice information processing unit 232 notifies the action control unit 224 of the phrase recognized from the utterance of the target person.

The scenario execution control unit 254 selects the type of the quick-response to be made for the utterance of the target person on the basis of the result of recognizing the utterance content. For example, the scenario execution control unit 254 selects the quick-response to be executed on the basis of the phrase in the utterance recognized by the voice information processing unit 232.

For example, the quick-response is classified into the following 10 types.
1. Gratitude for being informed
2. Response
3. Affirmation
4. Consideration
5. Waiting
6. Praise
7. Empathy
8. Greeting
9. Appreciation
10. Name

For example, the quick-response classified as “1. Gratitude for being informed” includes a quick-response such as “Thank you for telling me”.

For example, the quick-response classified as “2. Response” includes a quick-response such as “Yes” and “Yeah”.

For example, the quick-response classified as “3. Affirmation” includes a quick-response such as “Mm-hmm” and “Mmmnnn”.

For example, the quick-response classified as “4. Consideration” includes a quick-response such as “Are you ok?”, “I understand”, or “I will tell the staff”.

For example, the quick-response classified as “5. Waiting” includes a quick-response such as “It's almost here” or “Wait a minute”.

For example, the quick-response classified as “6. Praise” includes a quick response such as “You look nice today”, “You are good”, or “As expected”.

For example, the quick-response classified as “7. Empathy” includes a quick-response such as “Great” or “Good for you”.

For example, the quick response classified as “8. Greeting” includes a quick response such as “Good morning” and “Hello”.

For example, the quick-response classified as “9. Appreciation” includes a quick-response such as “Thank you”.

For example, the quick-response classified as “10. Name” includes a quick-response such as “I'm Hanamo” and “Call me Hana”. Note that Hanamo is an example of the name of the nursing care robot 11.

Note that the scenario execution control unit 254 selects the quick response of “3. Affirmation” in a case where a corresponding phrase has not been recognized from the utterance of the target person or in a case where the utterance content has not been recognized. For example, in a case where the target person utters a speech “I like cats” and the voice information processing unit 232 has not been able to recognize the corresponding phrase, the scenario execution control unit 254 selects the quick response such as “Mm-hmm”, for example.

Then, the nursing care robot 11 executes the quick-response motion including the selected quick-response. Specifically, the voice output control unit 257 causes the speaker 208 to output an uttered voice for the selected quick-response. Furthermore, the motor drive control unit 256 controls the actuator 209 as necessary to execute a motion corresponding to the quick-response.

Thereafter, the processing returns to step S151, and the pieces of processing of steps S151 to S165 are repeatedly executed until it is determined in step S162 that the state in which the gaze of the target person is not detected has continued for n seconds or more, or it is determined in step S163 that the utterance of the target person has not been detected.

On the other hand, the branching interaction motion processing ends in a case where it is determined in step S162 that the state in which the gaze of the target person is not detected has continued for n seconds or more, or in a case where it is determined in step S163 that the utterance of the target person has not been detected.

As described above, in the branching interaction motion processing, the nursing care robot 11 executes at least some utterance motions again while adding a motion to urge the target person to gaze or changing the voice. As a result, the target person is urged to gaze at the nursing care robot 11.

Returning to FIG. 26, in step S103, the scenario execution control unit 254 determines whether or not the state in which the gaze of the target person is not detected has continued for n seconds or more on the basis of the result of the processing of step S102. In a case where it is determined that the state in which the gaze of the target person is not detected has not continued for n seconds or more, the processing proceeds to step S104.

In step S104, the scenario execution control unit 254 determines whether or not there is a next utterance motion. In a case where it is determined that there is a next utterance motion, the processing returns to step S101.

Thereafter, the pieces of processing of steps S101 to S104 are repeatedly executed until it is determined in step S103 that the state in which the gaze of the target person is not detected has continued for n seconds or more, or it is determined in step S104 that there is no next utterance motion. As a result, the utterance motions of the application are sequentially executed according to the scenario.

On the other hand, in a case where it is determined in step S104 that there is no next utterance motion, the processing proceeds to step S105. This is a case where all the utterance motions of the application have been executed according to the scenario.

Furthermore, in a case where it is determined in step S103 that the state in which the gaze of the target person is not detected has continued for n seconds or more, the processing of step S104 is skipped, and the processing proceeds to step S105. This is, for example, a case where the application is terminated in the middle of the scenario because a positive reaction of the target person is not obtained.

In step S105, the nursing care robot 11 executes an end motion. For example, the nursing care robot 11 executes the utterance motion corresponding to a promise of a reunion as the end motion by processing similar to step S9 in FIG. 19.

Thereafter, the content provision processing ends.

### Second Specific Example of Content Provision Processing

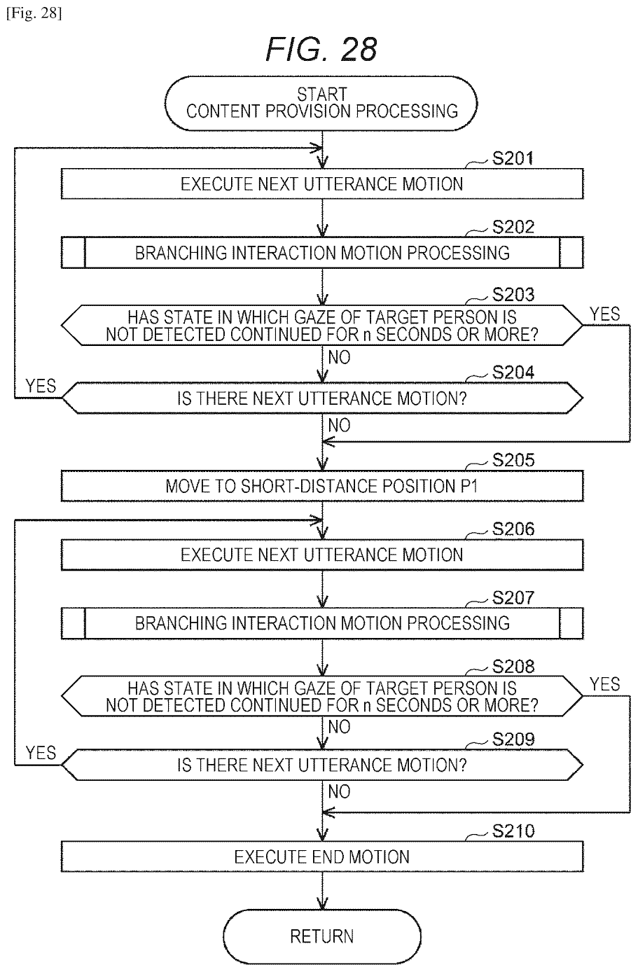

Next, a second embodiment of the content provision processing of step S66 in FIG. 24 will be described with reference to the flowchart of FIG. 28.

Note that, for example, the nursing care robot 11 provides the content to the target person by executing the processing of FIG. 29 to be described later while executing the processing of FIG. 28.

In the second embodiment of the content provision processing, the content is provided at the middle-distance position P2 and the short-distance position P1.

In steps S201 to S204, pieces of processing similar to steps S101 to S104 in FIG. 26 are executed. That is, the utterance motion and the branching interaction motion are executed at the middle-distance position P2.

In step S205, the nursing care robot 11 moves to the short-distance position P1. For example, the navigation control unit 258 controls the carriage drive unit 212 to move the nursing care robot 11 from the middle-distance position P2 to the short-distance position P1.

In steps S206 to S210, pieces of processing similar to steps S101 to S105 in FIG. 26 are executed. That is, the utterance motion, the branching interaction motion, and the end motion are executed at the short-distance position P1.

Thereafter, the content provision processing ends.

Note that, for example, the nursing care robot 11 may move between the short-distance position P1 and the middle-distance position P2 as necessary after moving to the short-distance position P1.

### Specific Example of Content Provision Processing

Next, a specific example of the content provision processing of step S66 in FIG. 24 will be described with reference to the flowchart of FIG. 29.

For example, the nursing care robot 11 executes the processing of FIG. 29 while executing the processing described above with reference to FIG. 26 or 28.

In step S251, the nursing care robot 11 greets the target person by processing similar to step S2 in FIG. 19 described above. At this time, the nursing care robot 11 moves to the middle-distance position P2 or the short-distance position P1 as necessary.

In step S252, the nursing care robot 11 introduces itself. For example, the motor drive control unit 256 controls the actuator 209 to direct the face of the nursing care robot 11 toward the face of the target person under the control of the tracking motion control unit 255. Furthermore, the motor drive control unit 256 controls the actuator 209 to cause the nursing care robot 11 to execute a self-introduction motion. The voice output control unit 257 causes the speaker 208 to output an uttered voice for self-introduction in accordance with the motion of the nursing care robot 11.

In step S253, the nursing care robot 11 executes the utterance motion according to the target person. Specifically, the nursing care robot 11 executes the utterance motion by processing similar to step S59 in FIG. 23. At this time, the utterance content is arranged on the basis of the state, reaction, or the like of the target person recognized by the image information processing unit 231.

For example, the nursing care robot 11 outputs an uttered voice related to the recognized state of the target person. For example, in a case where the color of clothes of the target person is recognized, the nursing care robot 11 notifies the target person of the recognition result by outputting an uttered voice such as “Today's clothes are purple”. For example, in a case where the smiling face of the target person is recognized, the nursing care robot 11 notifies the target person of the recognition result by outputting an uttered voice such as “It makes me happy to see you smile”. For example, the nursing care robot 11 transmits the recognition result to the target person by outputting an uttered voice such as “Thanks for waving” on the basis of a result of recognizing the motion of the hand of the target person.

As described above, the recognition result regarding the state of the target person is fed back to the target person, so that the target person can feel that the nursing care robot 11 recognizes himself/herself or obtain an appropriate response from the nursing care robot 11. This improves an experience value of the target person.

Note that, since there is a possibility that accuracy in recognition of an uttered voice by an elderly person may be low, a feedback based on an image recognition result may be preferentially executed according to the situation.

In step S254, the nursing care robot 11 asks the target person a question. Specifically, the nursing care robot 11 executes an utterance motion by processing similar to step S59 in FIG. 23, and asks the target person some simple questions. For example, the nursing care robot 11 asks the target person a question that can be immediately answered such as “What is your name?”, “How old are you?”, “Where are you from?”, or “Do you like strawberries?”.

In response to this, the voice information processing unit 232 measures a silent response time from when the nursing care robot 11 asks a question to when the target person starts to answer the question.

Note that, in the measurement of the response time, correctness or incorrectness of an answer content may be considered or does not have to be considered.

In the former case, for example, a response time in a case where a correct answer is provided is measured. This makes it possible to measure the response time while considering a cognitive state of the target person. In this case, for example, the response time is measured using speech recognition.

In the latter case, since it is not typically necessary to recognize the answer content of the target person, for example, the response time can be measured using volume recognition instead of speech recognition. Alternatively, for example, the response time can be measured using a result of image recognition for opening and closing of the mouth, a change in facial expression, a nodding motion of the head, a motion of the hand, and the like. For example, in a case where image recognition is used, the response time can be measured even in a case where the target person fails in utterance or the utterance volume is too small when the target person answers the question. Note that the measurement accuracy may be improved by measuring the response time by using a combination of volume recognition and image recognition.

The learning unit 225 learns an appropriate interaction interval for the target person on the basis of the response time measurement result. That is, the learning unit 225 learns an appropriate time from the end of the utterance to the start of the next utterance.

By appropriately setting the interaction interval, the interaction between the nursing care robot 11 and the target person becomes smooth. On the other hand, in a case where an interval between utterances is not appropriately set, the target person may not be able to respond or the target person may wait too long.

The learning unit 225 supplies the interaction interval learning result to the application setting unit 222. The parameter setting unit 241 adjusts the interaction interval on the basis of the learning result.

Note that, for example, the nursing care robot 11 may utter a greeting such as “Good morning” instead of a question, and measure a time until a response to the greeting is started.

Furthermore, for example, the learning unit 225 may learn the preference of the target person on the basis of at least one of the answer content or the reaction of the target person. Furthermore, for example, the scenario execution control unit 254 may control the material of the content to be presented on the basis of at least one of the answer content or the reaction of the target person.

In this manner, in steps S251 to S254, a content start set is executed.

In step S255, the nursing care robot 11 causes the target person to recognize the content to be provided. For example, pieces of processing similar to steps S3 to S6 in FIG. 19 are executed.

In step S256, the content is provided similarly to the processing of step S7 in FIG. 19.

In this manner, in steps S255 and S256, a content execution set is executed.

In step S257, the nursing care robot 11 executes looking back of the content. For example, the motor drive control unit 256 controls the actuator 209 to cause the nursing care robot 11 to execute a motion for giving a positive feeling to the target person while looking back the provided content with the target person under the control of the scenario execution control unit 254. The voice output control unit 257 causes the speaker 208 to output a voice for giving a positive feeling to the target person while looking back the provided content with the target person under the control of the scenario execution control unit 254.

In step S258, the utterance motion according to the target person is executed similarly to the processing of step S253. At this time, for example, the utterance content is arranged on the basis of the state, reaction, or the like of the target person recognized by the image information processing unit 231 during the provision of the content.

In step S259, the nursing care robot 11 asks the target person of a question similarly to the processing of step S254. At this time, for example, a simple question regarding the content of the provided content or the like is made.

Note that, in a case where a plurality of contents is included in the application being executed, for example, the pieces of processing of steps S255 and S256 or the pieces of processing of steps S255 to S259 are repeatedly executed.

In step S260, similarly to the processing of step S9 in FIG. 19, a promise of a reunion is executed.

Thereafter, the content provision processing ends.

As described above, the nursing care robot 11 can execute various applications while appropriately providing a content for each target person. That is, the nursing care robot 11 can execute various applications while providing a content with an appropriate material by an appropriate method for each target person.

For example, the nursing care robot 11 can go around while performing recreation individually for each target person. Examples of the individual recreation include singing, interaction, measurement of the vital value of the target person, and oral calisthenics.

The oral calisthenics are calisthenics for moving the muscles of the throat of the target person, and are effective in preventing choking hazards. For example, the oral calisthenics is also referred to as “PATACARA calisthenics” because it prompts the target person to utter sounds of greatly moving the muscles of the throat like “PA”. “TA”, “KA”, and “RA”.

For example, the nursing care robot 11 displays, on the hand display 91, a sentence containing a lot of “PA”, “TA”, “KA”, and “RA” sounds, such as “PANDA NO PAPA NO TAKARA MONO (“the treasure of panda's dad” in Japanese)”, to prompt the target person to utter a sentence containing a lot of “PA”, “TA”, “KA”, and “RA” sounds. For example, the nursing care robot 11 prompts the target person to sing a song including the sounds “PA”, “TA”, “KA”, and “RA”.

Further, for example, the nursing care robot 11 can distribute a present to each target person.

For example, the nursing care robot 11 can come close to each target person and execute an interaction to know happy moments, preferences, dreams, or the like of each target person.

### Example of Method of Handing Over User Database

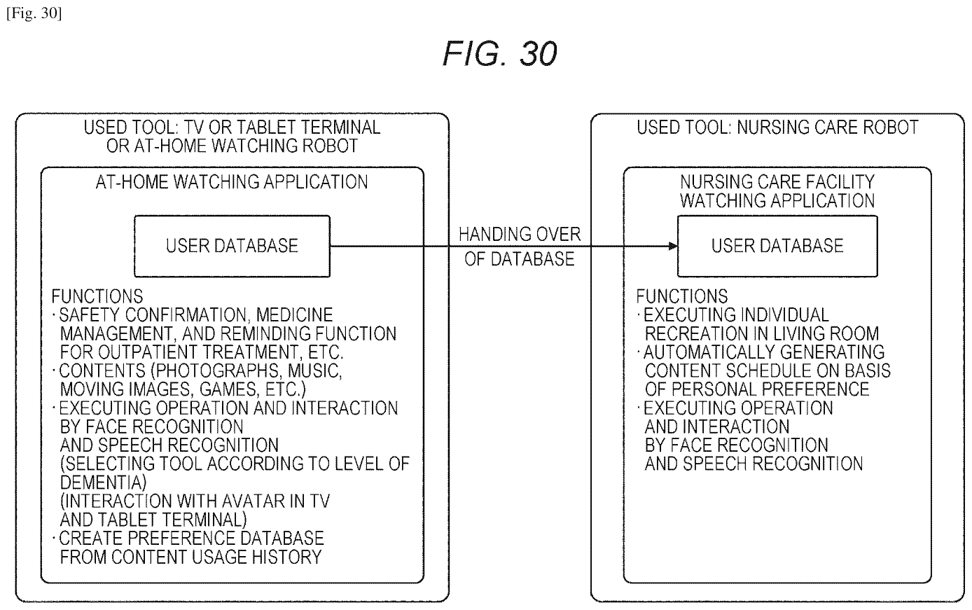

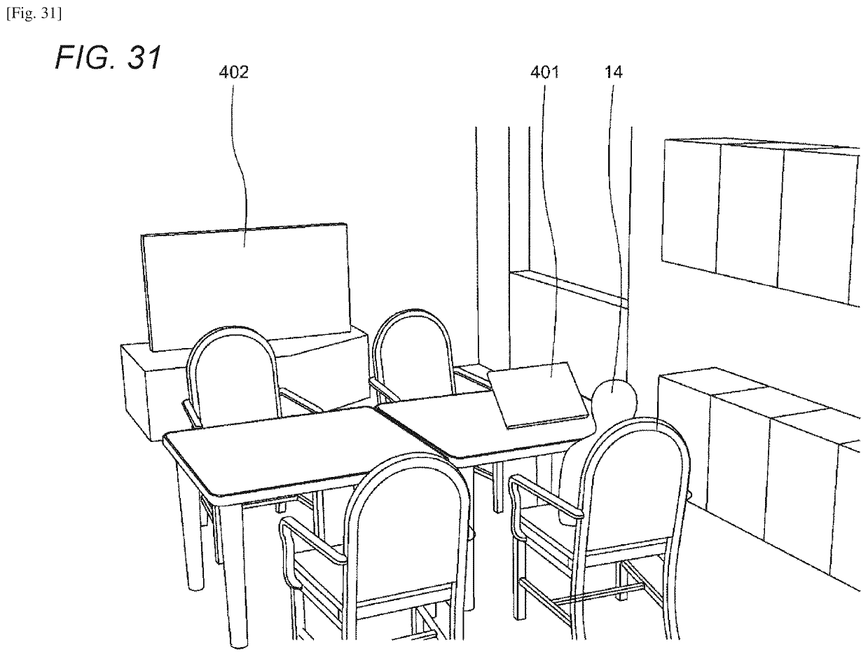

Next, an example of a method of handing over the user database will be described with reference to FIGS. 30 and 31.

For example, since there is no user database of the target person immediately after the target person enters the nursing care facility, it is difficult to adjust the application execution method (for example, the operation parameter) according to the target person as described above.

On the other hand, for example, the user database may be created and updated at home before the user enters the nursing care facility, and the user database created at home may be handed over after the user enters the nursing care facility.

For example, an at-home watching application is provided at home before the target person enters the nursing care facility. The at-home watching application is provided using a TV, a tablet terminal, or an at-home watching robot. For example, as illustrated in FIG. 31, a tablet terminal 401 or a TV 402 placed on a desk at the home of the target person 14 is used.

The at-home watching application is mainly targeted at, for example, the target person whose care needs level is 1 or 2.

For example, the at-home watching application provides a reminding function such as safety confirmation, medicine management, or outpatient treatment. Note that, for example, the at-home watching application may provide a function of supporting a call with a family member or friend.

For example, the at-home watching application provides a content such as photographs, music, moving images, and games.

For example, the at-home watching application performs an operation or interaction using face recognition or speech recognition. In this case, a tool is selected depending on the degree of dementia. In addition, an interaction with an avatar is provided in a TV or a tablet terminal.

Note that the avatar displayed on the at-home watching robot or the TV or the tablet terminal is desirably the same as or relevant to the nursing care robot 11, for example. At least the at-home watching robot and the avatar are desirably characters having the same face and voice as those of the nursing care robot 11.

As a result, for example, when the target person leaves home and enters the nursing care facility, acceptability of the nursing care robot 11 increases (for example, it is considered that the nursing care robot 11 comes from home), and the target person is prevented from feeling lonely.

For example, the at-home watching application creates a database of the preference of the target person on the basis of a content use history. That is, the preference of the target person is reflected in the user database.

Then, in a case where the target person enters the nursing care facility, the user database created by the at-home watching application is handed over to the nursing care facility. For example, the user database created by the at-home watching application is stored in the user database 114 of FIG. 13.

In the nursing care facility, a nursing care facility watching application for the nursing care facility is provided using the above-described nursing care robot 11 (child-type nursing care robot).

The nursing care facility watching application is mainly targeted at, for example, the target person whose care needs level is 3 or higher.

For example, the nursing care facility watching application performs individual recreation in the living room.

For example, the nursing care facility watching application automatically generates a content schedule on the basis of a personal preference.

For example, the nursing care facility watching application executes an operation or interaction using face recognition or speech recognition. In this case, the nursing care robot 11 executes the operation or interaction.

Note that the provision of the content and the interaction are executed on the basis of the database based on the database created at home before the entrance, and thus the acceptability for the target person is high.

In addition, it is not necessary to newly execute face registration, voice registration, and registration of content preference information of the target person after the entrance, so that a burden on the target person and the staff is reduced.

Moreover, since it is not necessary to execute an operation of selecting a content suitable for the target person from among a number of contents, a burden on the staff is reduced.

In addition, since the at-home watching application of the same system is provided to the target person before the entrance, the acceptability of the nursing care facility watching application for the target person is high even immediately after the entrance.

### <Middle-Term Development of User Database>

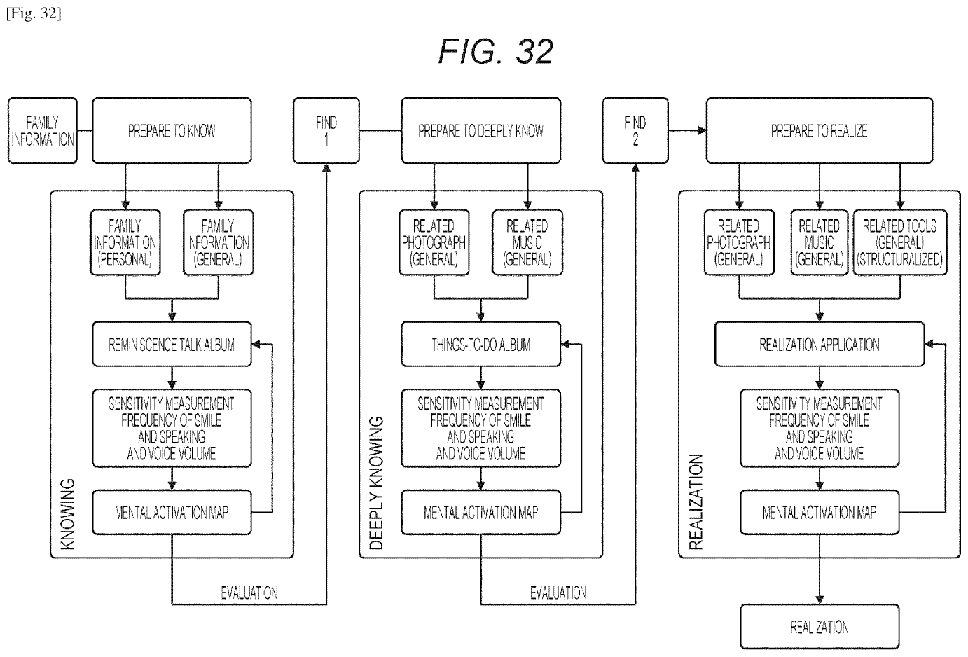

Next, an example of middle-term development of the user database will be described with reference to FIG. 32. That is, an example of a method for improving the QOL of the target person by finding and providing what the target person really wants to do after the target person enters the facility will be described.

First, the staff prepares to know the target person on the basis of family information acquired from a family member of the target person. Specifically, for example, the staff selects the content to be provided to the target person from among the contents selected by the nursing care robot 11 on the basis of the user database created at home (at-home watching application). Alternatively, for example, the nursing care robot 11 or the server 113 may propose or automatically select the content to be provided to the target person on the basis of the user database.

For example, a family photograph and a related photograph of the target person are selected as the contents to be provided to the target person. It is desirable that the family photograph reflects a personal episode. The related photograph is a general photograph, and for example, it is desirable that a photograph of a noted product, a famous product, a famous place, and the like related to the target person (preferred by the target person) is shown in the related photograph.

Note that, for example, the staff may plan recreation to be performed for the target person on the basis of the user database.

The nursing care robot 1 executes an application called a reminiscence talk album. For example, the nursing care robot 11 interacts with the target person while looking at the family photograph and the related photograph. Then, the nursing care robot 11 measures the sensitivity of the target person in the middle of interaction. For the sensitivity of the target person, for example, one or more of a frequency of a smile of the target person, a frequency of speaking, and a voice volume are used. Note that, for example, a change in vital measurement value such as a body temperature or a heart rate of the target person, a change in facial expression, and a change in motion can also be used for the sensitivity of the target person.

Then, the nursing care robot 11 or the server 113 generates a mental activation map on the basis of the measured sensitivity. The mental activation map is, for example, a map of the sensitivity of the target person to the content in the presented photograph.

Thereafter, for example, the reminiscence talk album is repeatedly executed until a content for which the sensitivity of the target person is equal to or higher than a predetermined threshold appears, and the mental activation map is updated.

Next, the staff prepares to deeply know the target person. For example, the staff selects the content to be provided to the target person while viewing the mental activation map. For example, the staff selects a related photograph and related music to be presented to the target person. The related photograph and the related music are a general photograph and general music. Alternatively, for example, the nursing care robot 11 or the server 113 may provide or automatically select the content to be provided to the target person.

The nursing care robot 1 executes an application called a things-to-do album. For example, the nursing care robot 11 interacts with the target person while looking at the related photograph or listening to the related music. Then, the nursing care robot 11 measures the sensitivity of the target person who is in the middle of interaction by a method similar to that for the reminiscence talk album, and the nursing care robot 11 or the server 113 generates the mental activation map.

Thereafter, for example, the things-to-do album is repeatedly executed until a content for which the sensitivity of the target person is equal to or higher than a predetermined threshold appears, and the mental activation map is updated.

Next, the staff prepares to realize. For example, the staff selects a content that the target person is likely to realize while viewing the new mental activation map. For example, the staff selects a related photograph, related music, and a related tool to be presented to the target person. The related photograph and the related music are a general photograph and general music, and the related tool is a general structuralized tool.

The nursing care robot 11 executes a realization application. For example, the nursing care robot 11 takes the related tool and interacts with the target person while viewing the related photograph or listening to the related music. Then, the nursing care robot 11 measures the sensitivity of the target person who is in the middle of interaction by a method similar to that for the reminiscence talk album and the things-to-do album, and the nursing care robot 11 or the server 113 generates the mental activation map.

Thereafter, for example, the realization application album is repeatedly executed until a content for which the sensitivity of the target person is equal to or higher than a predetermined threshold appears, and the mental activation map is updated.

This makes it possible, for example, to find and execute what the target person wants to do anew.

### 2. Modifications of First Embodiment of Present Technology>

Next, modifications of the first embodiment of the present technology will be described.

### Modifications of Hand (Robot Hand Mechanism) of Nursing Care Robot 11

First, modifications of a robot hand mechanism which is the hand of the nursing care robot 11 will be described.

Note that, although modifications of the right hand of the nursing care robot 11 will be described below, it is assumed that the left hand also has a similar configuration in left-right symmetry.

### First Modification of Hand

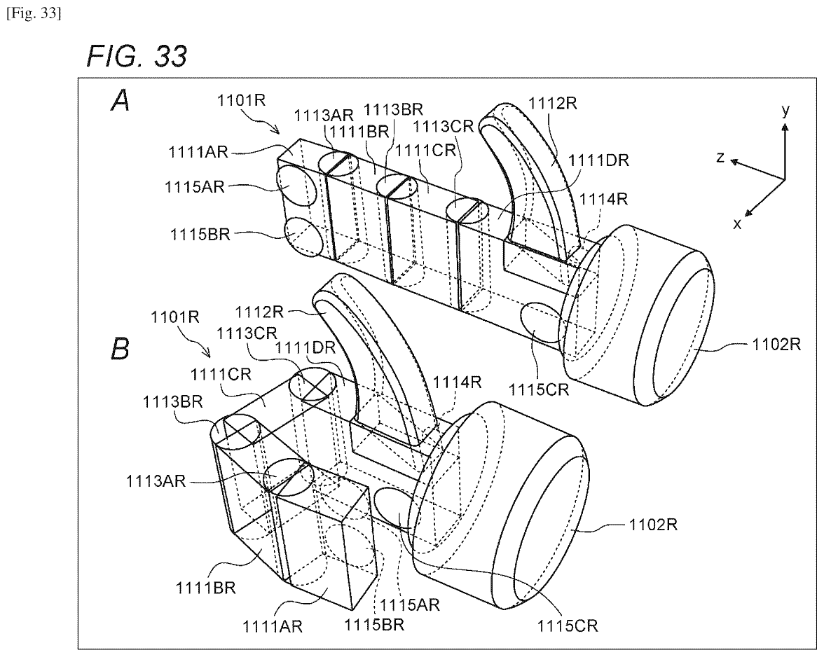

First, a first modification of the hand of the nursing care robot 11 will be described with reference to FIGS. 33 to 35.

FIGS. 33 to 35 schematically illustrate a configuration example of an appearance of a hand 1101R corresponding to the right hand of the nursing care robot 11. In FIGS. 33 to 35, a part of the hand 1101R is see-through, and the see-through portion is indicated by a dotted line. This similarly applies to the following drawings.

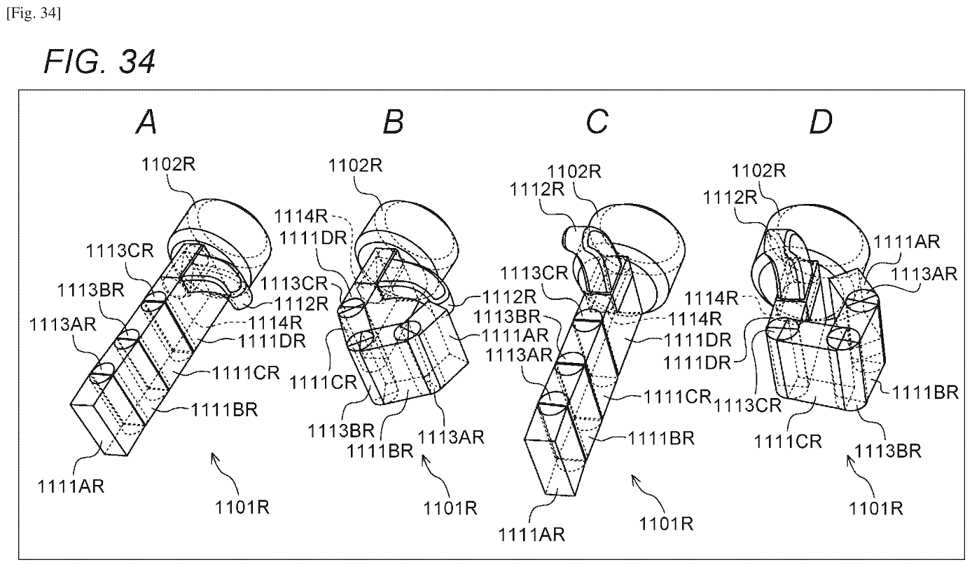

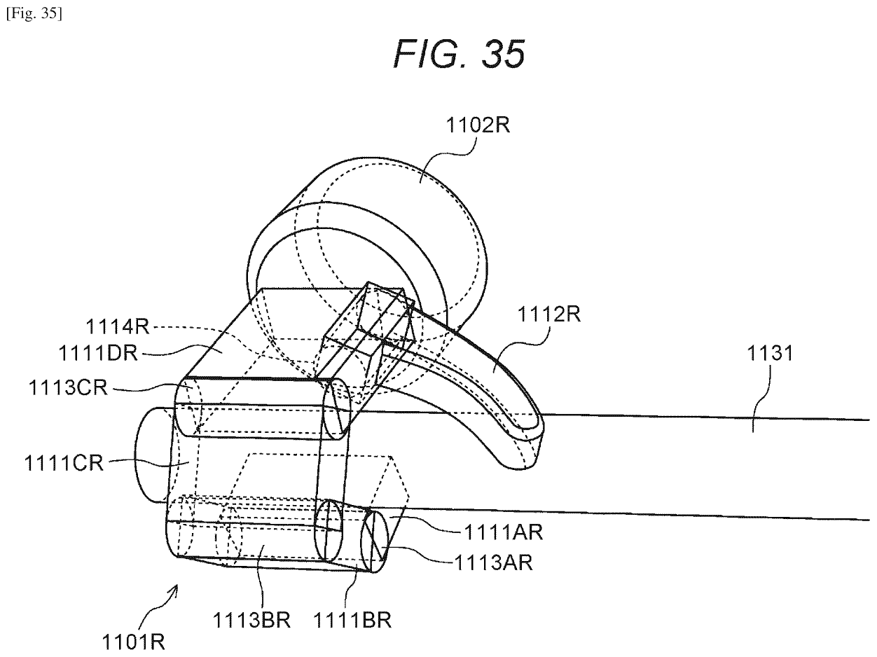

A of FIG. 33 illustrates a state in which the hand 1101R is spread. B of FIG. 33 illustrates a state in which a portion corresponding to the thumb of the hand 1101R is spread and a portion corresponding to a finger other than the thumb is bent. A of FIG. 34 illustrates a state in which a portion corresponding to the portion (hereinafter, referred to as a main portion) other than the thumb of the hand 1101R is spread and the portion corresponding to the thumb is bent. B of FIG. 34 illustrates a state in which the portions corresponding to the respective fingers of the hand 1101R are bent, that is, a state in which the hand 1101R is clenched into a fist. C of FIG. 34 illustrates a state in which the hand 1101R is spread, similarly to A of FIG. 33. D of FIG. 34 illustrates a state in which the portion corresponding to the thumb of the hand 1101R is spread and the portion corresponding to the finger other than the thumb is bent similarly to B of FIG. 33. FIG. 35 illustrates a state in which the hand 1101R grasps a rod-shaped bar 1131.

Hereinafter, a coordinate system is defined as illustrated in FIG. 33. A thickness direction of the hand 1101R is defined as an x-axis direction, and a direction from the back of the hand toward the palm is defined as a positive direction. A width direction of the hand 1101R is defined as a y-axis direction, and a direction from the little finger toward the thumb is defined as a positive direction. A longitudinal direction of the hand 1101R (a direction in which the hand 1101R extends) is defined as a z-axis direction, and a direction from the wrist toward the fingertip is defined as a positive direction. An x axis, a y axis, and a z axis are orthogonal to each other.

Hereinafter, a rotation direction around a rotation axis (roll axis) parallel to the x axis is defined as a roll direction. A rotation direction around a rotation axis (pitch axis) parallel to the y axis is defined as a pitch direction. A rotation direction around a rotation axis (yaw axis) parallel to the z axis is defined as a yaw direction. The roll direction, the pitch direction, and the yaw direction are orthogonal to each other.

A similar coordinate system is applied in the following modifications of the nursing care robot 11.

A base of the hand 1101R is supported by a cylindrical part 1102R. The hand 1101R includes parts 1111AR to 1111DR corresponding to the main portion other than the thumb, a part 1112R corresponding to the thumb, actuators 1113AR to 1113CR, an actuator 1114R, and tactile sensors 1115AR to 1115CR.

Note that the tactile sensors 1115AR to 1115CR are not illustrated in FIGS. 34 and 35.

The part 1111AR is a rectangular plate-shaped member corresponding to distal sections of the index finger to the little finger.

The part 1111BR is a rectangular plate-shaped member corresponding to middle sections of the index finger to the little finger.

The part 1111CR is a rectangular plate-shaped member corresponding to proximal sections of the index finger to the little finger.

The part 1111DR is a rectangular plate-shaped member corresponding to the palm and the back of the hand.

The part 1112R has a shape in which a thumb portion having a thumb shape is connected to a side surface of a cylindrical rotation shaft. The rotation shaft of the part 1112R is arranged in the part 1111DR in such a way as to extend in the x-axis direction near a base and an end portion of the part 111DR in the y-axis direction. The diameter of the rotation shaft of the part 1112R and the thickness of the thumb portion are substantially the same as the thickness of the part 1111DR.

Note that the shape of the thumb portion is not limited to this example. For example, the thumb portion may have a frame shape having an angle of 45 degrees to 90 degrees with respect to the Z axis. In addition, a cross section of the thumb portion may have a shape suitable for gripping an object or may have a circular shape (that is, the thumb portion has a cylindrical shape).

The parts 1111AR to 1111DR are connected in such a way as to be arranged in the z-axis direction via the actuators 1113AR to 1113CR in a state where the hand 1101R is spread. Therefore, the main portion of the hand 1101R has a plate shape in a state where the hand 1101R is spread.

The actuator 1113AR corresponds to distal inter phalangeal (DIP) joints of the index finger to the little finger, connects the parts 1111AR and 1111BR, and serves as the pitch axis extending in the y-axis direction. The actuator 1113AR rotates the part 1111AR in the pitch direction with respect to the part 1111BR to move the part 1111AR closer to the part 1111BR or away from the part 1111BR. As a result, a portion of the hand 1101R that corresponds to the DIP joints of the index finger to the little finger can be bent and spread in the pitch direction.

The actuator 1113BR corresponds to proximal inter phalangeal (PIP) joints of the index finger to the little finger, connects the parts 1111BR and 1111CR, and serves as the pitch axis extending in the y-axis direction. The actuator 1113BR rotates the part 1111BR in the pitch direction with respect to the part 1111CR to move the part 1111BR closer to the part 1111CR or away from the part 1111CR. As a result, a portion of the hand 1101R that corresponds to the PIP joints of the index finger to the little finger can be bent and spread in the pitch direction.

The actuator 1113CR corresponds to metacarpophalangeal (MP) joints of the index finger the little finger, connects the parts 1111CR and 1111DR, and serves as the pitch axis extending in the y-axis direction. The actuator 1113CR rotates the part 1111CR in the pitch direction with respect to the part 1111DR to move the part 1111CR closer to the part 1111DR or away from the part 1111DR. As a result, a portion of the hand 1101R that corresponds to the MP joints of the index finger to the little finger can be bent and spread in the pitch direction.

The actuator 1114R corresponds to an MP joint of the thumb, connects the parts 1111DR and 1112R, and serves as the yaw axis extending in the z-axis direction. The actuator 1114R is arranged in the rotation shaft of the part 1112R. Since the rotation shaft of the part 1112R is arranged in the part 1111DR, the actuator 1114R is also arranged in the part 1111DR. The actuator 1114R rotates the part 1112R in the yaw direction with respect to the part 1111DR to move the thumb portion of the part 1112R closer to the part 1111DR or away from the pail 1111DR. As a result, a portion of the hand 1101R that corresponds to the MP joint of the thumb can be rotated in the yaw direction.

Note that the rotation shaft of the part 1112R is not necessarily parallel to the z axis, and may be inclined in an oblique direction around the x axis (around the roll axis) with respect to the z axis. Specifically, for example, an orientation of the rotation shaft of the part 1112R may be within a range of ±45 degrees (−45 degrees to +45 degrees) around the x axis with respect to the z axis.

The tactile sensors 1115AR and 1115BR are provided near both ends of a palm-side tip of the part 1111AR in the width direction. The tactile sensor 1115CR is provided near a palm-side base of the part 1111DR and an end portion of the part 1111DR that is away from the part 1112R. As a result, contact with a palm side of the hand 1101R is detected.

Note that the shape, position, and number of tactile sensors in FIG. 33 are examples, and can be appropriately changed. For example, a tactile sensor may be provided on the part 1112R. Furthermore, for example, one or more of a force sensor, a proximity sensor, an image sensor, a contact switch, and the like may be used instead of or together with the tactile sensor.

The actuators 1113AR to 1113CR and the actuator 1114R are housed in the main portion of the hand 1101R including the parts 1111AR to 1111DR. Then, as illustrated in A of FIG. 33, in a state where the hand 1101R is spread (a state where the main portion and the thumb portion are spread), the actuators 1113AR to 1113CR and the actuator 1114R are arranged on the same plane. In addition, the parts 1111AR to 1111DR and the part 1112R form flat surfaces on both surfaces (the palm side and a back side of the hand) of the hand 1101R.

In this manner, since the flat surfaces are formed on the palm side of the hand 1101R in a state where the hand 1101R is spread, an interaction of the nursing care robot 11 with the target person becomes smooth. For example, since there is no obstacle in a case where the target person grasps the hand 1101R, a natural handshake is possible. For example, since the flat surface is formed, a contact area can be maximized at the time of contact with the target person, and thus, a pressure is dispersed, and it is possible to suppress the target person from feeling pain. For example, the nursing care robot 11 can spread the hand 1101R to rub, support, or pat the shoulder, back, hand, arm, or the like of the target person. At a site of nursing care, there are many opportunities to request contact or handshake with the target person. In this case, since the nursing care robot 11 can naturally touch the target person with the hand 1101R or the target person can naturally touch the hand 1101R, the acceptability for the target person is improved, and an interaction with the target person becomes smooth.

In addition, since the flat surface is formed, the degree of freedom of arrangement of sensors increases, and the sensors can be arranged at more appropriate positions. As a result, the measurement accuracy of the sensors is improved, and an interaction in which a contact force or the like is controlled is more appropriately executed.

In addition, a gripping function of the hand 1101R is implemented. For example, by bending each joint of the hand 1101R, it is possible to grasp, hold, or support an object such as a hand of a person. For example, an object can be gripped in parallel by a palm-side surface of the part 1111AR and a palm-side surface of the part 11 IDR. For example, a tip of the part 1111AR and a tip of the part 1112R can come into contact with each other, and an object can be held (gripped in parallel) by the tip of the part 1111AR and the tip of the part 1112R. For example, as illustrated in FIG. 35, the hand 1101R can firmly grasp the bar 1131 with the parts 1111AR to 1111DR and the part 1112R.

Note that, although not illustrated below, for example, the hand 1101R can perform parallel track gripping on the same plane. Specifically, for example, in a case of picking up a coin on a desk, the hand 1101R can grip the coin by bringing a tip of the thumb portion of the part 1112R and a tip of the main portion of the hand 1101R close to (substantially into contact with) the desk and operating the tip of the main portion of the hand 1101R on a track parallel to a gripping surface of the thumb portion of the part 1112R in a state where the position and posture of the arm portion 27R are fixed. This can be implemented because the main portion of the hand 1101R has three pitch axes, and controllability is favorable.

For example, the hand 1101R can take a gripping form of precision grasp corresponding to two surfaces with an angle with respect to an object (for example, a tapered object or a triangular prism-shaped object) in which representative two surfaces are not parallel to each other but form an angle.

For example, the band 1101R can take a gripping form of precision grasp and power grasp with respect to a spherical object, a cylindrical object, and a quadrangular prism-shaped object.

For example, the hand 1101R can take a gripping form of power grasp on the palm side of the main portion of the hand 1101R while supporting a moment load of an object (for example, a door handle or a frying pan) having a shape to which the moment load is applied with the thumb portion of the part 1112R.

As described above, the hand 1101R can facilitate an interaction between the nursing care robot 11 and the target person without impairing the gripping function.

### Second Modification of Hand

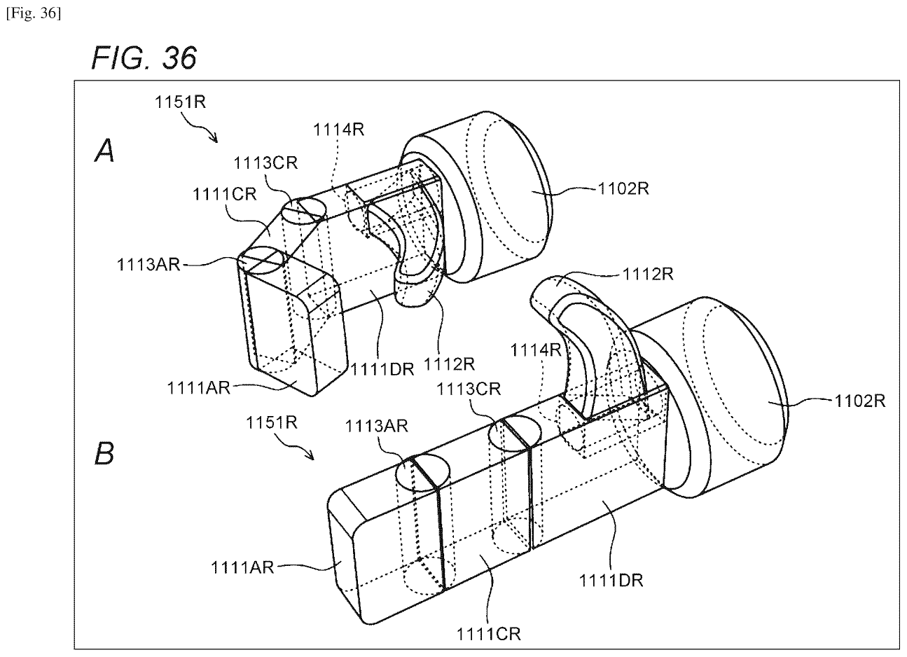

Next, a second modification of the hand of the nursing care robot 11 will be described with reference to FIG. 36.

FIG. 36 schematically illustrates a configuration example of an appearance of a hand 1151R corresponding to the right hand of the nursing care robot 11. A of FIG. 36 illustrates a state in which the hand 1151R is clenched into a fist. B of FIG. 36 illustrates a state in which the hand 1151R is opened. Note that, in the drawing, a portion corresponding to the hand 1101R in FIGS. 33 to 35 is denoted by the same reference numeral, and a description thereof will be omitted as appropriate.

The hand 1151R is different from the hand 1101R in that the part 1111BR and the actuator 1113BR are removed. That is, the hand 1151R is different from the hand 1101R in that portions corresponding to the middle sections of the index finger to the little finger and the PIP joints of the index finger to the little finger are removed, and the number of pitch axes for bending and spreading the portions corresponding to the index finger to the little finger are reduced from three to two.

In the hand 1151R, similarly to the band 1101R, flat surfaces are formed on both surfaces (a palm side and a back side of the hand) of the hand 1151R in an opened state. Therefore, similarly to the hand 1151R, the hand 1101R can facilitate an interaction between the nursing care robot 11 and the target person.

Further, like the hand 1101R, it is difficult for the hand 1151R to grip an object in parallel with a palm-side surface of a part 1111AR and a palm-side surface of a part 1111DR but the hand 1151R can freely grip an object.

### Third Modification of Hand

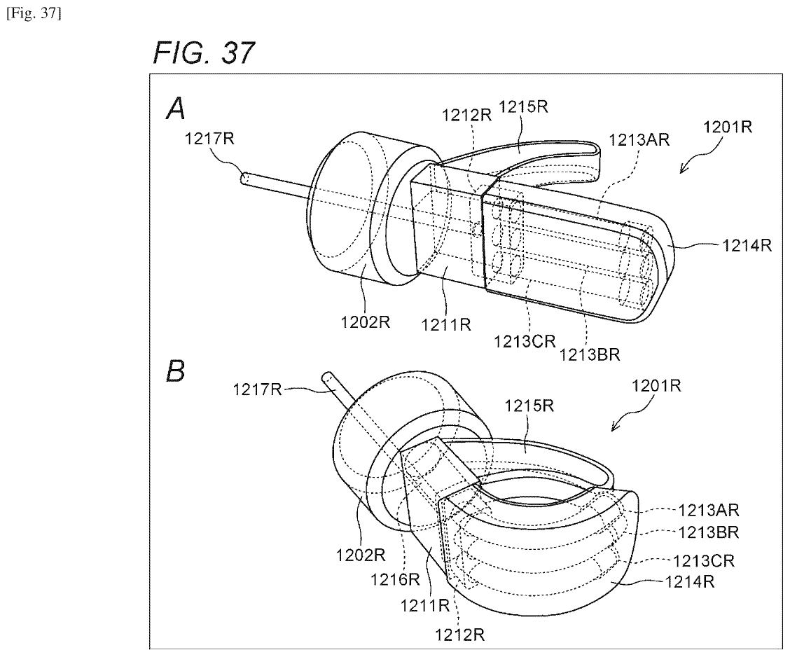

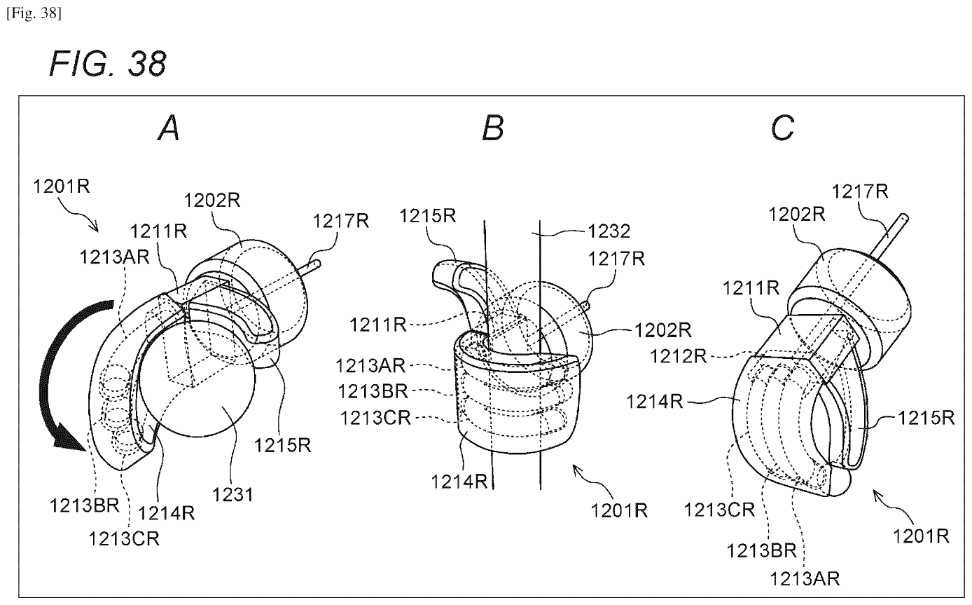

Next, a third modification of the hand of the nursing care robot 11 will be described with reference to FIGS. 37 and 38.

FIGS. 37 and 38 schematically illustrate a configuration example of an appearance of a hand 1201R corresponding to the right hand of the nursing care robot 11.

A of FIG. 37 illustrates a state in which a portion corresponding to a portion (hereinafter, referred to as a main portion) other than the thumb of the hand 1201R is spread and a portion corresponding to the thumb is bent. B of FIG. 37 illustrates a state in which portions corresponding to the respective fingers of the hand 1201R are bent, that is, a state in which the hand 1201R is clenched into a fist. A of FIG. 38 illustrates a state in which the hand 1201R grips a ball 1231. B of FIG. 38 illustrates a state in which the hand 1201R grips a rod-shaped bar 1232. C of FIG. 38 illustrates a state in which the hand 1201R holds a small object.

A base of the hand 1201R is supported by a cylindrical part 1202R. The hand 1201R includes a part 1211R, a pneumatic branching unit 1212R, pneumatic bending actuators 1213AR to 1213CR, an exterior 1214R, a part 1215R, an actuator 1216R, and a tube 1217R. The part 1211R, the pneumatic branching unit 1212R, the pneumatic bending actuators 12I 3AR to 1213CR, and the exterior 1214R correspond to the main portion of the hand. The part 1215R corresponds to the thumb and has a similar shape to that of the part 1112R of the hand 1101R.

Hereinafter, in a case where it is not necessary to individually distinguish the pneumatic bending actuators 1213AR to 1213CR, they are simply referred to as the pneumatic bending actuator 1213R.

Note that the actuator 1216R is not illustrated in A of FIG. 37 and FIG. 38.

The pail 1211R is a rectangular plate-shaped member corresponding to the palm and the back of the hand, similarly to the part 1111DR of the hand 1101R.

A distal end side of the pneumatic branching unit 1212R is inserted into the part 1211R, and a tip side of the pneumatic branching unit 1212R protrudes from the part 1211R.

Each pneumatic bending actuator 1213R is a cylindrical member having the same diameter. Distal ends of the respective pneumatic bending actuators 1213R are connected to a tip of the pneumatic branching unit 1212R, extend in the z-axis direction, and are arranged in the y-axis direction.

Each pneumatic bending actuator 1213R is covered with the exterior 1214R. A flexible and waterproof material such as urethane rubber is used for the exterior 1214R.

A rotation shaft of the part 1215R is arranged in the part 1211R in such a way as to extend in the x-axis direction at an end portion of the part 1211R in the width direction. The diameter of the rotation shaft of the part 1215R and the thickness of a thumb portion are substantially the same as the thickness of the part 1211R.

The actuator 1216R corresponds to the MP joint of the thumb, connects the parts 1211R and 1215R, and serves as the yaw axis extending in the z-axis direction. The actuator 1216R is arranged in the rotation shaft of the part 1215R. Since the rotation shaft of the part 1215R is arranged in the part 1211R, the actuator 1216R is also arranged in the part 1211R. The actuator 1216R rotates the part 1215R in the yaw direction with respect to the part 1211R, and moves the thumb portion of the part 1215R close to the part 1211R or away from the part 1211R. As a result, a portion of the hand 1201R that corresponds to the MP joint of the thumb can be rotated in the yaw direction.

Note that the rotation shaft of the part 1215R is not necessarily parallel to the z axis, and may be inclined in an oblique direction around the x axis (around the roll axis) with respect to the z axis. Specifically, for example, an orientation of the rotation shaft of the part 1215R may be within a range of 45 degrees around the x axis with respect to the z axis.

The tube 1217R penetrates through the part 1202R, and has one end connected to the distal end of the pneumatic branching unit 1212R and the other end connected to a pneumatic source (not illustrated).

Once the pneumatic source discharges air, the discharged air is inserted into each pneumatic bending actuator 1213R via the tube 1217R and the pneumatic branching unit 1212R. As a result, an air pressure in each pneumatic bending actuator 1213R increases.

On the other hand, once the pneumatic source sucks air, air in each pneumatic bending actuator 1213R is discharged via the pneumatic branching unit 1212R and the tube 1217R. As a result, the air pressure in each pneumatic bending actuator 1213R decreases.

As described above, by changing the air pressure in each pneumatic bending actuator 1213R, each pneumatic bending actuator 1213R and the exterior 1214R can be spread as illustrated in A of FIG. 37 or bent in the pitch direction as illustrated in B of FIG. 37. That is, a portion of the hand 1201R that corresponds to the index finger to the little finger can be bent and spread in the pitch direction.

Furthermore, as described above, the thumb portion of the part 1215R can be rotated in the yaw direction.

As a result, similarly to the hand 1101R, the hand 1201R can be spread or clenched into a fist.

For example, although not illustrated, flat surfaces are formed on both surfaces (the palm side and the back side of the hand) of the hand 1201R by spreading the hand 1201R. As a result, similarly to the hand 1101R, the hand 1201R can facilitate an interaction between the nursing care robot 11 and the target person.

Further, similarly to the hand 11011R, the hand 12011R can grasp, hold, and support an object such as a hand of a person.

For example, as illustrated in A of FIG. 38, the hand 1201R can grip a sphere such as the ball 1231 or an object (for example, a cup or a bowl having a tapered shape) having a curved surface in such a way as to cover the sphere or object. Furthermore, for example, also in a case where the nursing care target person shakes hands, the shape of the hand 1201R can be matched with the shape of the hand of the target person.

For example, as illustrated in B of FIG. 38, the hand 12011R can firmly hold the bar 1232 or a handle (for example, a door handle or a bucket handle).

For example, as illustrated in C of FIG. 38, in the hand 1201R, a tip of the exterior 1214R and a tip of the part 1215R can come into contact with each other, and a small object can be held (gripped in parallel) by the tip of the exterior 1214R and the tip of the part 1215R.

In this manner, the air pressure of each pneumatic bending actuator 1213R and a bending angle of each pneumatic bending actuator 1213R are adjusted in accordance with the shape of an object to be gripped, so that the shape of the hand 1201R can conform to the object. As a result, stability in gripping an object by the hand 1201R is improved.

In addition, a gripping force and rigidity of the hand 1201R can be enhanced by arranging the plurality of pneumatic bending actuators 1213R in the y-axis (pitch axis) direction and bending the plurality of pneumatic bending actuators 1213R in the pitch direction. Furthermore, the exterior 1214R prevents deformation of each pneumatic bending actuator 1213R in the roll direction, thereby further enhancing the gripping force and rigidity of the hand 12011R. Further, a gap between the respective pneumatic bending actuators 1213R is closed by the exterior 1214R, and the hand 1201R can be brought into surface contact with an object.

Furthermore, the plurality of pneumatic bending actuators 1213R shares one pneumatic source, whereby the hand 12011R can be downsized. Further, by simultaneously driving the plurality of pneumatic bending actuators 1213R with one pneumatic source, responsiveness for bending and spreading the hand 12011R in the pitch direction is improved.

In addition, the exterior 1214R improves waterproofness, flexibility, robustness, and hygiene of the hand 1201R. For example, each pneumatic bending actuator 1213R hardly interferes with an environment or an object. In addition, even in a case where the hand 1201R roughly comes into contact with an environment, a person, or an object, the hand and the environment, the person, or the object are prevented from being damaged. Furthermore, deterioration of members inside the hand 12011R can be suppressed.

Note that a range covered by the exterior 1214R can be expanded.

Moreover, by using the pneumatic bending actuator 1213R, cost reduction and weight reduction can be implemented, and beat generation during operation of the hand 1201R is prevented.

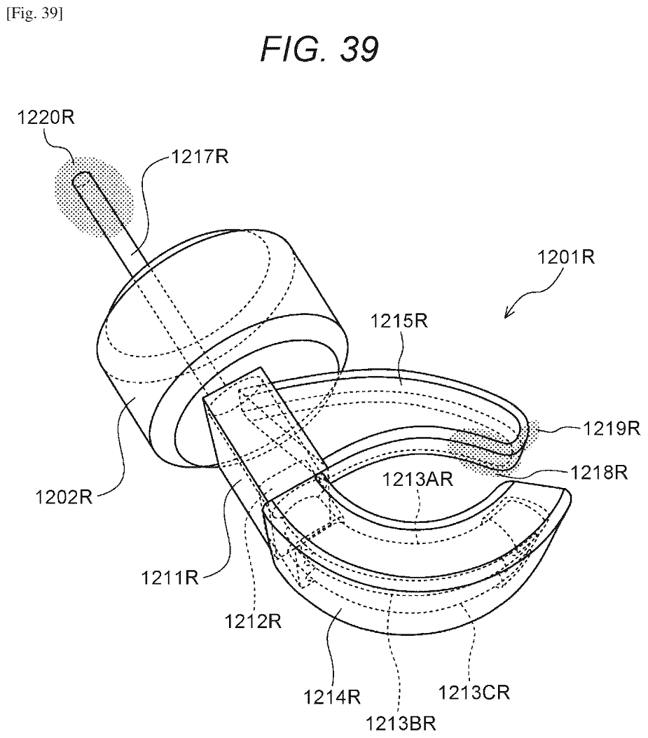

Note that, for example, as illustrated in FIG. 39, a distance sensor 1218R and a distance sensor 1219R may be provided at a tip of the thumb portion of the part 1215R. Furthermore, for example, the pneumatic source may be provided with a pneumatic sensor 1220R. Note that a tactile sensor may be provided instead of or together with the distance sensor 1218R and the distance sensor 1219R.

### Fourth Modification of Hand

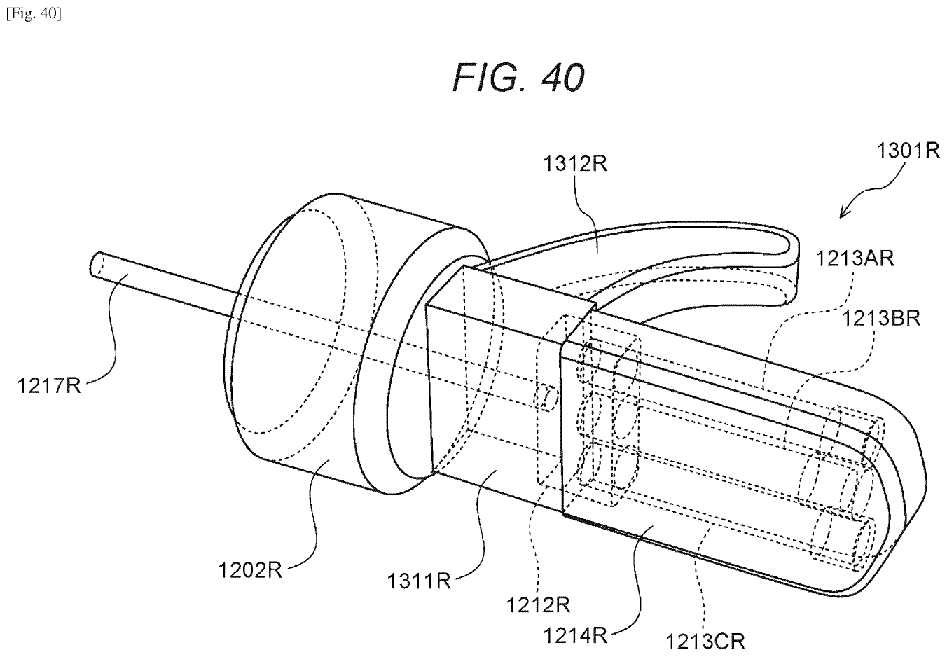

Next, a fourth modification of the hand of the nursing care robot 11 will be described with reference to FIG. 40.

FIG. 40 schematically illustrates a configuration example of an appearance of a hand 1301R corresponding to the right hand of the nursing care robot 11. Note that, in the drawing, a portion corresponding to the hand 1201R in FIGS. 37 and 38 is denoted by the same reference numeral, and a description thereof will be omitted as appropriate.

The hand 1301R is different from the hand 1201R in that a part 1311R and a part 1312R are provided instead of the part 1211R and the part 1215R, and the actuator 1216R is removed.

The parts 1311R and 1312R have substantially similar shapes to those of the parts 1211R and 1215R of the hand 1201R. However, the part 1312R is fixed to the part 1311R in such a way as not to move. That is, a thumb portion of the part 1312R is fixed in a direction perpendicular to the palm of the hand 1301R.

### Fifth Modification of Hand

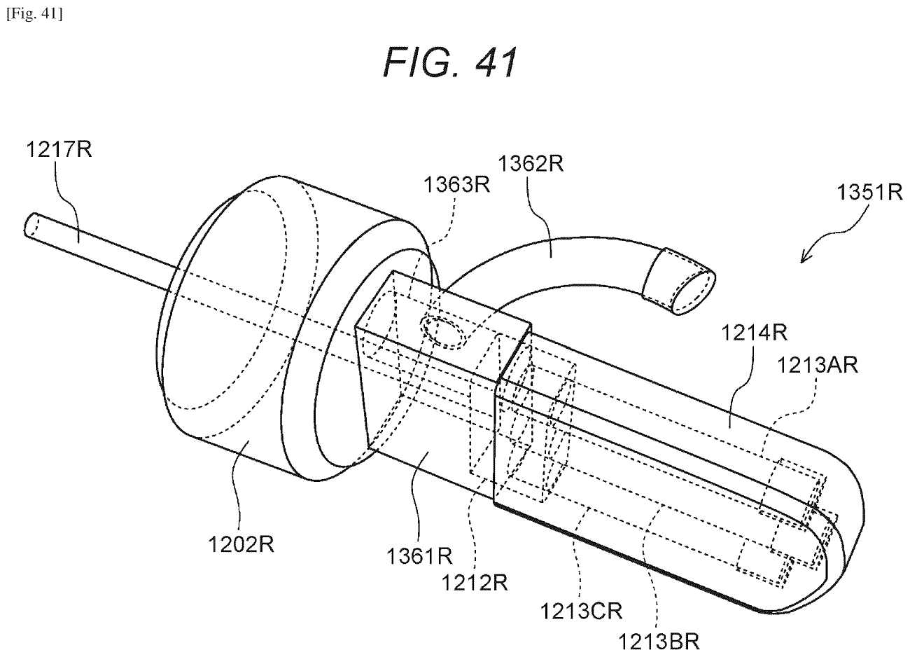

Next, a fifth modification of the hand of the nursing care robot 11 will be described with reference to FIG. 41.

FIG. 41 schematically illustrates a configuration example of an appearance of a hand 1351R corresponding to the right hand of the nursing care robot 11. Note that, in the drawing, a portion corresponding to the hand 1301R in FIG. 40 is denoted by the same reference numeral, and a description thereof will be omitted as appropriate.

The hand 1351R is different from the hand 1301R in that a part 1361 and a pneumatic bending actuator 1362R are provided instead of the part 1311R and the part 1312R, and an actuator 1363R is added.

The part 1361R has a substantially similar shape to that of the part 1311R of the hand 1301R.

The pneumatic bending actuator 1362R is a member corresponding to the thumb. The pneumatic bending actuator 1362R may be in either the roll direction or the pitch direction.

The actuator 1363R corresponds to the MP joint of the thumb, is arranged in the part 1361R, connects the part 1361R and the pneumatic bending actuator 1362R, and serves as the yaw axis extending in the z-axis direction. The actuator 1363R rotates the pneumatic bending actuator 1362R in the yaw direction with respect to the part 1361R to move the pneumatic bending actuator 1362R closer to the part 1361R or away from the part 1361R. As a result, a portion of the hand 1351R that corresponds to the MP joint of the thumb can be rotated in the yaw direction.

Note that a rotation shaft of the pneumatic bending actuator 1362R is not necessarily parallel to the z axis, and may be inclined in an oblique direction around the x axis (around the roll axis) with respect to the z axis. Specifically, for example, an orientation of the rotation shaft of the pneumatic bending actuator 1362R may be within a range of ±45 degrees around the x axis with respect to the z axis.

Note that the pneumatic bending actuator 1362R may be covered with an exterior. In this case, the exterior covering each pneumatic bending actuator 1213R and the pneumatic bending actuator 1362R may be common.

### Sixth Modification of Hand

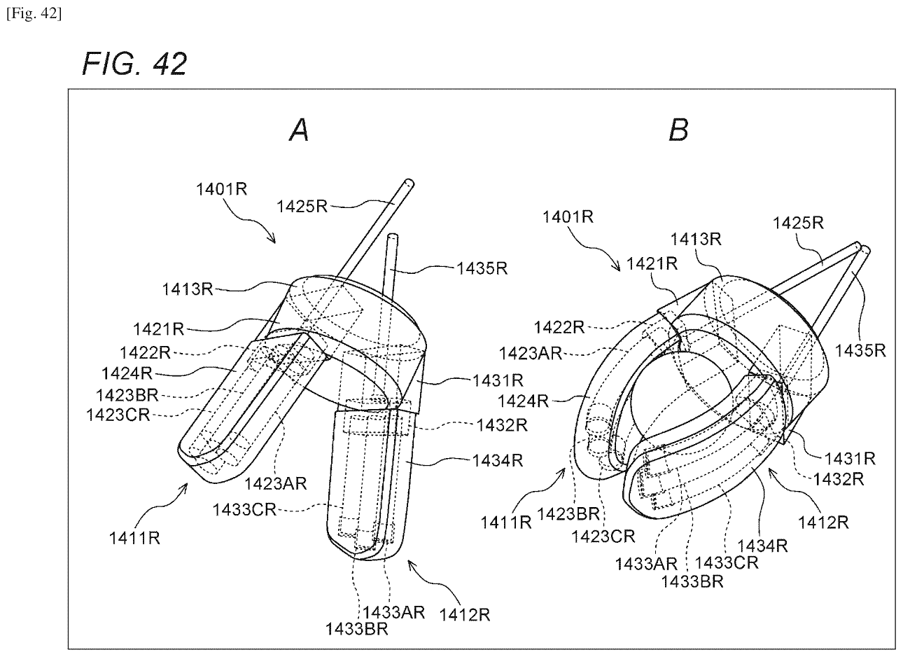

Next, a sixth modification of the hand of the nursing care robot 11 will be described with reference to FIG. 42.

FIG. 42 schematically illustrates a configuration example of an appearance of a hand 1401R corresponding to the right hand of the nursing care robot 11. A of FIG. 42 illustrates a state in which the hand 1401R is spread. B of FIG. 42 illustrates a state in which the hand 1401R holds a ball 1402.

The hand 1401R includes a gripper 1411R, a gripper 1412R, and a part 1413R. The gripper 1411R and the gripper 1412R have bases fixed by the cylindrical part 1413R, and face each other.

The gripper 1411R includes a part 1421R, a pneumatic branching unit 1422R, pneumatic bending actuators 1423AR to 1423CR, an exterior 1424R, and a tube 1425R.

The gripper 1412R includes a part 1431R, a pneumatic branching unit 1432R, pneumatic bending actuators 1433AR to 1433CR, an exterior 1434R, and a tube 1435R.

The gripper 1411R and the gripper 1412R have similar configurations to that of a portion including the part 1211R of the hand 1201R, the pneumatic branching unit 1212R, the pneumatic bending actuators 1213AR to 1213CR, the exterior 1214R, and the tube 1217R in FIGS. 37 and 38.

Note that the tube 1425R of the gripper 1411R and the tube 1435R of the gripper 1412R are connected to different pneumatic sources.

Hereinafter, in a case where it is not necessary to individually distinguish the pneumatic bending actuators 1423AR to 1423CR, they are simply referred to as the pneumatic bending actuator 1423R. Hereinafter, in a case where it is not necessary to individually distinguish the pneumatic bending actuators 1433AR to 1433CR, they are simply referred to as the pneumatic bending actuator 1433R.

The gripper 1411R and the gripper 1412R face each other and can be bent in a direction in which the gripper 1411R and the gripper 1412R face each other. That is, each pneumatic bending actuator 1423R and the exterior 1424R of the gripper 1411R can be bent and spread in the pitch direction, and can be bent in a direction toward the gripper 1412R. Each pneumatic bending actuator 1433R and the exterior 1434R of the gripper 1412R can be bent and spread in the pitch direction and can be bent in a direction toward the gripper 1411R.

As a result, for example, as illustrated in B of FIG. 42, the gripper 1411R and the gripper 1412R can grip the ball 1402 in such a way as to cover the ball 1402 from both sides.

Note that, for example, the tube 1425R and the tube 1435R may be connected to one pneumatic source, and the gripper 1411R and the gripper 1412R may be simultaneously bent and spread.

### Seventh Modification of Hand

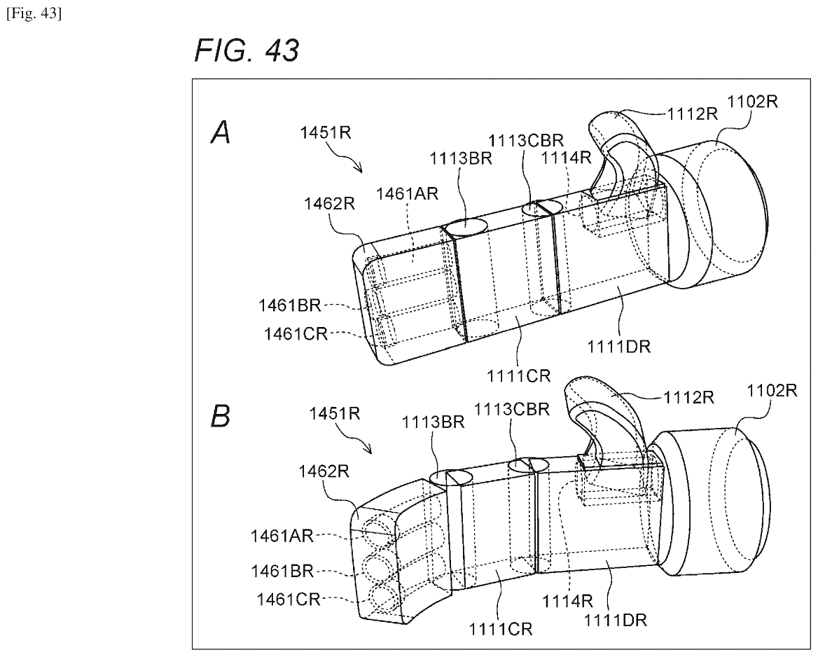

Next, a seventh modification of the hand of the nursing care robot 11 will be described with reference to FIG. 43.

FIG. 43 schematically illustrates a configuration example of an appearance of a hand 1451R corresponding to the right hand of the nursing care robot 11. A of FIG. 43 illustrates a state in which the hand 1451R is spread. B of FIG. 42 illustrates a state in which a tip of a main portion of the hand 1451R is bent. Note that, in the drawing, a portion corresponding to the hand 1101R in FIGS. 33 to 35 is denoted by the same reference numeral, and a description thereof will be omitted as appropriate.

The seventh modification is a combination of the first modification and the third modification.

Specifically, the hand 1451R is different in that pneumatic bending actuators 1461AR to 1461CR and an exterior 1462R are provided instead of the part 1111AR, the part 1111BR, and the actuator 1113AR.

Hereinafter, in a case where it is not necessary to individually distinguish the pneumatic bending actuators 1461AR to 1461CR, they are simply referred to as the pneumatic bending actuator 1461R.

One ends of the respective pneumatic bending actuators 1461R are connected to an actuator 1113BR, extend in the z-axis direction, and are arranged in the v-axis direction.

Each pneumatic bending actuator 1461R is covered with the exterior 1462R. A material similar to that of the exterior 1214R of FIG. 37 is used for the exterior 1462R.

Each pneumatic bending actuator 1461R is connected to a pneumatic branching unit, a tube, and a pneumatic source (not illustrated). Each pneumatic bending actuator 1461R and the exterior 1462R can be bent and spread in the pitch direction.

In addition, the actuator 1113BR rotates each pneumatic bending actuator 1461R and the exterior 1462R in the pitch direction with respect to a part 1111CR to move each pneumatic bending actuator 1461R and the exterior 1462R closer to the part 1111CR or away from the part 1111CR. As a result, a portion of the hand 1451R that corresponds to the PIP joints of the index finger to the little finger can be bent and spread in the pitch direction.

As a result, the degree of freedom of the shape of a portion corresponding to distal sections of the index finger to the little finger of the hand 1451R is improved.

### Other Modifications of Hand of Nursing Care Robot 11

For example, in the first modification, the number of pitch axes for bending and spreading the main portion of the hand 1101R can be four or more.

For example, in the third to fifth and seventh modifications, the number of pneumatic bending actuators of the main portion can be two or four or more.

For example, in the sixth modification, the number of pneumatic flexing actuators of each gripper can be two or four or more.

For example, in the third to seventh modifications, it is possible to use a bending actuator using a pressure (for example, a hydraulic pressure or a water pressure) other than the air pressure.

### Other Modifications

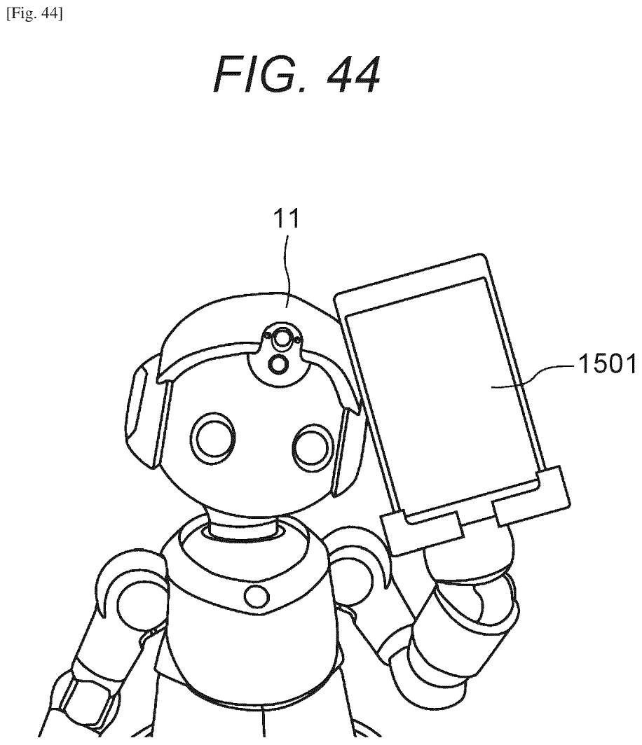

For example, as illustrated in FIG. 44, a hand display 1501 can be mounted on the hand of the nursing care robot 11. In this case, for example, a hand capable of forming a flat surface on the palm side as in the first to fourth and seventh modifications of the hand of the nursing care robot 11 described above can be used to grip the hand display 1501 in a natural posture.

The robot hand mechanism according to an embodiment of the present technology, that is, a mechanism of the hand of the nursing care robot 11 described above can be applied to various robots including a hand mechanism imitating a human hand. For example, the robot hand mechanism according to an embodiment of the present technology can be applied to a robot including only an arm such as a manipulator.

In the above description, an example has been described in which the nursing care robot 11 operates autonomously, but for example, the nursing care robot 11 may operate by remote control by an external information processing device such as a mobile information terminal or a cloud server. In this case, for example, all or some functions (for example, the action control unit 224) of the in-robot PC 205 are provided in an external device. In this case, for example, the provision method and the material of the content provided at the time of execution of the application are controlled by the external information processing device.

The shape, specification, and the like of the nursing care robot can be appropriately changed according to the content, purpose, and the like of care.

For example, the present technology can be applied to the following scenes in addition to the above-described nursing care facility for an elderly person.
Nursing care facilities for the handicapped, at-home care for the handicapped
Hospital facilities
Children's ward facilities
Infant care facilities and nursery schools
kindergartens and schools
Commercial facilities, lodging facilities, airports, and stations
Exhibition halls and event venues
Others

Furthermore, a recipient to which a content is provided by using the present technology is not limited to the nursing care target person.

That is, according to the present technology, it is possible to provide a robot that moves autonomously in various scenes, interacts with the user having various cognitive characteristics while appropriately providing the content, and has high acceptability for the user.

### 3. Background of Second Embodiment of Present Technology

Next, a background of a second embodiment of the present technology will be described.

In a nursing care facility such as a nursing home for the aged, there is a problem of labor shortage, and introduction of a robot for nursing care (hereinafter, referred to as a nursing care robot) that executes various types of care for a user of the nursing care facility is desired.

However, an autonomous robot capable of stably executing multiple tasks demanding hospitality in an unstructured environment in which a person and a robot coexist, such as a nursing care facility, has not yet been implemented.

For example, it is difficult for an autonomous robot according to the related art to appropriately cope with a dynamically changing environment or appropriately interact with each of users having different characteristics. Specifically, for example, traveling of the autonomous robot according to the related art is disabled only by the presence of an unknown obstacle (for example, a power cord or a cardboard box) on the course. For example, in the autonomous robot according to the related art, when the position of an object such as a table or a chair in a room changes, a target point is lost and navigation is disabled. For example, since an utterance of a user in a facility for the aged is unclear and has a small volume, the autonomous robot according to the related art has a low recognition rate for a voice of a user in a facility for the aged.

On the other hand, it is conceivable that a remote operator remotely operates the robot in real time to cause the robot to execute an action or interaction with hospitality.

However, since a remote operation type robot according to the related art occupies one remote operator, work efficiency of the remote operator is poor and the necessary cost increases. Therefore, higher workability and lower cost can be achieved in a case where one person works than in a case where the remote operation type robot works.

Depending on environmental conditions, one remote operator can operate a plurality of remote operation type robots, but there is a limit to the number of operable remote operation type robots, and the remote operator needs to be a highly skilled worker.

On the other hand, in the present technology, an action of the robot is subdivided into a plurality of micro-level tasks (hereinafter, referred to as microtasks), the robot autonomously executes a task within a possible range, and a task that is difficult for the robot to autonomously execute is executed by remote operation.

Note that, hereinafter, a task that the robot autonomously executes is referred to as an autonomous task, and a task that the robot does not autonomously execute is referred to as a non-autonomous task.

Here, the microtask is, for example, a task that is subdivided to a level irrelevant to a context (for example, the background or the surrounding environment) in which the robot executes an action, and is a task that does not need an advanced operation skill.

In addition, the robot includes a module specialized for (corresponding to one skill) (hereinafter, referred to as a task execution module) for each type of skill, and each task execution module independently executes a task related to each type of skill. As a result, the remote operator can cause the robot to execute a task related to a skill that the remote operator has by remotely operating the task execution module specialized for the skill.

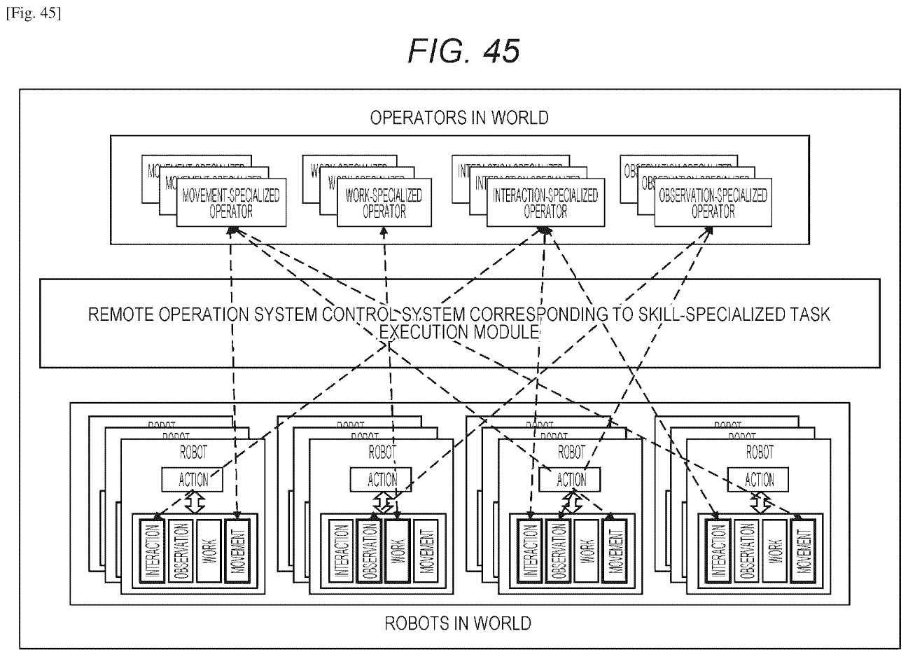

As a result, for example, as illustrated in FIG. 45, a remote operation control system corresponding to a skill-specialized task execution module is implemented.

In the example of FIG. 45, the robot includes five types of modules including an action module, an interaction module, an observation module, a work module, and a movement module. Among them, four types of the interaction module, the observation module, the work module, and the movement module are skill-specialized task execution modules (hereinafter, simply referred to as task execution modules).

The action module is a module that controls an action of the entire robot. For example, the action module creates a plan of an action of the entire robot, decomposes each action into tasks, and causes a corresponding task execution module to execute each task, thereby causing the robot to execute the planned action.

The interaction module is a module that executes interaction processing of the robot autonomously or by remote operation. For example, the interaction module interacts with a person and executes processing of communicating information, mutual understanding, and the like.

The observation module is a module that executes observation processing of the robot autonomously or by remote operation. For example, the observation module observes the surroundings of the robot, and executes processing of recognizing a surrounding state such as a surrounding object (including a living organism such as a person) or an environment.

The work module is a module that executes work processing of the robot autonomously or by remote operation. For example, the work module executes work using a portion such as the hand of the robot. Specifically, for example, the work module executes operation, movement, creation, processing, and the like of various objects, and a motion such as a gesture of the robot by using the portion of the robot.

The movement module is a module that executes movement processing of the robot autonomously or by remote operation. For example, the movement module executes processing of moving the robot by using a movement portion such as a leg or a wheel of the robot.

Then, for example, an interaction-specialized operator who performs a specialized remote operation for “interaction”, an observation-specialized operator who performs a specialized remote operation for “observation”, a work-specialized operator who performs a specialized remote operation for “work”, and a movement-specialized operator who performs a specialized remote operation for “movement” perform a remote operation of the robot by using the task execution module of the corresponding skill of each robot.

Note that, hereinafter, the interaction-specialized operator, the observation-specialized operator, the work-specialized operator, and the movement-specialized operator are also referred to as an interaction operator, an observation operator, a work operator, and a movement operator, respectively.

Note that an operator having a plurality of types of skills can also perform a remote operation for the plurality of skills.

In addition, although not illustrated, an action operator who can remotely operate the entire robot performs a remote operation for an action of the entire robot or a remote operation for a task that is relevant to the context or a task including a plurality of skills by using the action module, for example. For example, the action operator designs an action rule of autonomous action control of the robot, and performs a remote operation for the action of the entire robot by using the action module in a case where it is difficult for the action module to autonomously execute an action task of the entire robot.

The action operator is a top-level operator who can operate the action of the robot, and for example, needs to have a special authority. For example, an employee of a company that provides a robot service, an employee of a commercial facility that introduces and operates a robot, and the like are the action operators. For example, in a case of the nursing care robot, for example, a staff of a nursing care facility that introduces and operates the nursing care robot, an employee of a visiting nursing care service provider that introduces and operates the nursing care robot, a family member of a user who receives at-home care by the nursing care robot, and the like are the action operators.

Note that the action operator can also perform a remote operation for a specific skill of the robot by using the task execution module as the interaction operator, the observation operator, the work operator, or the movement operator.

As described above, an architecture is implemented in which operators in the world can perform a remote operation specialized for skills possessed by the operators on robots in the world.

For example, each operator can remotely operate only some tasks of each robot. For example, each operator can remotely operate a plurality of robots in parallel according to the skills possessed by the operator. For example, a plurality of operators can remotely operate one robot in cooperation. For example, each robot can receive the support of the operator only for a task that is difficult for the robot to autonomously execute.

As a result, it is possible to cause the robots in the world to efficiently execute an action by effectively utilizing the skills and time of the operators in the world. In addition, the hospitality of each robot is improved. That is, each robot can stably execute multiple tasks demanding hospitality.

### 4. Second Embodiment of Present Technology

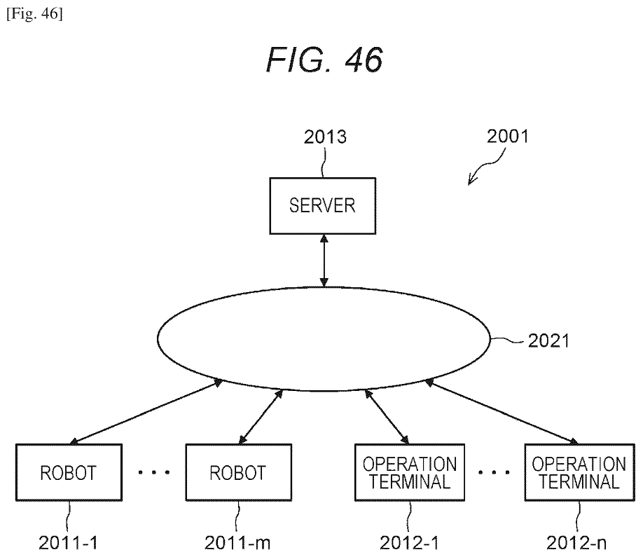

Next, a second embodiment of the present technology will be described with reference to FIGS. 46 to 58.

### Configuration Example of Remote Operation Control System 2001

FIG. 46 illustrates a configuration example of a remote operation control system 2001 to which the present technology is applied.

The remote operation control system 2001 is a system that controls a remote operation of robots 2011-1 to 2011-m.

The remote operation control system 2001 includes the robots 2011-1 to 2011-m, operation terminals 2012-1 to 2012-n, and a server 2013. The robots 2011-1 to 2011-m, the operation terminals 2012-1 to 2012-n, and the server 2013 are connected to each other via a network 2021 and can communicate with each other.

Hereinafter, in a case where it is not necessary to individually distinguish the robots 2011-1 to 2011-m, they are simply referred to as the robot 2011. Hereinafter, in a case where it is not necessary to individually distinguish the operation terminals 2012-1 to 2012-n, they are simply referred to as the operation terminal 2012.

Each robot 2011 corresponds to the robot described above with reference to FIG. 45. The robot 2011 is capable of autonomously executing an action and executes a task that is difficult to execute autonomously according to a remote operation using the operation terminal 2012.

Note that the form of the robot 2011 is not particularly limited. For example, the robot 2011 may be an autonomously movable robot, a manipulator that executes work by moving a portion such as the hand at a fixed place, or the like. For example, the robot may be a human type robot or another living organism type robot, or may be a robot that executes specific work. For example, the robot 2011 may present a character or the like by three-dimensional computer graphics (CG) or the like on a display including a sensor or a speaker.

The operation terminal 2012 is a terminal (information processing device) used by each remote operator to perform a remote operation of each robot 2011. The form of the operation terminal 2012 is not particularly limited. For example, a smartphone, a personal computer (PC), a tablet terminal, a game terminal, a dedicated operation terminal, or the like is used as the operation terminal 2012. For example, the operation terminal 2012 may be not only a terminal operated with the hand but also an operation terminal operated with a portion other than the hand or a terminal operated in a non-contact manner using speech recognition, line-of-sight recognition, or the like.

The server 2013 controls the remote operation of each robot by each remote operator. For example, the server 2013 performs matching between a non-autonomous task of each robot 2011 and each remote operator. For example, the server 2013 enables cooperation between the matching robot 2011 and the operation terminal 2012 of the remote operator via the network 2021, and executes processing necessary for the remote operation, data mediation, and the like between the robot 2011 and the operation terminal 2012.

### Configuration Example of Robot 2011

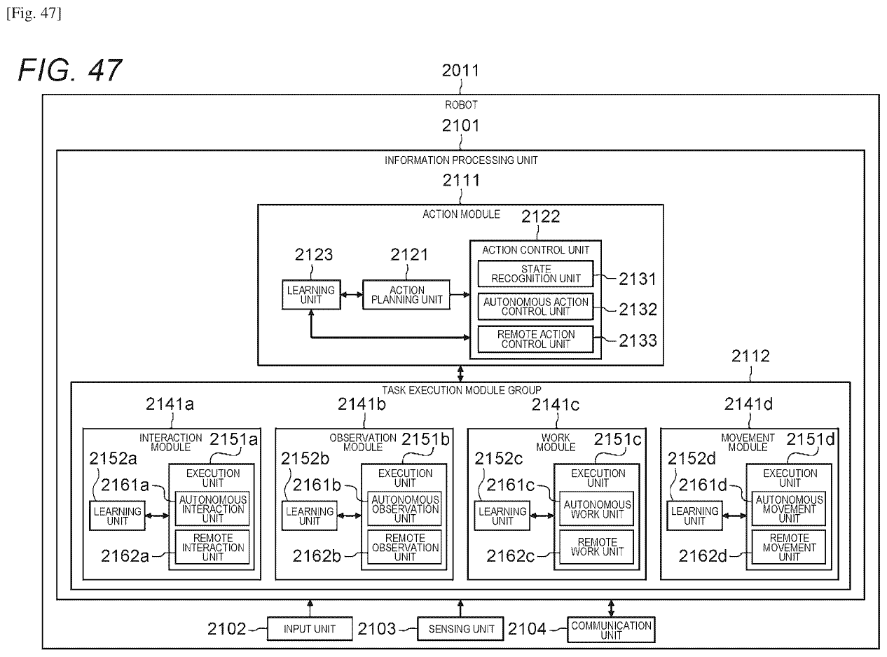

FIG. 47 illustrates a functional configuration example of the robot 2011.

The robot 2011 includes an information processing unit 2101, an input unit 2102, a sensing unit 2103, and a communication unit 2104.

The information processing unit 2101 includes an action module 2111 and a task execution module group 2112.

The action module 2111 is a module that controls an action of the entire robot 2011. The action module 2111 includes an action planning unit 2121, an action control unit 2122, and a learning unit 2123.

The action planning unit 2121 creates a plan of an action of the entire robot 2011 on the basis of a preset schedule, a command from the outside, a state around the robot 2011 recognized by a state recognition unit 2131 of the action module 2111, and the like. In addition, the action planning unit 2121 subdivides an action of the robot 2011 into micro-level tasks (microtasks).

Each task is classified into a task related to interaction processing in the robot 2011 (hereinafter, referred to as an interaction task), a task related to observation processing in the robot 2011 (hereinafter, referred to as an observation task), a task related to work processing in the robot 2011 (hereinafter, referred to as a work task), and a task related to movement processing in the robot 2011 (hereinafter, referred to as a movement task).

The interaction task is, for example, a task related to processing in which the robot 2011 interacts with a person and performs information communication, mutual understanding, and the like.

The observation task is, for example, a task related to processing of observing the surroundings of the robot 2011 and recognizing a surrounding state such as a surrounding object (including a living organism such as a person) or an environment.

The work task is, for example, a task related to processing of executing operation, movement, creation, processing, and the like of various objects and a motion such as a gesture of the robot 2011 by using each portion of the robot 2011.

The movement task is, for example, a task related to processing of moving the robot 2011 by using a movement portion such as a leg or a wheel of the robot 2011.

The action control unit 2122 controls an action of the entire robot 2011. The action control unit 2122 includes the state recognition unit 2131, an autonomous action control unit 2132, and a remote action control unit 2133.

The state recognition unit 2131 recognizes a state around the robot 2011 or the like on the basis of input data from the input unit 2102, sensing data output from the sensing unit 2103, an observation result of an observation module 2141b, and the like. For example, the state recognition unit 2131 recognizes an inner state such as an emotion or intention of a person around the robot 2011.

The autonomous action control unit 2132 controls autonomous execution of an action of the robot 2011. For example, the autonomous action control unit 2132 controls execution of an autonomous task of the robot 2011 by controlling the task execution module group 2112.

The remote action control unit 2133 controls execution of an action by the remote operation of the robot 2011. For example, the remote action control unit 2133 controls the task execution module group 2112 to control execution of a non-autonomous task by the remote operation of the robot 2011. In addition, the remote action control unit 2133 controls an action of the entire robot 2011 by the remote operation by the action operator described above on the basis of remote operation content information indicating a content of the remote operation transmitted from the server 2013.

The learning unit 2123 learns a method of autonomously executing an action on the basis of an execution content (for example, an operation content or an execution result) of the action of the robot 2011 by remote operation. Furthermore, the learning unit 2123 learns a method of autonomously executing an action according to an intention of the user on the basis of, for example, the intention, reaction, or the like of the user recognized by the state recognition unit 2131.

Note that, for example, the action module 2111 (the autonomous action control unit 2132) grows by learning based on the intention, reaction, or the like of the user, so that the user can finally become the action operator by himself/herself. As a result, for example, a user who is difficult to lead an autonomous life, such as the handicapped or a dementia patient, can become the action operator, coexist with the robot 2011, and lead an autonomous life.

An interaction module 2141a is a module that executes the interaction task autonomously or by remote operation. The interaction module 2141a includes an execution unit 2151a and a learning unit 2152a. The execution unit 2151a includes an autonomous interaction unit 2161a and a remote interaction unit 2162a.

The autonomous interaction unit 2161a autonomously executes the interaction task.

The remote interaction unit 2162a executes the interaction task by remote operation on the basis of the remote operation content information indicating the content of the remote operation transmitted from the server 2013.

The learning unit 2152a learns a method of autonomously executing the interaction task on the basis of an execution content (for example, an operation content or an execution result) of the interaction task by remote operation.

The observation module 2141b is a module that executes the observation task autonomously or by remote operation. The observation module 2141b includes an execution unit 2151b and a learning unit 2152b. The execution unit 2151b includes an autonomous observation unit 2161b and a remote observation unit 2162b.

The autonomous observation unit 2161b autonomously executes the observation task.

The remote observation unit 2162b executes the observation task by remote operation on the basis of the remote operation content information transmitted from the server 2013.

The learning unit 2152b learns a method of autonomously executing the observation task on the basis of an execution content (for example, an operation content or an execution result) of the observation task by remote operation.

The work module 2141c is a module that executes the work task autonomously or by remote operation. The work module 2141c includes an execution unit 2151c and a learning unit 2152c. The execution unit 2151c includes an autonomous work unit 2161c and a remote work unit 2162c.

The autonomous work unit 2161c autonomously executes the work task.

The remote work unit 2162c executes the work task by remote operation on the basis of the remote operation content information transmitted from the server 2013.

The learning unit 2152c learns a method of autonomously executing the work task on the basis of an execution content (for example, an operation content or an execution result) of the work task by remote operation.

The movement module 2141d is a module that executes the movement task autonomously or by remote operation. The movement module 2141d includes an execution unit 2151d and a learning unit 2152d. The execution unit 2151d includes an autonomous movement unit 2161d and a remote movement unit 2162d.

The autonomous movement unit 2161d autonomously executes the movement task.

The remote movement unit 2162d executes the movement task by remote operation on the basis of the remote operation content information transmitted from the server 2013.

The learning unit 2152d learns a method of autonomously executing the movement task on the basis of an execution content (for example, an operation content or an execution result) of the movement task by remote operation.

The input unit 2102 includes an input device used for inputting various types of input data such as a command and data. The input unit 2102 supplies the input data to the information processing unit 2101.

The sensing unit 2103 includes, for example, various sensors that sense the surroundings of the robot 2011 such as a camera, a light detection and ranging (LiDAR), a radar, and a microphone, and various sensors that sense the state of the robot 2011. The sensing unit 2103 supplies sensor data output from each sensor to the information processing unit 2101.

The communication unit 2104 communicates with the operation terminal 2012 and the server 2013 via the network 202L. The communication unit 2104 supplies received data to the information processing unit 2101, and acquires data to be transmitted from the information processing unit 2101.

Hereinafter, in a case where it is not necessary to individually distinguish the interaction module 2141a to the movement modules 2141d, they are referred to as the task execution module 2141. Hereinafter, in a case where it is not necessary to individually distinguish the execution unit 2151a of the interaction module 2141a to the execution unit 2151d of the movement module 2141d, they are simply referred to as the execution unit 2151. Hereinafter, in a case where it is not necessary to individually distinguish the learning unit 2152a of the interaction module 2141a to the learning unit 2152d of the movement module 2141d, they are simply referred to as the learning unit 2152. Hereinafter, in a case where it is not necessary to individually distinguish the autonomous interaction unit 2161a, the autonomous observation unit 2161b, the autonomous work unit 2161c, and the autonomous movement unit 2161d, they are referred to as the autonomous task execution unit 2161L Hereinafter, in a case where it is not necessary to individually distinguish the remote interaction unit 2162a, the remote observation unit 2162b, the remote work unit 2162c, and the remote movement unit 2162d, they are referred to as the remote task execution unit 2162.

Note that each task execution module 2141 includes necessary hardware and software, and can independently execute a task. Furthermore, the hardware and software included in each task execution module 2141 can be shared with other task execution modules 2141.

### Configuration Example of Appearance of Robot 2011

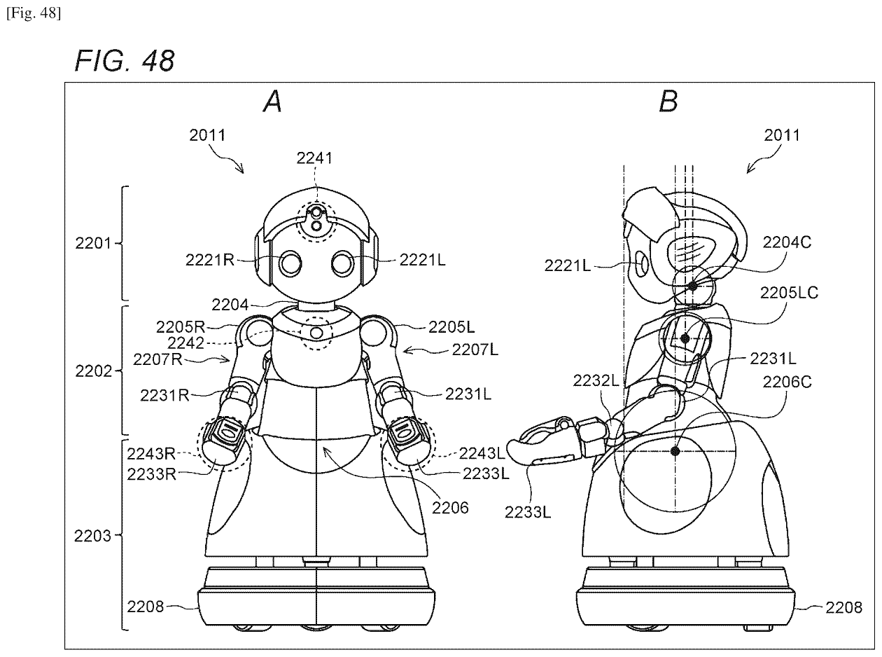

FIG. 48 illustrates a configuration example of an appearance of the robot 2011. A of FIG. 48 is a front view of the robot 2011. B of FIG. 48 is a left side view of the robot 2011.

The robot 2011 is a humanoid mobile manipulator robot capable of executing various applications for various types of care, state observation, communication, peripheral tasks, and the like with highly acceptable quality to the nursing care target person.

The robot 2011 includes a head portion 2201, a chest portion 2202, and a base portion 2203 that supports the chest portion 2202. The base portion 2203 includes, for example, a carriage 2208 that is movable in all directions and is provided at a lower portion of the base portion 2203. As a result, the robot 2011 can move in all directions.

The robot 2011 includes an arm portion 22071L attached to an upper-left portion of the chest portion 2202, and an arm portion 2207R attached to an upper-right portion of the chest portion 2202. The robot 2011 includes a movable neck 2204 provided between the head portion 2201 and the chest portion 2202 and including a neck joint shaft 2204C. The robot 2011 includes a movable shoulder 2205L provided between the chest portion 2202 and the arm portion 2071L and including a shoulder joint shaft 2205LC, and a movable shoulder 2205R provided between the chest portion 2202 and the arm portion 2207R and including a shoulder joint shaft 2205RC. In addition, the robot 2011 includes a movable waist 2206 provided under the chest portion 2202 and including a waist joint shaft 2206C.

The head portion 2201 includes an eyeball portion 2221L and an eyeball portion 2221R. For example, the robot 2011 controls the position of a black portion of the eyeball portion 2221L, the position of a black portion of the eyeball portion 2221R, and the axis of the neck 2204 (roll, pitch, and yaw) to gaze at the target person.

Note that, hereinafter, in a case where it is not necessary to individually distinguish the eyeball portion 2221L and the eyeball portion 2221R, they are simply referred to as the eyeball portion 2221.

The arm portion 2207L includes an elbow portion 2231L, a wrist 2232L, and a hand 2233L. The elbow portion 2231L has a pitch axis. The wrist 2232L has a yaw axis.

The arm portion 2207R is configured similarly to the arm portion 2207L, and includes an elbow portion 2231R, a wrist 2232R, and a hand 2233R.

In addition, hereinafter, in a case where it is not necessary to individually distinguish the arm portion 2207L and the arm portion 2207R, they are simply referred to as the arm portion 2207. Hereinafter, in a case where it is not necessary to individually distinguish the elbow portion 2231L and the elbow portion 2231R, they are simply referred to as the elbow portion 2231. Hereinafter, in a case where it is not necessary to individually distinguish the wrist 2232L and the wrist 2232R, they are simply referred to as the wrist 2232. Hereinafter, in a case where it is not necessary to individually distinguish the hand 2233L and the hand 2233R, they are simply referred to as the hand 2233.

A head sensor 2241 is provided at an upper front portion of the head portion 2201. The head sensor 2241 includes, for example, a distance image sensor, a microphone, a LiDAR, or the like. The head sensor 2241 is configured in such a way that a sensing direction is substantially the same as a line-of-sight direction of the robot 2011. For example, the robot 2011 can perform human recognition and face recognition by the head sensor 2241.

A chest sensor 2242 is provided at an upper front portion of the chest portion 2202. The chest sensor 2242 includes, for example, a non-contact type vital sensor. Examples of the non-contact type vital sensor include a body temperature sensor, a heart rate sensor, and a respiration sensor.

A hand sensor 2243L is provided in the hand 2233L. The hand sensor 2243L includes, for example, a contact type vital sensor or the like. Examples of the contact type vital sensor include a heart rate sensor, a blood pressure sensor, and an oxygen saturation measurement sensor.

In addition, vital sensing can be performed in a manner in which the target person places his/her hand on or holds the hand sensor 2243L, instead of a manner in which the robot 2011 touches the target person with the hand sensor 22431L by itself. This is an interface familiar to a dementia patient, and acceptability for the target person is high.

A hand sensor 2243R similar to the hand sensor 22431L is also provided in the hand 2233R.

Note that, hereinafter, in a case where it is not necessary to individually distinguish the hand sensor 2243L and the hand sensor 2243R, they are simply referred to as the hand sensor 2243.

### Configuration Example of Server 2013

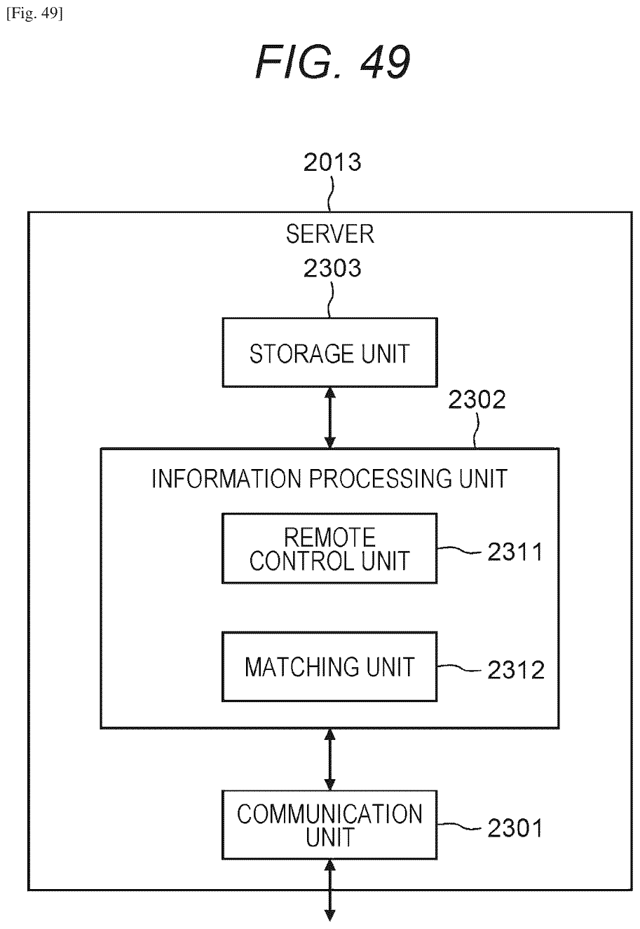

FIG. 49 illustrates a functional configuration example of the server 2013.

The server 2013 includes a communication unit 2301, an information processing unit 2302, and a storage unit 2303. The information processing unit 2302 includes a remote control unit 2311 and a matching unit 2312.

The communication unit 2301 communicates with each robot 2011 and each operation terminal 2012 via the network 2021. The communication unit 2301 supplies received data to the information processing unit 2302, and acquires data to be transmitted from the information processing unit 2302.

The remote control unit 2311 controls the remote operation of the robot 2011 using the operation terminal 2012 by each remote operator.

For example, the remote control unit 2311 receives, from the robot 2011 via the network 2021 and the communication unit 2301, task request information including information regarding a task for which remote operation is requested. The remote control unit 2311 transmits the task request information to the operation terminal 2012 of the remote operator selected by the matching unit 2312 via the communication unit 2301 and the network 2021.

For example, the remote control unit 2311 receives remote operation provision information including information necessary for remote operation from the robot 2011 via the network 2021 and the communication unit 2301. For example, the remote control unit 2311 generates remote operation UT information for providing a user interface for remote operation (hereinafter, referred to as a remote operation UI) on the basis of the remote operation provision information. The remote control unit 2311 transmits the remote operation UI information to the operation terminal 2012 of the remote operator in charge of the remote operation via the communication unit 2301 and the network 2021.

For example, the remote control unit 2311 receives the remote operation content information from the operation terminal 2012 via the network 2021 and the communication unit 2301, and converts the remote operation content information for the robot 2011 that is a remote operation target as necessary. The remote control unit 2311 transmits the remote operation content information to the robot 2011 that is the remote operation target via the communication unit 23011 and the network 2021.

For example, the remote control unit 2311 receives a task execution result notification signal for notifying of a result of execution of a task by remote operation from the robot 2011 via the network 2021 and the communication unit 2301, and transmits the task execution result notification signal to the operation terminal 2012 of the remote operator in charge of the remote operation. The task execution result notification signal is divided into, for example, a task completion notification signal for notifying of completion of the task and a task failure notification signal for notifying of failure of the task.

The matching unit 2312 executes matching processing between non-autonomous tasks of a plurality of robots 2011 and a plurality of remote operators. For example, the matching unit 2312 selects a remote operator to be requested to perform the remote operation for a task on the basis of the task request information received from the robot 2011 and a remote operator database and a task database stored in the storage unit 2303. The matching unit 2312 updates the remote operator database and the task database stored in the storage unit 2303 as necessary on the basis of a remote operation result notification signal.

The storage unit 2303 stores various types of data necessary for processing in the server 2013. For example, the storage unit 2303 stores the remote operator database and the task database.

The remote operator database includes, for example, data regarding an attribute, a characteristic, a schedule, an environment, and a remote operation history of each remote operator.

The attribute of the remote operator includes the name, age, sex, nationality, occupation, and the like of the remote operator.

The characteristic of the remote operator includes, for example, a skill, a skill level, a language, and the like of the remote operator.

The schedule of the remote operator includes, for example, information regarding a schedule on which the remote operator can perform the remote operation of the robot 2011.

The environment of the remote operator includes, for example, information regarding an environment in which the remote operator performs the remote operation. For example, the environment of the remote operator includes the form and performance of the operation terminal 2012 used by the remote operator, the position coordinates on the earth, a time, and the like.

The remote operation history includes, for example, a date and time when the remote operation of the robot was performed in the past, a content of the task, an execution result, and the like.

The task database includes, for example, data regarding a content of each task, a difficulty level, an environment necessary for remote operation, and the like.

### <Processing in Remote Operation Control System 2001>

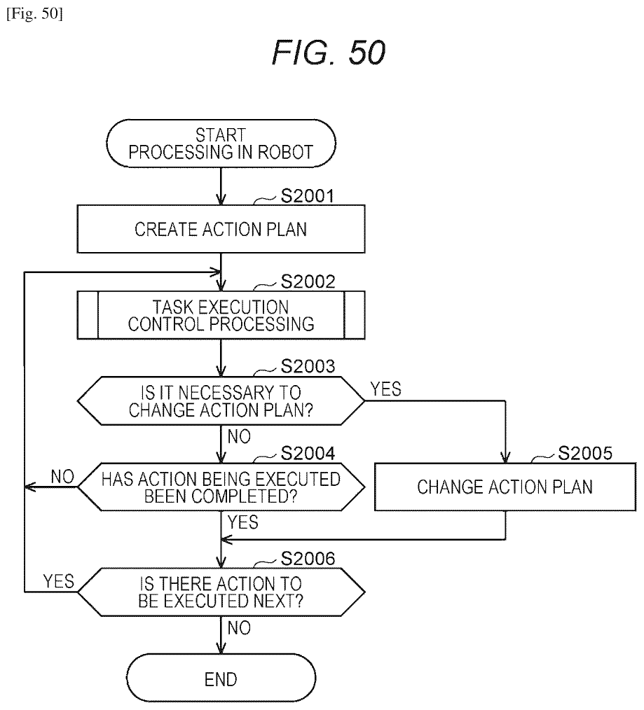

Next, processing in the remote operation control system 2001 will be described with reference to FIGS. 50 to 52.

### <Processing in Robot 2011>

Processing in the robot 2011 will be described with reference to the flowchart of FIG. 50.

This processing is started, for example, in a case where a trigger for the robot 2011 to start a certain action is generated. For example, in a case where it is time to start a predetermined action in a preset schedule, or in a case where a command to execute a certain action is given from the outside, the robot 2011 starts this processing.

In step S2001, the action planning unit 2121 creates an action plan. For example, the action planning unit 2121 creates a series of action plans necessary for achieving a given purpose.

Note that a method of creating the action plan is not particularly limited. For example, the action planning unit 2121 may autonomously create an action plan, create an action plan on the basis of information given from the outside, or create an action plan on the basis of an interaction with the user.

Furthermore, for example, the action planning unit 2121 may apply an action plan given from the outside, or may select an action plan from among a plurality of action plans in a case where the plurality of action plans is given. As the action plan given from the outside, for example, an action plan designed in advance by a business operator of the remote operation control system 2001, an action plan created by the user of the robot 2011, an action plan created by the action operator, or the like is assumed.

The action planning unit 2121 decomposes each action into a plurality of tasks. At this time, each action is decomposed into a plurality of tasks until each task becomes a micro-level irrelevant to a context in which the action is executed as much as possible.

In step S2002, the robot 2011 executes task execution control processing.

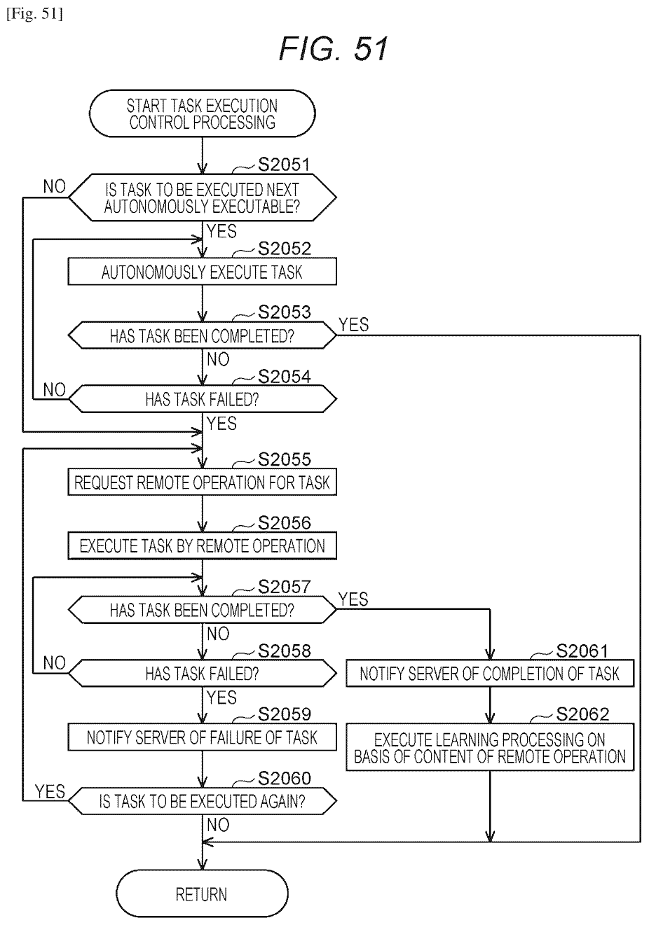

Here, details of the task execution control processing will be described with reference to the flowchart of FIG. 51.

In step S2051, the autonomous action control unit 2132 determines whether or not a task to be executed next is autonomously executable. In a case where it is determined that the task to be executed next is autonomously executable, the processing proceeds to step S2052.

In step S2052, the robot 2011 autonomously executes the task.

For example, in a case where the task to be executed next is the interaction task, the autonomous action control unit 2132 instructs the interaction module 2141a to autonomously execute the task. In this case, the autonomous interaction unit 2161a of the interaction module 2141a autonomously executes the instructed task.

For example, in a case where the task to be executed next is the observation task, the autonomous action control unit 2132 instructs the observation module 2141b to autonomously execute the task. In this case, the autonomous observation unit 2161b of the observation module 2141b autonomously executes the instructed task.

For example, in a case where the task to be executed next is the work task, the autonomous action control unit 2132 instructs the work module 2141c to autonomously execute the task. In this case, the autonomous work unit 2161c of the work module 2141c autonomously executes the instructed task.

For example, in a case where the task to be executed next is the movement task, the autonomous action control unit 2132 instructs the movement module 2141d to autonomously execute the task. In this case, the autonomous movement unit 2161d of the movement module 2141d autonomously executes the instructed task.

In step S2053, the autonomous action control unit 2132 determines whether or not the task has been completed on the basis of information from the task execution module 2141 that has instructed the execution of the task. In a case where it is determined that the task has not been completed, the processing proceeds to step S2054.

In step S2054, the autonomous action control unit 2132 determines whether or not the task has failed on the basis of the information from the task execution module 2141 that has instructed the execution of the task. In a case where it is determined that the task has not failed, the processing returns to step S2052.

Thereafter, the pieces of processing of steps S2052 to S2054 are repeatedly executed until it is determined in step S2053 that the task has been completed or it is determined in step S2054 that the task has failed.

On the other hand, in a case where it is determined in step S2054 that the task has failed, the processing proceeds to step S2055.

Here, an example in which it is determined that the task has failed will be described.

For example, in a case where a target time of the task is set, when the task is not completed within the target time, it is determined that the task has failed.

Note that, in a case of a new task, it is difficult to set the target time, and thus, the target time is set to be longer. On the other hand, in a case of a task for which a similar task has been executed in the past, the target time is set on the basis of an actual value of a time taken for the similar task in the past.

For example, in a case of executing a task for recognizing the target person, the surrounding state, and the like, when a certainty factor (recognition accuracy) is low, it is determined that the task has failed.

Note that an allowable range (threshold) of the certainty factor is set, for example, on the basis of the degree to which erroneous recognition is allowable. For example, in a case of a task for which erroneous recognition in face authentication or the like is not allowed, the threshold is set to a high value (for example, 99% or more). On the other hand, in a case of a task for which erroneous recognition in conversation content recognition is allowed to some extent, the threshold is set to a somewhat low value (for example, 70% or more).

Note that the threshold of the certainty factor is learned and optimized every time a similar task is executed.

For example, in a case where the robot 2011 has an unexpected collision or contact with the surrounding environment during the execution of the movement task, it is determined that the task has failed. The unexpected collision or contact with the surrounding environment is detected by, for example, a detection value of a sensor such as a tactile sensor or a force sensor, a current value of an actuator, contact sound recognition, an input value of a switch, or the like.

For example, in a case of executing the work task, when a work error occurs, it is determined that the task has failed. For example, in a case where an abnormality of a work target object occurs, it is determined that the task has failed. The abnormality of the target object is, for example, falling, collapse, or collision of the target object. The abnormality of the target object is detected by, for example, image recognition, contact sound recognition, a detection value of a sensor such as a tactile sensor or a force sensor, or the like.

On the other hand, in a case where it is determined in step S2051 that the task to be executed next is not autonomously executable, the pieces of processing of steps S2052 to S2054 are skipped, and the processing proceeds to step S2055.

In step S2055, the remote action control unit 2133 requests the remote operation for the task. Specifically, the remote action control unit 2133 generates the task request information including information regarding the task for which the remote operation is requested, and transmits the task request information to the server 2013 via the communication unit 2104 and the network 2021.

Then, the server 2013 performs matching between the requested task and the remote operator as described later.

In step S2056, the robot 2011 executes the task by remote operation.

For example, in a case where the task that is a remote operation target is the interactive task, the remote action control unit 2113 instructs the interaction module 2141a to execute the task by remote operation. In this case, the remote interaction unit 2162a of the interaction module 2141a executes the instructed task according to the remote operation.

For example, in a case where the task that is the remote operation target is the observation task, the remote action control unit 2113 instructs the observation module 2141b to execute the task by remote operation. In this case, the remote observation unit 2162b of the observation module 2141b executes the instructed task according to the remote operation.

For example, in a case where the task that is the remote operation target is the work task, the remote action control unit 2113 instructs the work module 2141c to execute the task by remote operation. In this case, the remote work unit 2162c of the work module 2141c executes the instructed task according to the remote operation.

For example, in a case where the task that is the remote operation target is the movement task, the remote action control unit 2113 instructs the movement module 2141d to execute the task by remote operation. In this case, the remote movement unit 2162d of the movement module 2141d executes the instructed task according to the remote operation.

At this time, the remote task execution unit 2162 that executes the task by remote operation (hereinafter, referred to as a target remote task execution unit 2162) transmits information necessary for the remote operation (remote operation provision information) to the server 2013 via the communication unit 2104 and the network 2021 as appropriate. In addition, the target remote task execution unit 2162 receives the remote operation content information indicating the content of the remote operation from the server 2013 via the network 2021 and the communication unit 2104. The target remote task execution unit 2162 executes the task on the basis of the remote operation content information.

In step S2057, it is determined whether or not the task has been completed, similarly to the processing of step S2053. In a case where it is determined that the task has not been completed, the processing proceeds to step S2058.

In step S2058, similarly to the processing of step S2054, it is determined whether or not the task has failed. In a case where it is determined that the task has not failed, the processing returns to step S2056.

Thereafter, the pieces of processing of steps S2056 to S2058 are repeatedly executed until it is determined in step S2057 that the task has been completed or it is determined in step S2058 that the task has failed.

On the other hand, in a case where it is determined in step S2058 that the task has failed, the processing proceeds to step S2059.

In step S2059, the robot 2011 notifies the server 2013 of the failure of the task. Specifically, the remote action control unit 2133 generates the task failure notification signal for notifying of the failure of the task, and transmits the task failure notification signal to the server 2013 via the communication unit 2104 and the network 2021.

In step S2060, the remote action control unit 2133 determines whether or not to execute the task again. In a case where it is determined to execute the task again, the processing returns to step S2055.

Thereafter, the pieces of processing of steps S2055 to S2060 are repeatedly executed until it is determined in step S2057 that the task has been completed or it is determined in step S2060 not to execute the task again. That is, the execution processing by the remote operation for the failed task is repeatedly executed.

On the other hand, in a case where it is determined in step S2060 not to execute the task again, the task execution control processing ends. For example, a case where the task fails a predetermined number of times or more or the task is not completed within a predetermined time is assumed.

On the other hand, in a case where it is determined in step S2057 that the task has been completed, the processing proceeds to step S2061.

In step S2061, the robot 2011 notifies the server 2013 of the completion of the task. Specifically, the remote action control unit 2133 generates a task success notification signal for notifying of the completion of the task, and transmits the task success notification signal to the server 2013 via the communication unit 2104 and the network 2021.

In step S2062, the robot 2011 executes learning processing on the basis of the content of the remote operation. For example, the learning unit 2152 of the task execution module 2141 that has executed the task by remote operation learns a method of autonomously executing the task on the basis of the content of the remote operation.

As a result, in the future, it is expected that the non-autonomous task gradually shifts to the autonomous task and is autonomously executed by the robot 2011.

Thereafter, the task execution control processing ends.

Returning to FIG. 50, in step S2003, the action planning unit 2121 determines whether or not it is necessary to change the action plan. In a case where it is determined that it is not necessary to change the action plan, the processing proceeds to step S2004.

In step S2004, the action planning unit 2121 determines whether or not the action being executed has been completed on the basis of the result of the processing of step S2002. In a case where it is determined that the action being executed has not been completed, the processing returns to step S2002.

Thereafter, the pieces of processing of steps S2002 to S2004 are repeatedly executed until it is determined in step S2002 that it is necessary to change the action plan or it is determined in step S2004 that the action being executed has been completed.

On the other hand, in a case where it is determined in step S2004 that the action being executed has been completed, the processing proceeds to step S2006.

On the other hand, in a case where it is determined in step S2003 that it is necessary to change the action plan, the processing proceeds to step S2005. For example, a case where it is difficult to execute the action as planned due to a task failure, an unexpected situation, an occurrence of disturbance, or the like is assumed.

In step S2005, the action planning unit 2121 changes the action plan. For example, the action planning unit 2121 reviews the action plan and changes a plan of a series of actions necessary for achieving the given purpose. In addition, the action planning unit 2121 decomposes each action after the change into a plurality of tasks.

Note that, at this time, in a case where it is determined that it is difficult to achieve the given purpose, the action planning unit 2121 may determine to stop the action.

Thereafter, the processing proceeds to step S2006.

In step S2006, the action planning unit 2121 determines whether or not there is an action to be executed next. In a case where it is determined that there is an action to be executed next, the processing returns to step S2002.

Thereafter, in step S2006, the pieces of processing of steps S2002 to S2006 are repeatedly executed until it is determined that there is no action to be executed next. As a result, the action is executed according to the action plan.

On the other hand, in a case where it is determined in step S2006 that there is no action to be executed next, the processing in the robot 2011 ends.

### <Processing in Server 2013>

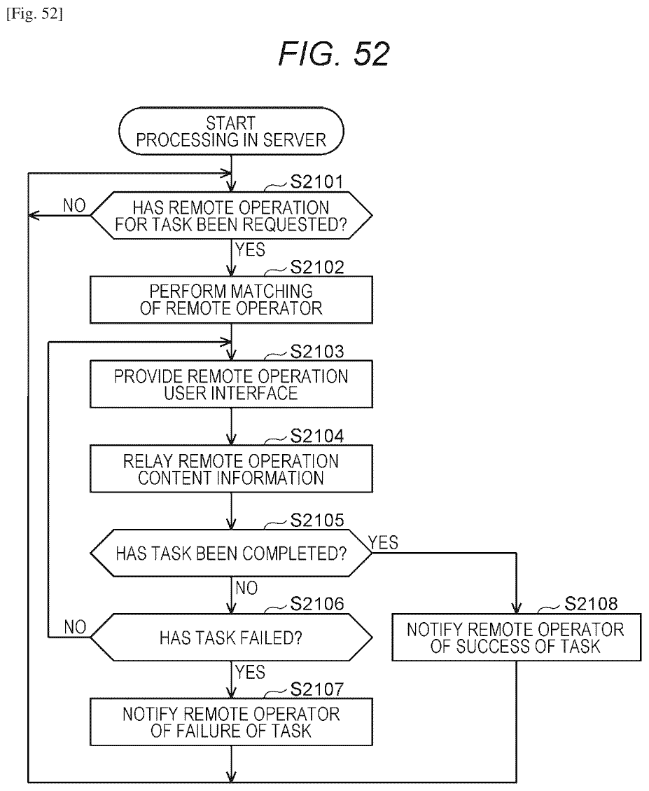

Next, processing executed by the server 2013 corresponding to the processing in the robot 2011 in FIG. 50 will be described with reference to the flowchart of FIG. 52.

In step S2101, the remote control unit 2311 determines whether or not a remote operation for a task has been requested. The determination processing of step S2101 is repeatedly executed until it is determined that a remote operation for a task has been requested. Then, in a case where the remote control unit 2311 receives the task request information transmitted from the robot 2011 in the processing of step S2055 of FIG. 51 via the network 2021 and the communication unit. 2301, it is determined that a remote operation for a task has been requested, and the processing proceeds to step S2102.

In step S2102, the matching unit 2312 performs matching of the remote operator. That is, the matching unit 2312 determines a remote operator in charge of the requested task by executing matching processing.

Here, a method of the matching processing is not particularly limited.

For example, the matching unit 2312 selects one remote operator in charge of the remote operation at the present time point from among the remote operators having skills capable of executing the requested task on the basis of the remote operator database stored in the storage unit 2303.

Alternatively, for example, the matching unit 2312 seeks remote operators having skills capable of executing the requested task, and selects one from the remote operators who have applied.

Note that, for example, in a case where a plurality of remote operators is needed, the matching unit 2312 selects the remote operators corresponding to the number of remote operators.

The matching unit 2312 transmits the task request information to the operation terminal 2012 of the selected remote operator via the communication unit 2301 and the network 2021.

In step S2103, the server 2013 provides the remote operation user interface. For example, the remote control unit 2311 receives the remote operation provision information from the robot 2011 via the network 2021 and the communication unit 2301. The remote control unit 2311 generates the remote operation UT information for providing the remote operation UI on the basis of the remote operation provision information. The remote control unit 2311 transmits the remote operation provision information to the operation terminal 2012 of the remote operator via the communication unit 2301 and the network 2021.

In this case, the operation terminal 2012 presents the remote operation UT to the remote operator on the basis of the remote operation UI information.

Here, it is desirable that the remote operation UI is a UI with which the operators in the world having different skills are highly motivated and can simply perform the remote operation efficiently.

For example, the remote operation UI may include a video obtained by imaging an environment in which the robot 2011 actually executes the task.

Alternatively, for example, the remote operation UI may include a video of a virtual space simulating an environment in which the robot 2011 executes the task by using computer graphics (CG) or the like.

In this case, for example, the remote operation UT may be provided in the virtual space (metaverse space) in which the remote operator exists as an avatar or a character and is active.

This conceals the actual environment around the robot 2011 and protects the privacy of the user of the robot 2011. In addition, it is possible to change information of the real world in such a way as to facilitate execution of the remote operation.

Alternatively, for example, the remote operation UI may include a dedicated video for executing the task, for example, a game video for executing the task, regardless of the environment in which the robot 2011 executes the task.

In this case, for example, the remote operation UI may be provided in an abstract game space or the above-described virtual space. In addition, for example, in a game, an additional value such as level-up, reward/item acquisition, point accumulation, and storyline progression may be given to a remote operator who is a player of the game according to a skill level, an operation success rate, the number of processed operations, an operation processing speed, and the like. In addition, the acquired points may be exchanged for money in the virtual world or the real world.

This conceals the actual environment around the robot 2011 and protects the privacy of the user of the robot 2011L In addition, for example, operability and gameplay are enhanced, and it is possible to expect improvement in motivation and work efficiency of the remote operator. Furthermore, for example, the player of the game can perform the remote operation of the robot 2011 as a task to earn income, so that a new employment form can be provided.

In step S2104, the server 2013 relays the remote operation content information.

For example, the remote operator performs the remote operation for the requested task according to the remote operation UI presented by the operation terminal 2012. The operation terminal 2012 generates the remote operation content information indicating the content of the remote operation, and transmits the remote operation content information to the server 2013 via the network 2021.

In this case, the remote control unit 2311 of the server 2013 receives the remote operation content information via the network 2021 and the communication unit 2301.

The remote control unit 2311 converts the remote operation content information for the robot 2011 as necessary. For example, depending on the content of the remote operation UI, it is necessary to convert the operation content of the remote operator into information for actually remotely operating the robot 2011 (for example, an operation signal). In this case, the remote control unit 2311 converts the remote operation content information for the robot 2011.

The remote control unit 2311 transmits the remote operation content information to the robot 2011 that is the remote operation target via the communication unit 2301 and the network 2021.

In step S2105, the remote control unit 2311 determines whether or not the task has been completed. In a case where it is determined that the task has not been completed, the processing proceeds to step S2106.

In step S2106, the remote control unit 2311 determines whether or not the task has failed. In a case where it is determined that the task has not failed, the processing returns to step S2103.

Thereafter, the pieces of processing of steps S2103 to S2106 are repeatedly executed until it is determined in step S2105 that the task has been completed or it is determined in step S2106 that the task has failed.

On the other hand, in step S2106, in a case where the remote control unit 2311 receives the task failure notification signal transmitted from the robot 2011 in the processing of step S2059 of FIG. 51 via the network 2021 and the communication unit 2301, it is determined that the task has failed, and the processing proceeds to step S2107.

In step S2107, the remote control unit 2311 notifies the remote operator of the failure of the task. Specifically, the remote control unit 2311 transmits the task failure notification signal to the operation terminal 2012 of the remote operator via the communication unit 2301 and the network 2021.

Note that, at this time, the remote control unit 2311 updates, as necessary, information (for example, the skill level or the remote operation history) regarding the remote operator who has failed in the remote operation in the remote operator database stored in the storage unit 2303. In addition, the remote control unit 2311 updates, as necessary, information regarding the task for which the remote operation has failed (for example, the content or the difficulty level) in the task database stored in the storage unit 2303.

Thereafter, the processing returns to step S2101, and the pieces of processing of step S2101 and subsequent steps are executed.

On the other hand, in step S2106, in a case where the remote control unit 2311 receives the task failure notification signal transmitted from the robot 2011 in the processing of step S2059 of FIG. 51 via the network 2021 and the communication unit 2301, it is determined that the task has failed, and the processing proceeds to step S2107.

On the other hand, in step S2105, in a case where the remote control unit 2311 receives the task completion notification signal transmitted from the robot 2011 in the processing of step S2061 of FIG. 51 via the network 2021 and the communication unit 2301, it is determined that the task has been completed, and the processing proceeds to step S2108.

In step S2108, the remote control unit 2311 notifies the remote operator of the completion of the task. Specifically, the remote control unit 2311 transmits the task completion notification signal to the operation terminal 2012 of the remote operator via the communication unit 2301 and the network 2021.

Note that, at this time, the remote control unit 2311 updates, as necessary, information (for example, the skill level or the remote operation history) regarding the remote operator who has succeeded in the remote operation in the remote operator database stored in the storage unit 2303. In addition, the remote control unit 2311 updates, as necessary, information regarding the task for which the remote operation has succeeded (for example, the content or the difficulty level) in the task database stored in the storage unit 2303.

Thereafter, the processing returns to step S2101, and the pieces of processing of step S2101 and subsequent steps are executed.

### Specific Example of Task Execution Processing in Robot 2011

Next, a specific example of task execution processing in the robot 2011 will be described.

### Example of Executing Action of Pouring Tea into Cup and Transporting Cup

First, an example in which the robot 2011 executes an action of pouring tea into a cup and transporting the cup will be described.

For example, the state recognition unit 2131 detects an utterance of a user near the robot 2011.

The autonomous action control unit 2132 instructs the interaction module 2141a to execute a task of executing an interaction with the user.

The autonomous interaction unit 2161a executes an interaction with the user and recognizes a word “I want something to drink” in the utterance of the user.

However, since the certainty factor of speech recognition of the autonomous interaction unit 2161a is low, the remote action control unit 2133 requests the server 2013 to perform the remote operation for the task.

The server 2013 requests the movement operator selected by executing the matching processing to perform the remote operation for the task.

The remote interaction unit 2162a executes an interaction with the user by the remote operation of the interaction operator. As a result, the remote interaction unit 2162a recognizes that the user “wants to drink tea” with a high certainty factor.

In this case, the action planning unit 2121 plans an action of “transporting a cup containing tea to the user”.

Next, the autonomous action control unit 2132 instructs the movement module 2141d to execute a task of moving to the front of a shelf on which the cup is placed.

The autonomous movement unit 2161d moves the robot 2011 to a position 1 m in front of the shelf.

Next, the autonomous action control unit 2132 instructs the observation module 2141b to execute a task of searching for the cup in the shelf.

The shelf has no door, and tableware inside the shelf can be seen. The autonomous observation unit 2161b searches for the cup in the shelf. However, more objects than usual are stored in the shelf, and the certainty factor of recognition of the cup by the autonomous observation unit 2161b is low.

In this case, the remote action control unit 2133 requests the server 2013 to perform the remote operation for the task.

The server 2013 requests the observation operator selected by executing the matching processing to perform the remote operation for the task.

The remote observation unit 2162b fins the cup by the remote operation of the observation operator.

Next, the autonomous action control unit 2132 instructs the movement module 2141d to execute a task of moving the robot 2011 to a position 50 cm in front of the cup.

The autonomous movement unit 2161d moves the robot 2011 to a position 50 cm in front of the cup.

Next, the autonomous action control unit 2132 instructs the work module 2141c to execute a task of gripping the cup.

The autonomous work unit 2161c attempts to grip the cup and it is difficult to grip the cup due to many other objects placed around the cup. Therefore, while the autonomous work unit 2161c is searching for an optimal approach to the cup, an instructed work time has been exceeded.

In this case, the remote action control unit 2133 requests the server 2013 to perform the remote operation for the task.

The server 2013 requests the work operator selected by executing the matching processing to perform the remote operation for the task.

The remote work unit 2162c causes the robot 2011 to grip the cup by the remote operation of the remote operator.

Next, the autonomous action control unit 2132 instructs the movement module 2141d to execute a task of moving to the front of a tea feeder.

The autonomous movement unit 2161d moves the robot 2011 to the front of the tea feeder.

Next, the autonomous action control unit 2132 instructs the work module 2141c to execute a task of putting the cup in the tea feeder.

The autonomous work unit 2161c puts the cup in the tea feeder.

Next, the autonomous action control unit 2132 instructs the work module 2141c to execute a task of operating a tea feeing switch of the tea feeder.

The autonomous work unit 2161c performs an operation of the tea feeding switch of the tea feeder. Accordingly, the tea is poured into the cup by the tea feeder.

The autonomous action control unit 2132 instructs the work module 2141c to execute a task of gripping the cup containing tea.

The autonomous work unit 2161c starts to grip the cup.

However, while the autonomous work unit 2161c is gripping the cup, the autonomous interaction unit 2161a detects an utterance of a staff in a kitchen who is a third party with respect to the robot 2011. The autonomous interaction unit 2161a recognizes that a content of the utterance of the staff is “Can you step aside for a moment?” by speech recognition.

In this case, the action planning unit 2121 determines that moving to a place that does not interfere with the staff has a higher priority than gripping the cup. The autonomous action control unit 2132 instructs the work module 2141c to stop the task of gripping the cup.

The autonomous work unit 2161c stops the gripping of the cup and returns the arm of the robot 2011 holding the cup to the original standard posture.

The autonomous action control unit 2132 instructs the movement module 2141d to execute a task of moving to a place 1 m away from the front of the tea feeder in the opposite direction to that of the staff.

The autonomous movement unit 2161d attempts to move from the front of the tea feeder. However, since a passage width is narrow and there are many obstacles including a person around the robot 2011, a movement route plan of the autonomous movement unit 2161d fails, and movement of the robot 2011 is disabled.

In this case, the remote action control unit 2133 requests the server 2013 to perform the remote operation for the task.

The server 2013 requests the movement operator selected by executing the matching processing to perform the remote operation for the task.

The remote movement unit 2162d moves the robot 2011 from the front of the tea feeder by the remote operation of the movement operator.

Next, the autonomous action control unit 2132 instructs the observation module 2141b to execute a task of confirming a state of the obstacles including a person in front of the tea feeder in order to determine whether or not to return to the original task (gripping of the cup).

The autonomous observation unit 2161b confirms that there is no obstacle including a person in front of the tea feeder. However, since there are many objects around the tea feeder, the certainty factor of the autonomous observation unit 2161b is low.

In this case, the remote action control unit 2133 requests the server 2013 to perform the remote operation for the task.

The server 2013 requests the observation operator selected by executing the matching processing to perform the remote operation for the task.

The remote observation unit 2162b confirms that there is no obstacle in front of the tea feeder by the remote operation of the observation operator.

Next, the autonomous action control unit 2132 instructs the movement module 2141d to execute a task of moving to the front of the tea feeder.

The autonomous movement unit 2161d moves the robot 2011 to the front of the tea feeder.

Next, the autonomous action control unit 2132 instructs the work module 2141c to execute a task of gripping the cup put in the tea feeder.

The autonomous work unit 2161c causes the robot 2011 to grip the cup.

Next, the autonomous action control unit 2132 instructs the movement module 2141d to execute a task of moving to the front of the desk where the user is present.

The autonomous movement unit 2161d moves the robot 2011 to the front of the desk where the user is present.

Next, the autonomous action control unit 2132 instructs the observation module 2141b to execute a task of finding the user and confirming the state.

The autonomous observation unit 2161b detects the position and orientation of the face of the user. However, since the user is slightly depressed and there are many shadows on the face of the user, the certainty factor of the autonomous observation unit 2161b is low.

In this case, the autonomous action control unit 2132 requests the server 2013 to perform the remote operation for the task.

The server 2013 requests the observation operator selected by executing the matching processing to perform the remote operation for the task.

The remote observation unit 2162b finds the user by the remote operation of the observation operator and confirms that there is no abnormality in the user.

Next, the autonomous action control unit 2132 instructs the interaction module 2141a to execute a task of starting conversation with the user, such as “I've got some tea for you” or “I'll put the cup here”.

The autonomous interaction unit 2161a starts conversation with the user. At this time, in a case where, although there is a response from the user, the user is slightly depressed, the pronunciation is unclear, and there is a lot of environmental noise, it may be difficult for the autonomous interaction unit 2161a to recognize the response of the user.

In this case, the remote action control unit 2133 requests the server 2013 to perform the remote operation for the task.

The server 2013 requests the interaction operator selected by executing the matching processing to perform the remote operation for the task.

The remote interaction unit 2162a starts conversation with the user by the remote operation of the interaction operator. Then, the remote interaction unit 2162a (remote operator) confirms that the user is positive with a high certainty factor.

Next, the autonomous action control unit 2132 instructs the work module 2141c to execute a task of placing the cup on the desk.

The autonomous work unit 2161c places the cup on the desk.

Next, the autonomous action control unit 2132 instructs the interaction module 2141a to execute a task of interacting with the user.

The autonomous interaction unit 2161a executes an interaction with the user.

Then, the action planning unit 2121 confirms completion of the action of “transporting the cup containing tea to the user”.

By combining the autonomous operation and the remote operation as described above, the robot 2011 can pour tea into the cup and transport the cup to the user while interacting with the user.

### Example of Executing Action of Measuring Vital Value of Nursing Care Target Person

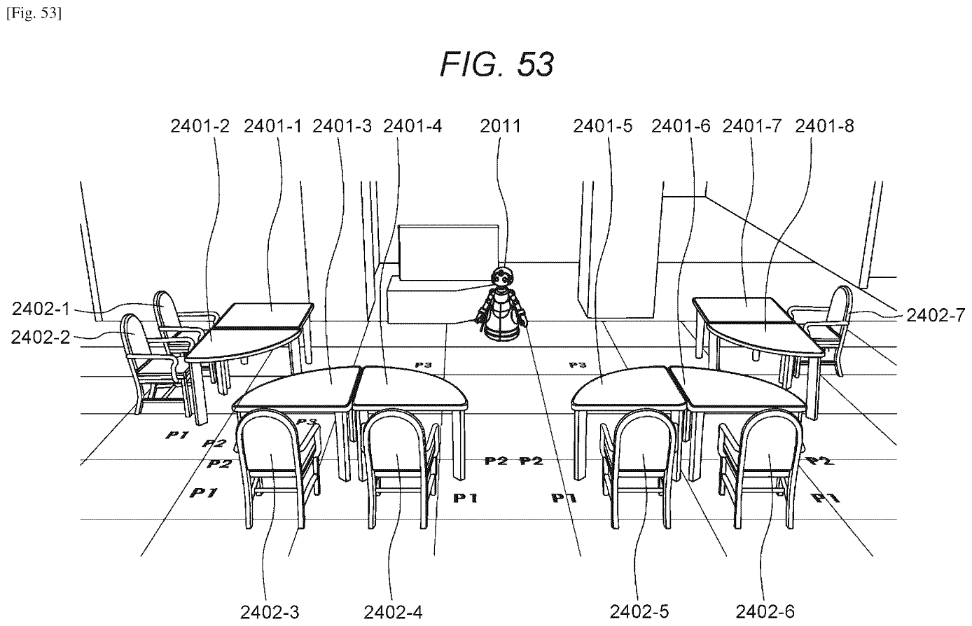

Next, an example in which the robot 2011 of FIG. 48 executes an action of measuring a vital value of a nursing care target person 2403 will be described with reference to FIGS. 53 to 56.

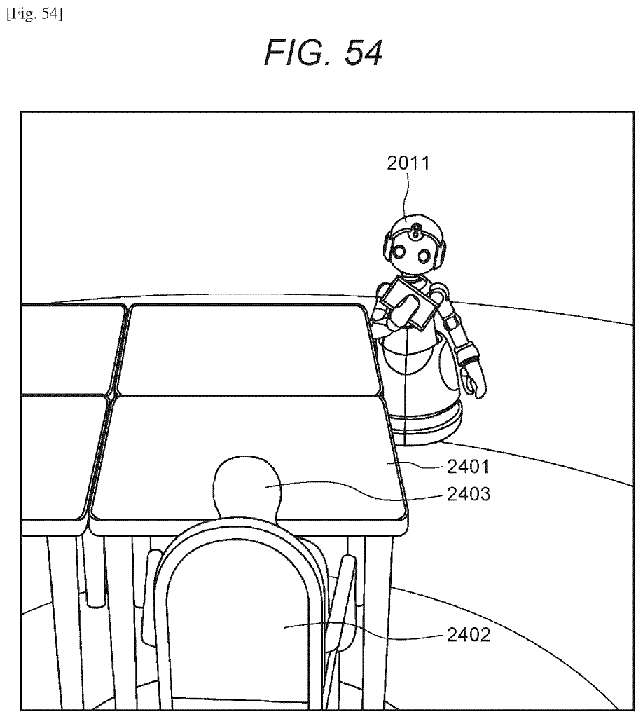

Note that, hereinafter, an example of a case where the robot 2011 executes a vital measurement application for measuring the vital value of the target person 2403 (FIG. 54) in a living room illustrated in FIG. 53 will be described.

In FIG. 53, a position where the robot 2011 is present is a home position P0, and for example, a charging dock (not illustrated) is arranged. In addition, tables 2401-1 to 2401-8 and chairs 2402-1 to 2402-7 are arranged in the living room.

The tables 2401-1 to 2401-8 are arranged in a U shape. That is, a row of the tables 2401-1 and 2401-2, a row of the tables 2401-3 to 2401-6, and a row of the tables 2401-7 and 2401-8 are arranged in a U shape. The row of the tables 2401-3 to 2401-6 is arranged in front of the robot 2011. The row of the tables 2401-1 and 2401-2 and the row of the tables 2401-7 and 2401-8 are arranged in a direction perpendicular to the row of the tables 2401-3 to 2401-6 and face each other.

Furthermore, the chairs 2402-1 to 2402-7 are arranged for the tables 2401-1 to 2401-7, respectively. Note that no chair is arranged for the table 2401-8.

Note that, hereinafter, in a case where it is not necessary to individually distinguish the tables 2401-1 to 2401-7, they are simply referred to as the table 2401. Hereinafter, in a case where it is not necessary to individually distinguish the chairs 2402-1 to 2402-7, they are simply referred to as the chair 2402.

Further, in FIG. 53, a long-distance position P3, a middle-distance position P2, and a short-distance position P1 with respect to each chair 2402 are illustrated.

For example, the long-distance position P3 is set to a position about 2 m away from the target person 2403 in a direction of about 0 degrees with respect to the front of a target person 2403 who is a target for the robot 2011 to execute the application.

For example, the middle-distance position P2 is set to a position about 1.2 m away from the target person 2403 in a direction of about 45 degrees with respect to the front of the target person 2403.

For example, the short-distance position P1 is set to a position about 0.6 n away from the target person 2403 in a direction of about 70 degrees with respect to the front of the target person 2403.

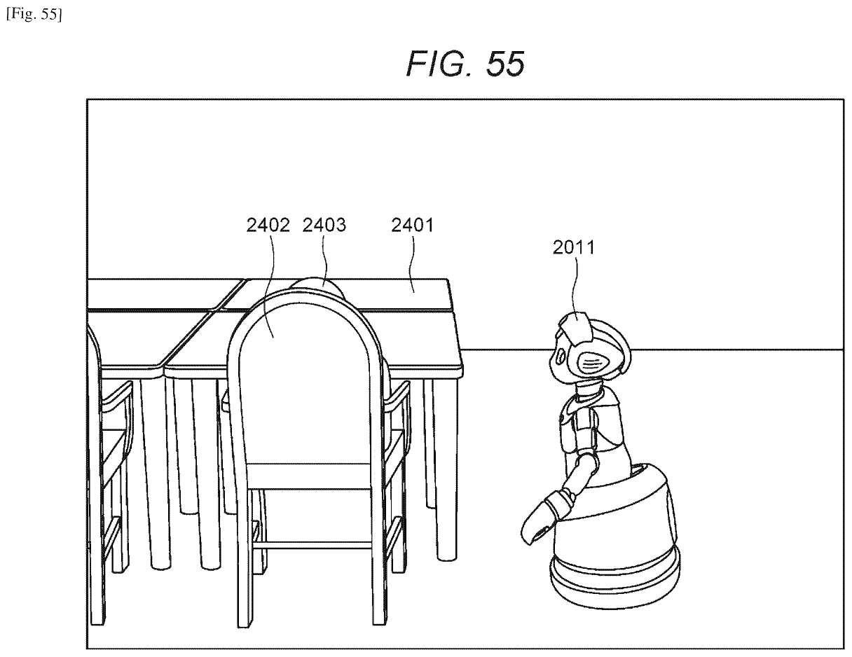

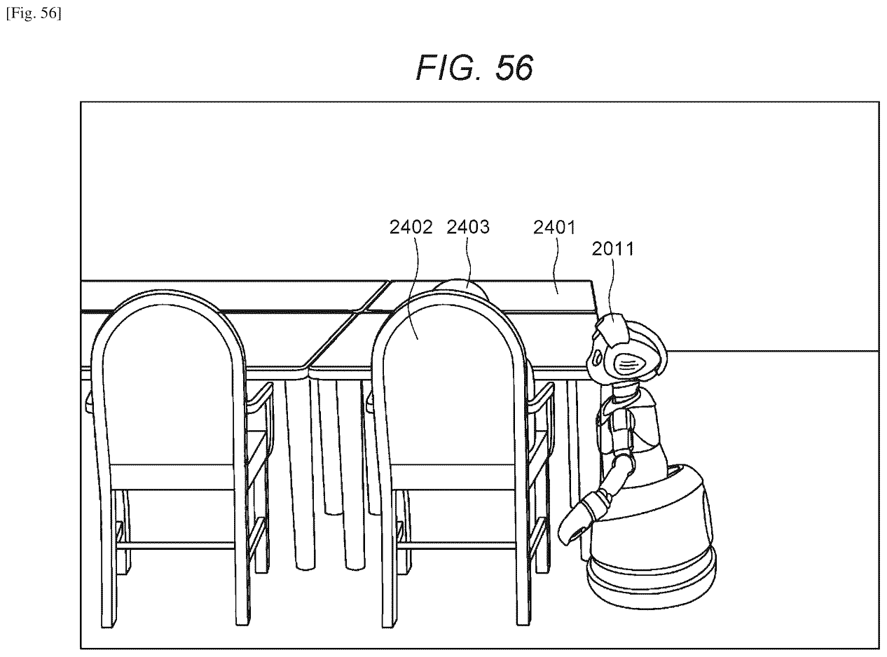

For example, the action planning unit 2121 plans an action of starting conversation with the target person 2403 at each position while approaching the target person 2403 in the order of the long-distance position P3 (FIG. 54), the middle-distance position P2 (FIG. 55), and the short-distance position P1 (FIG. 56), and finally measuring the vital value of the target person 2403 at the short-distance position P1.

Next, the autonomous action control unit 2132 instructs the movement module 2141d to execute a task of moving to the long-distance position P3.

The autonomous movement unit 2161d moves the robot 2011 to the long-distance position P3.

Here, for example, in a case where it is difficult to move to the long-distance position P3 within a target time, the remote action control unit 2133 requests the server 2013 to perform the remote operation for the task.

The server 2013 requests the movement operator selected by executing the matching processing to perform the remote operation for the task.

The remote movement unit 2162d moves the robot 2011 to the long-distance position P3 by the remote operation of the movement operator. Here, since the movement operator is superior in situation recognition and determination to the robot 2011, a task success rate increases. This similarly applies to the following movement task.

Next, the autonomous action control unit 2132 requests the interaction module 2141a to execute a task of interacting with the target person 2403.

The autonomous interaction unit 2161a executes an interaction with the target person 2403.

Here, for example, in a case where a failure of the interaction with the target person 2403 is detected, the remote action control unit 2133 requests the server 2013 to perform the remote operation for the task.

The server 2013 requests the interaction operator selected by executing the matching processing to perform the remote operation for the task.

The remote interaction unit 2162a executes an interaction with the target person 2403 by the remote operation of the interaction operator. Here, since the interaction operator is superior in situation recognition and determination to the robot 2011, the task success rate increases. This similarly applies to the following interaction task.

Next, the autonomous action control unit 2132 instructs the movement module 2141d to execute a task of moving to the middle-distance position P2.

The autonomous movement unit 2161d moves the robot 2011 to the middle-distance position P2.

Here, for example, in a case where it is difficult to move to the middle-distance position P2 within a target time, the remote action control unit 2133 requests the server 2013 to perform the remote operation for the task.

The server 2013 requests the movement operator selected by executing the matching processing to perform the remote operation for the task. At this time, the server 2013 may preferentially request the previously requested movement operator for the remote operation.

The remote movement unit 2162d moves the robot 2011 to the middle-distance position P2 by the remote operation of the movement operator.

Next, the autonomous action control unit 2132 requests the interaction module 2141a to execute a task of interacting with the target person 2403.

The autonomous interaction unit 2161a executes an interaction with the target person 2403.

Here, for example, in a case where a failure of the interaction with the target person 2403 is detected, the remote action control unit 2133 requests the server 2013 to perform the remote operation for the task.

The server 2013 requests the interaction operator selected by executing the matching processing to perform the remote operation for the task. At this time, the server 2013 may preferentially request the previously requested interaction operator for the remote operation.

The remote interaction unit 2162a executes an interaction with the target person 2403 by the remote operation of the interaction operator.

Next, the autonomous action control unit 2132 instructs the movement module 2141d to execute a task of moving to the short-distance position P1.

The autonomous movement unit 2161d moves the robot 2011 to the short-distance position P1.

Here, for example, in a case where it is difficult to move to the short-distance position P1 within a target time, the remote action control unit 2133 requests the server 2013 to perform the remote operation for the task.

The server 2013 requests the movement operator selected by executing the matching processing to perform the remote operation for the task. At this time, the server 2013 may preferentially request the previously requested movement operator for the remote operation.

The remote movement unit 2162d moves the robot 2011 to the short-distance position P1 by the remote operation of the movement operator.

Next, the autonomous action control unit 2132 requests the interaction module 2141a to execute a task of interacting with the target person 2403.

The autonomous interaction unit 2161a executes an interaction with the target person 2403.

Here, for example, in a case where a failure of the interaction with the target person 2403 is detected, the remote action control unit 2133 requests the server 2013 to perform the remote operation for the task.

The server 2013 requests the interaction operator selected by executing the matching processing to perform the remote operation for the task. At this time, the server 2013 may preferentially request the previously requested interaction operator for the remote operation.

The remote interaction unit 2162a executes an interaction with the target person 2403 by the remote operation of the interaction operator.

Next, the autonomous action control unit 2132 instructs the observation module 2141b to execute a task of recognizing the positions of the face and the hand of the target person 2403.

The autonomous observation unit 2161b attempts to recognize the positions of the face and the hand of the target person 2403.

Here, for example, in a case where the recognition of the positions of the face and the hand of the target person 2403 has failed, the remote action control unit 2133 requests the server 2013 to perform the remote operation for the task.

The server 2013 requests the observation operator selected by executing the matching processing to perform the remote operation for the task.

The remote observation unit 2162b recognizes the positions of the face and the hand of the target person 2403 by the remote operation of the observation operator. Here, since the observation operator is superior in situation recognition and determination to the robot 2011, the task success rate increases. This similarly applies to the following observation task.

Next, the autonomous action control unit 2132 instructs the work module 2141c to execute a task of holding out the hand 2233 of the robot 2011 toward the front of the target person 2403.

The autonomous work unit 2161c attempts to hold out the hand 2233 of the robot 2011 toward the front of the target person 2403.

Here, for example, in a case where the hand 2233 of the robot 2011 is not held out toward the front of the target person 2403, the remote action control unit 2133 requests the server 2013 to perform the remote operation for the task.

The server 2013 requests the work operator selected by executing the matching processing to perform the remote operation for the task.

The remote observation unit 2162b holds out the hand 2233 of the robot 2011 toward the front of the target person 2403 by the remote operation of the work operator.

At this time, for example, even in a case where an unexpected situation in which an obstacle is present on the table 2401 occurs, the work operator finds and moves the obstacle, so that a space for holding out the hand 2233 can be easily secured. In this case, it is difficult for the robot 2011 to autonomously move the obstacle and to hold out the hand 2233 of the robot 2011 toward the front of the target person 2403.

Next, for example, the autonomous interaction unit 2161a detects an unexpected situation such as an utterance of a staff who is a third party with respect to the robot 2011. The autonomous interaction unit 2161a attempts to recognize a content of the utterance of the staff.

Here, for example, in a case where the autonomous interaction unit 2161a has not been able to recognize the content of the utterance of the staff, the remote action control unit 2133 requests the server 2013 to perform the remote operation for a task of recognizing the content of the utterance of the staff.

The server 2013 requests the interaction operator selected by executing the matching processing to perform the remote operation for the task.

The remote interaction unit 2162a interacts with the staff by the remote operation of the interaction operator, and recognizes that the content of the utterance of the staff is “Can you step aside for a moment?”.

At this time, for example, even in a case where an unexpected situation such as the utterance of the staff occurs, the interaction operator can easily recognize the content of the utterance of the staff.

Next, the action planning unit 2121 determines that a priority of a task of moving in such a way that the staff can pass is high. In this case, the autonomous action control unit 2132 instructs the movement module 2141d to execute the task of moving in such a way that the staff can pass.

The autonomous movement unit 2161d attempts to move the robot 2011 in such a way that the staff can pass.

Here, for example, in a case where it is difficult to move in such a way that the staff can pass within a target time, the remote action control unit 2133 requests the server 2013 to perform the remote operation for the task.

The server 2013 requests the movement operator selected by executing the matching processing to perform the remote operation for the task. At this time, the server 2013 may preferentially request the previously requested movement operator for the remote operation.

The remote movement unit 2162d moves the robot 2011 in such a way that the staff can pass by the remote operation of the movement operator.

At this time, for example, even in a case where an unexpected situation such as movement to an unplanned position occurs, the movement operator can easily move the robot 2011.

Next, the autonomous action control unit 2132 instructs the observation module 2141b to execute a task of confirming the passage of the staff.

The autonomous observation unit 2161b attempts to confirm the passage of the staff.

Here, for example, in a case where confirmation of the passage of the staff has failed, the remote action control unit 2133 requests the server 2013 to perform the remote operation for the task.

The server 2013 requests the observation operator selected by executing the matching processing to perform the remote operation for the task. At this time, the server 2013 may preferentially request the previously requested observation operator for the remote operation.

The remote observation unit 2162b confirms the passage of the staff by the remote operation of the observation operator.

At this time, for example, even in a case where an unexpected situation such as confirmation of the passage of the staff occurs, the observation operator can easily confirm the passage of the staff.

Thereafter, the tasks from the task of moving to the short-distance position P1 to the task of holding out the hand 2233 of the robot 2011 toward the front of the target person 2403 are executed again.

Next, the autonomous action control unit 2132 instructs the interaction module 2141a to execute a task of requesting the target person 2403 to touch the hand 2233 of the robot 2011.

The autonomous interaction unit 2161a requests the target person 2403 to touch the hand 2233 of the robot 2011.

Here, for example, in a case where a failure of the interaction with the target person 2403 is detected, the remote action control unit 2133 requests the server 2013 to perform the remote operation for the task.

The server 2013 requests the interaction operator selected by executing the matching processing to perform the remote operation for the task. At this time, the server 2013 may preferentially request the previously requested interaction operator for the remote operation.

The remote interaction unit 2162a requests the target person 2403 to touch the hand 2233 of the robot 2011 by the remote operation of the interaction operator.

Next, the autonomous action control unit 2132 instructs the observation module 2141b to execute a task of confirming that the hand of the target person 2403 is in contact with the hand 2233 of the robot 2011.

The autonomous observation unit 2161b confirms that the hand of the target person 2403 is in contact with the hand 2233 of the robot 2011.

Here, for example, in a case where the confirmation of the contact of the hand of the target person 2403 with the hand 2233 of the robot 2011 has failed, the remote action control unit 2133 requests the server 2013 to perform the remote operation for the task.

The server 2013 requests the observation operator selected by executing the matching processing to perform the remote operation for the task. At this time, the server 2013 may preferentially request the previously requested observation operator for the remote operation.

The remote observation unit 2162b confirms that the hand of the target person 2403 is in contact with the hand 2233 of the robot 2011 by the remote operation of the observation operator.

Here, for example, it is assumed that the remote operations for the task of holding out the hand 2233 of the robot 2011 toward the front of the target person 2403, the task of requesting the target person 2403 to touch the hand 2233 of the robot 2011, and the task of confirming that the hand of the target person 2403 is in contact with the hand 2233 of the robot 2011 are more efficient and have a higher success rate in a case of being executed in parallel than in a case of being executed sequentially.

In this case, for example, the autonomous action control unit 2132 may request the work operator, the interaction operator, and the observation operator for the remote operation in parallel via the server 2013. Then, the work operator, the interaction operator, and the observation operator may perform the remote operations in parallel.

In this case, since the work module 2141c that is a target of the remote operation of the work operator, the interaction module 2141a that is a target of the remote operation of the interaction operator, and the observation module 2141b that is a target of the remote operation of the observation operator can independently execute a task, parallel processing of each task by the remote operation is smoothly executed.

Note that, in this case, the work operator, the interaction operator, and the observation operator are not necessarily be separate operators, and for example, one operator having a plurality of skills may also serve as two or more operators.

Next, the autonomous action control unit 2132 instructs the observation module 2141b to execute a task of measuring the vital value of the target person 2403.

The remote observation unit 2162b measures the vital value of the target person 2403.

Next, the autonomous action control unit 2132 instructs the interaction module 2141a to execute a task of requesting the target person 2403 to release the hand from the hand 2233 of the robot 2011.

The autonomous interaction unit 2161a requests the target person 2403 to release the hand from the hand 2233 of the robot 2011.

Here, for example, in a case where a failure of the interaction with the target person 2403 is detected, the remote action control unit 2133 requests the server 2013 to perform the remote operation for the task.

The server 2013 requests the interaction operator selected by executing the matching processing to perform the remote operation for the task. At this time, the server 2013 may preferentially request the previously requested interaction operator for the remote operation.

The remote interaction unit 2162a requests the target person 2403 to release the hand from the hand 2233 of the robot 2011 by the remote operation of the interaction operator.

Next, the autonomous action control unit 2132 instructs the observation module 2141b to execute a task of confirming that the hand of the target person 2403 is separated from the hand 2233 of the robot 2011.

The autonomous observation unit 2161b confirms that the hand of the target person 2403 is separated from the hand 2233 of the robot 2011.

Here, for example, in a case where the confirmation of the separation of the hand of the target person 2403 from the hand 2233 of the robot 2011 has failed, the remote action control unit 2133 requests the server 2013 to perform the remote operation for the task.

The server 2013 requests the observation operator selected by executing the matching processing to perform the remote operation for the task. At this time, the server 2013 may preferentially request the previously requested observation operator for the remote operation.

The remote observation unit 2162b confirms that the hand of the target person 2403 is separated from the hand 2233 of the robot 2011 by the remote operation of the observation operator.

Next, the autonomous action control unit 2132 instructs the work module 2141c to execute a task of returning the hand 2233 of the robot 2011 to the original posture.

The autonomous work unit 2161c attempts to return the hand 2233 of the robot 2011 to the original posture.

Here, for example, in a case where it is difficult to return the hand 2233 of the robot 2011 to the original posture, the remote action control unit 2133 requests the server 2013 to perform the remote operation for the task.

The server 2013 requests the work operator selected by executing the matching processing to perform the remote operation for the task.

The remote observation unit 2162b returns the hand 2233 of the robot 2011 to the original posture by the remote operation of the work operator.

Next, the autonomous action control unit 2132 requests the interaction module 2141a to execute a task of interacting with the target person 2403.

The autonomous interaction unit 2161a executes an interaction with the target person 2403.

Here, for example, in a case where a failure of the interaction with the target person 2403 is detected, the remote action control unit 2133 requests the server 2013 to perform the remote operation for the task.

The server 2013 requests the interaction operator selected by executing the matching processing to perform the remote operation for the task. At this time, the server 2013 may preferentially request the previously requested interaction operator for the remote operation.

The remote interaction unit 2162a executes an interaction with the target person 2403 by the remote operation of the interaction operator.

Next, the autonomous action control unit 2132 instructs the movement module 2141d to execute a task of moving to the next target position.

The autonomous movement unit 2161d moves the robot 2011 to the next target position.

Here, for example, in a case where it is difficult to move to the next target position within a target time, the remote action control unit 2133 requests the server 2013 to perform the remote operation for the task.

The server 2013 requests the movement operator selected by executing the matching processing to perform the remote operation for the task. At this time, the server 2013 may preferentially request the previously requested movement operator for the remote operation.

The remote movement unit 2162d moves the robot 2011 to the next target position by the remote operation of the movement operator.

By combining the autonomous operation and the remote operation as described above, the robot 2011 can smoothly measure the vital value of the target person 2403.

### Example of Executing Action of Opening and Passing Door

Next, an example in which the robot 2011 executes an action of opening and passing a door will be described.

For example, the action planning unit 2121 plans an action of moving to the front of the door, opening the door, and then passing the door.

Next, the autonomous action control unit 2132 instructs the movement module 2141d to execute on a task of moving to the front of the door.

The autonomous movement unit 2161d moves the robot 2011 to the front of the door.

Here, for example, in a case where it is difficult to move to the front of the door, the remote action control unit 2133 requests the server 2013 to perform the remote operation for the task.

The server 2013 requests the movement operator selected by executing the matching processing to perform the remote operation for the task.

The remote movement unit 2162d moves the robot 2011 to the front of the door by the remote operation of the movement operator.

Next, the autonomous action control unit 2132 instructs the observation module 21411b to execute a task of recognizing a door handle.

The autonomous observation unit 2161b attempts to recognize the door handle.

Here, for example, in a case where the recognition of the door handle has failed, the remote action control unit 2133 requests the server 2013 to perform the remote operation for the task.

The server 2013 requests the observation operator selected by executing the matching processing to perform the remote operation for the task.

The remote observation unit 2162b recognizes the door handle by the remote operation of the observation operator.

Next, the action planning unit 2121 plans an action of opening the door and moving on the basis of the shapes, positions, and the like of the door and the door handle.

Next, the autonomous action control unit 2132 instructs the work module 2141c to execute a task of gripping the door handle.

The autonomous work unit 2161c attempts to grip the door handle.

Here, for example, in a case where it is difficult to grip the door handle within a target time, the remote action control unit 2133 requests the server 2013 to perform the remote operation for the task.

The server 2013 requests the work operator selected by executing the matching processing to perform the remote operation for the task.

The remote observation unit 2162b grips the door handle by the remote operation of the work operator. At this time, since the work operator has more excellent recognition ability for the shape and position of the door handle than the robot 2011, the task success rate increases.

Next, the autonomous action control unit 2132 instructs the work module 2141c to execute a task of rotating the door handle.

The autonomous work unit 2161c attempts to rotate the door handle.

Here, for example, in a case where it is difficult to rotate the door handle within a target time, the remote action control unit 2133 requests the server 2013 to perform the remote operation for the task.

The server 2013 requests the work operator selected by executing the matching processing to perform the remote operation for the task. At this time, the server 2013 may preferentially request the previously requested work operator for the remote operation.

The remote observation unit 2162b rotates the door handle by the remote operation of the work operator. At this time, since the work operator has more excellent ability to adjust the moving direction, force, and the like according to the type and shape of the door handle than the robot 2011, the task success rate increases.

Next, the autonomous action control unit 2132 instructs the work module 2141c and the movement module 2141d to execute a task of pulling and opening the door.

The autonomous work unit 2161c and the autonomous movement unit 2161d attempt an operation of pulling and opening the door while appropriately moving the robot 2011.

Here, for example, in a case where the door has not been pulled and opened within a target time, the remote action control unit 2133 requests the server 2013 to perform the remote operation for the task.

The server 2013 requests the work operator and the movement operator selected by executing the matching processing to perform the remote operation for the task. At this time, the server 2013 may preferentially request the previously requested work operator for the remote operation. Furthermore, the server 2013 may request one remote operator to perform the remote operation for the task.

The remote work unit 2162c and the remote movement unit 2162d pull and open the door by the remote operations of the work operator and the movement operator. At this time, since the work operator and the movement operator are superior in situation recognition and determination to the robot 2011, the task success rate increases.

Next, the autonomous action control unit 2132 instructs the work module 2141c to execute a task of holding the door.

The autonomous work unit 2161c attempts to hold the door with a hand opposite to the hand gripping the door handle.

Here, for example, in a case where the door has not been held within a target time, the remote action control unit 2133 requests the server 2013 to perform the remote operation for the task.

The server 2013 requests the work operator selected by executing the matching processing to perform the remote operation for the task. At this time, the server 2013 may preferentially request the previously requested work operator for the remote operation.

The remote work unit 2162c holds the door by the remote operation of the operation operator.

Next, the autonomous action control unit 2132 instructs the work module 2141c and the movement module 2141d to execute a task of passing the door while holding the door.

The autonomous work unit 2161c and the autonomous movement unit 2161d attempt an operation of passing the door while holding the door.

Here, for example, in a case where the door has not been passed while the door is held within a target time, the remote action control unit 2133 requests the server 2013 to perform the remote operation for the task.

The server 2013 requests the work operator and the movement operator selected by executing the matching processing to perform the remote operation for the task. At this time, the server 2013 may preferentially request the previously requested work operator and movement operator for the remote operation. Furthermore, the server 2013 may request one remote operator to perform the remote operation for the task.

The remote work unit 2162c and the remote movement unit 2162d pass the door while holding the door by the remote operations of the work operator and the movement operator. At this time, since the work operator and the movement operator are superior in situation recognition and determination to the robot 2011, the task success rate increases.

By combining the autonomous operation and the remote operation as described above, the robot 2011 can smoothly open and pass the door.

Note that, in this action, two or more of the work operator, the movement operator, and the observation operator may perform the remote operations in parallel as necessary. This may improve the efficiency of the remote operation for each task. Further, in this case, the work operator, the movement operator, and the observation operator are not necessarily separate operators, and for example, one operator having a plurality of skills may also serve as two or more operators.

### Effects of Second Embodiment of Present Technology

Hereinafter, effects of the second embodiment of the present technology will be described.

For example, reliability and functions of various actions of the robot 2011 are improved. That is, the robot 2011 autonomously executes a task that the robot 2011 is good at and executes a task that the robot is bad at by remote operation, so that it is possible to implement the robot 2011 having a new architecture capable of utilizing the brain or sensory organ of the remote operator as a component. As a result, the reliability of various actions of the robot 2011 can be enhanced to a human level or higher. In addition, the robot 2011 can stably perform multiple tasks demanding hospitality.

For example, each action of the robot 2011 is divided into a plurality of micro-level tasks, and the remote operation is requested, so that work efficiency of the remote operator is improved. That is, since each task is simplified to a level irrelevant to the context, the remote operation is easy and simple, and a time taken for the remote operation is also shortened. Therefore, for example, each remote operator can perform the remote operations of the plurality of robots 2011 in parallel. Furthermore, for example, each remote operator can participate in the remote operation of the robot 2011 while performing other work or job, or can participate in the remote operation of the robot 2011 in a short extra time.

For example, since the robot 2011 is modularized for each skill, the remote operations related to the skills can be performed in parallel. This enables a plurality of remote operators to remotely operate one robot 2011 in parallel.

For example, the number of skills demanded for the remote operator is reduced, so that more remote operators can perform the remote operation. For example, since each task is simple, it is easy to implement a user interface with good operability. Therefore, for example, a handicapped person can easily perform the remote operation. As a result, as described above with reference to FIG. 45, many people in the world can participate in and play an active role in the remote operation of the robots 2011 in the world. In addition, it is easy for each remote operator to obtain a job, and it is possible to eliminate labor shortage. Furthermore, since the requirements for each task are reduced and the operability is improved, the failure rate of the remote operation is lowered and the quality of the task by the remote operation is improved.

For example, the amount and time of tasks to be remotely operated for one robot 2011 can be reduced. As a result, the cost of operating the robot 2011 can be reduced.

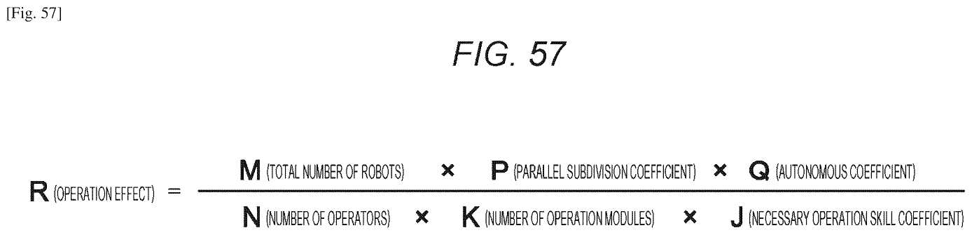

FIG. 57 illustrates an example of a calculation formula of an operation effect R of the remote operation control system 2001.

The operation effect R is proportional to the total number M of robots, a parallel subdivision coefficient P, and an autonomous coefficient Q. On the other hand, the operation effect R is inversely proportional to the number N of operators, the number K of operation modules, and a necessary operation skill coefficient J.

The total number M of robots is the total number of robots 2011 operating in the remote operation control system 2001.

The parallel subdivision coefficient P indicates the degree of parallel subdivision of the task. For example, the more the task is subdivided, the larger the parallel subdivision coefficient P becomes.

The autonomous coefficient Q indicates the degree of automation of the robot 2011. As a proportion of tasks that can be autonomously executed by the robot 2011 increases, the autonomous coefficient Q increases. Normally, the more the task is subdivided, the larger the proportion of the tasks that can be autonomously executed by the robot 2011 becomes, and thus the autonomous coefficient Q increases.

The number N of operators is the total number of remote operators necessary for smoothly operating the robots 2011 of the total number M of robots operating in the remote operation control system 2001.

The number K of operation modules is the number of task execution modules 2141 included in the robot 2011. For example, since the robot 2011 described above includes four task execution modules 2141, the interaction module 2141a, the observation module 2141b, the work module 2141c, and the movement module 2141d, the number K of operation modules is four.

The necessary operation skill coefficient J indicates the level of skill necessary for the remote operation for a task, and the necessary operation skill coefficient J increases as the level of skill necessary for the remote operation for a task increases. Normally, the more the task is subdivided, the lower the level of skill necessary for the remote operation for a task becomes, and thus the necessary operation skill coefficient J decreases. Normally, as the number of robots 2011 per person increases, the level of skill necessary for the remote operation for a task increases, and thus the necessary operation skill coefficient J increases.

In the remote operation control system 2001, the number N of operators and the number K of operation modules increase, which is a factor of reducing the operation effect R. On the other hand, the parallel subdivision coefficient P increases, and the necessary operation skill coefficient J decreases. As a result, the number of robots 2011 that can be operated by each remote operator increases, and the total number M of robots can be greatly increased. Therefore, the operation effect R can be increased as a whole.

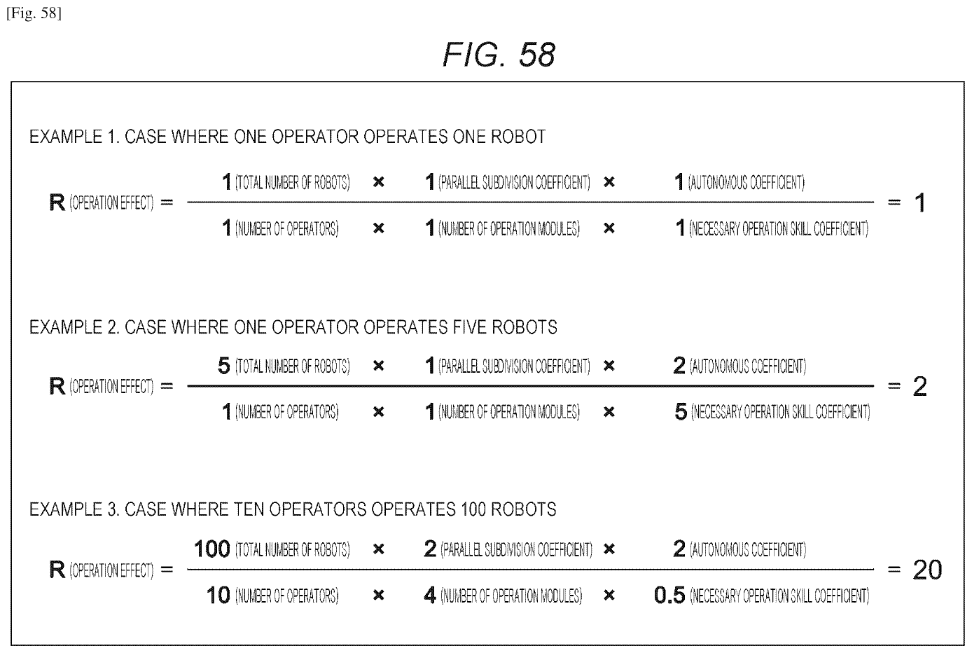

FIG. 58 illustrates a specific example of the operation effect R.

Example 1 illustrates an example in which one remote operator operates one robot 2011. In this case, the operation effect R is 1, and this value is a reference value of the operation effect R.

Note that, in Example 1, the number of remote operators is one, and it is not necessary to divide the task execution module of the robot 2011, and thus, an example is illustrated in which the number K of operation modules is one.

Example 2 illustrates an example in which one remote operator operates five robots 2011. In this case, it is necessary to increase the autonomous coefficient Q of the robot 2011 in order to suppress an increase in necessary operation skill coefficient J. However, even in a case where the autonomous coefficient Q is increased, one remote operator needs to operate the five robots for the entire time, and thus the necessary operation skill coefficient J increases. Further, in this example, the value of the operation effect R is 2.

Note that, in Example 2, similarly to Example 1, the number of remote operators is one, and it is not necessary to divide the task execution module of the robot 2011, and thus, an example is illustrated in which the number K of operation modules is one.

Example 3 illustrates an example in which ten remote operators operate 100 robots 2011 in the remote operation control system 2001. In this case, since each robot 2011 includes four task execution modules 2141, the number K of operation modules is four. Then, as the number K of operation modules increases, the degree of parallel subdivision of the task increases, the parallel subdivision coefficient P increases, and the necessary operation skill coefficient J decreases. As a result, the value of the operation effect R is increased from 2 to 20 as compared with Example 2. That is, it is possible to operate a large number of robots while reducing the number of remote operators, and the operation effect is improved.

### 5. Modification of Second Embodiment of Present Technology

Next, a modification of the second embodiment of the present technology will be described.

For example, the classification of the skills (task execution modules) of the robot 2011 can be changed as appropriate.

For example, after the server 2013 executes the matching processing and controls connection between the robot 2011 that is a remote operation target and the operation terminal 2012 of the remote operator, the robot 2011 and the operation terminal 2012 may directly communicate with each other without the server 2013 to perform the remote operation.

For example, the robot 2011 can execute the matching processing by itself on the basis of the remote operator database or the like and request (the operation terminal 2012 of) the selected remote operator to perform the remote operation. In this case, for example, the robot 2011 may generate the remote operator database, or may acquire the remote operator database from the outside.

The present technology can be applied to an autonomous mobile body that can be remotely operated other than a robot. For example, the present technology can be applied to vehicles such as vehicles and drones that can be operated remotely and autonomously. For example, the present technology can be applied to a manipulator or the like that does not move but can remotely or autonomously move a portion such as a hand.

### 6. Others

### Configuration Example of Computer

The above-described series of processing can be performed by hardware or software. In a case where the series of pieces of processing is performed by software, a program constituting the software is installed in a computer. Here, the computer includes a computer incorporated in dedicated hardware, a general-purpose personal computer capable of executing various functions by installing various programs, and the like, for example.

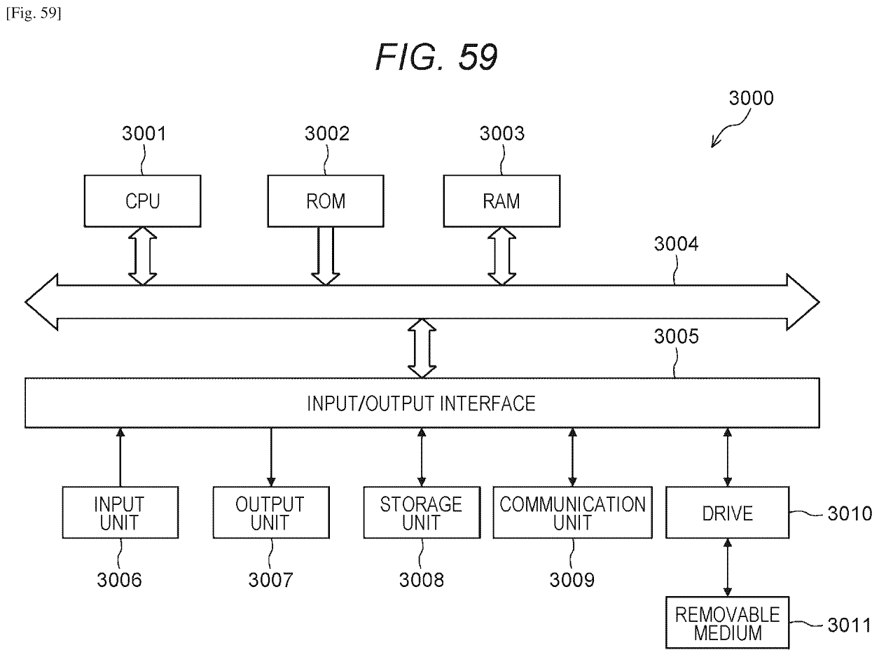

FIG. 59 is a block diagram illustrating a configuration example of hardware of the computer that executes the above-described series of processing by a program.

In a computer 3000, a central processing unit (CPU) 3001, a read only memory (ROM) 3002, and a random-access memory (RAM) 3003 are interconnected via a bus 3004.

An input/output interface 3005 is further connected to the bus 3004. An input unit 3006, an output unit 3007, a storage unit 3008, a communication unit 3009, and a drive 3010 are connected to the input/output interface 3005.

The input unit 3006 includes an input switch, a button, a microphone, an imaging element, and the like. The output unit 3007 includes a display, a speaker, and the like. The storage unit 3008 includes a hard disk, a non-volatile memory, and the like. The communication unit 3009 includes a network interface or the like. The drive 3010 drives a removable medium 3011 such as a magnetic disk, an optical disc, a magnetooptical disk, or a semiconductor memory.

In the computer 3000 configured as described above, the series of processing described above is performed, for example, by the CPU 3001 loading a program stored in the storage unit 3008 into the RAM 3003 via the input/output interface 3005 and the bus 3004, and executing the program.

The program executed by the computer 3000 (CPU 3001) can be provided by being recorded in the removable medium 3011 as a package medium or the like, for example. Furthermore, the program can be provided via a wired or wireless transmission medium such as a local area network, the Internet, or digital satellite broadcasting.

In the computer 3000, by attaching the removable medium 3011 to the drive 3010, the program can be installed in the storage unit 3008 via the input/output interface 3005. Furthermore, the program can be received by the communication unit 3009 via a wired or wireless transmission medium, and installed in the storage unit 3008. In addition, the program can be installed in the ROM 3002 or the storage unit 3008 in advance.

Note that the program executed by the computer may be a program that is processed in time series in the order described in the present specification or a program that is processed in parallel or at necessary timings such as when a call is made.

Furthermore, in the present specification, a system is intended to mean assembly of a plurality of components (devices, modules (parts), and the like) and it does not matter whether or not all the components are in the same casing. Therefore, a plurality of devices housed in separate housings and connected via a network and one device in which a plurality of modules is housed in one housing are both systems.

Moreover, the embodiments of the present technology are not limited to the above-described embodiments, and various modifications can be made without departing from the gist of the present technology.

For example, the present technology may be configured as cloud computing in which a function is shared and processed cooperatively by a plurality of devices through the network.

Furthermore, each step described in the above described flowcharts may be performed by one device or by a plurality of devices in a shared manner.

Moreover, when a plurality of pieces of processing is included in one step, the plurality of pieces of processing included in the one step can be executed by a single device or shared and executed by a plurality of devices.

### Combination Examples of Configurations

The present technology may also have the following configurations.

(1)

An information processing device including:
an action control unit that controls at least one of a provision method or a material of a content to be provided in an application for a nursing care robot to care for a nursing care target person on the basis of target person data including data regarding a characteristic of the target person.
   (2)

The information processing device according to (1), further including
a recognition unit that recognizes a state of the target person,
in which the action control unit controls at least one of the provision method or the material of the content on the further basis of the state of the target person.
   (3)

The information processing device according to (2),
in which the action control unit controls the nursing care robot to interact with the target person before the content is provided,
the recognition unit recognizes a reaction of the target person during the interaction, and
the action control unit controls at least one of the provision method or the material of the content on the further basis of the reaction of the target person during the interaction.
   (4)

The information processing device according to (3),
in which the action control unit controls an interval of the interaction with the target person on the basis of a response time of the target person for an utterance of the nursing care robot.
   (5)

The information processing device according to (4),
in which the utterance of the nursing care robot includes a question for the target person.
   (6)

The information processing device according to any one of (2) to (5),
in which the recognition unit recognizes a reaction of the target person to the content, and
the information processing device further includes a learning unit that learns the characteristic of the target person on the basis of the reaction of the target person to the content.
   (7)

The information processing device according to any one of (2) to (6),
in which the action control unit controls the nursing care robot to output an uttered voice related to the recognized state of the target person before the content is provided.
   (8)

The information processing device according to any one of (1) to (7),
in which the provision method of the content includes at least one of an interval of an interaction with the target person, whether or not conversation with the target person is possible, whether or not body contact of the target person is possible, or a feature amount of an uttered voice, a motion speed, a relative position with respect to the target person, a face orientation, or a line-of-sight direction of the nursing care robot.
   (9)

The information processing device according to (8),
in which the feature amount of the uttered voice includes at least one of a volume, a speed, or a pitch.
   (10)

The information processing device according to any one of (1) to (9),
in which the characteristic of the target person includes a preference of the target person, and
the action control unit controls the material of the content on the basis of the preference of the target person.
   (11)

The information processing device according to any one of (1) to (10),
in which the action control unit performs control in such a way as to use a recorded voice as an uttered voice of the nursing care robot and to use a synthesized voice based on the recorded voice for an appellation of the target person.
   (12)

The information processing device according to (11),
in which the action control unit performs control in such a way as to modulate a tone of an uttered voice of a remote operator who remotely operates the nursing care robot to a tone similar to the recorded voice and output the voice with the modulated tone.
   (13)

The information processing device according to (1), further including
a communication unit that receives the target person data from another information processing device.
   (14)

The information processing device according to (13), further including
a recognition unit that recognizes a feature amount of the target person,
in which the communication unit transmits feature amount information including the feature amount to the another information processing device, and receives the target person data that is searched for on the basis of the feature amount from the another information processing device.
   (15)

A nursing care robot control method including:
controlling at least one of a provision method or a material of a content to be provided in an application for a nursing care robot to care for a nursing care target person on the basis of target person data including data regarding a characteristic of the target person.

Note that the effects described herein are merely examples and are not limited, and other effects may be provided.

It should be understood by those skilled in the art that various modifications, combinations, sub-combinations and alterations may occur depending on design requirements and other factors insofar as they are within the scope of the appended claims or the equivalents thereof.

### REFERENCE SIGNS LIST

11 Nursing care robot
14 Target person
21 Head portion
63L, 63R Hand
91 Hand display
101 Robot operation system
113 Server
114 User database
115 Family database
116 Staff database
201 Distance image sensor
202 Microphone
203 Vital sensor
204 LiDAR
221 Recognition unit
222 Application setting unit
223 Application control unit
224 Action control unit
225 Learning unit
231 Image information processing unit
232 Voice information processing unit
233 Vital information processing unit
234 LiDAR information processing unit
254 Scenario execution control unit
255 Tracking motion control unit
256 Motor drive control unit
257 Voice output control unit
258 Navigation control unit
260 Call communication function control unit
352 Information processing unit
361 Learning unit
362 Search unit
1101R Hand
111lAR to 1111DR, and 1112R Part
1113AR to 1113CR, and 1114R Actuator
1115AR to 1115CR Tactile sensor
1151R Hand
1201R Hand
1211R Part
1212R Pneumatic branching unit
1213AR to 1213CR Pneumatic bending actuator
1214R Exterior
1215R Part
1216R Actuator
1217R Tube
1218R, 1219R Distance sensor
1220R Pneumatic sensor
1301R Hand
1311R, 1312R Part
1351R Hand
1361R Part
1362R Pneumatic bending actuator
1363R Actuator
1401R Hand
1411R, 1412R Gripper
1413R Part
1421R Part
1422R Pneumatic branching unit
1423AR to 1423CR Pneumatic bending actuator
1424R Flexible cover
1425R Tube
1431R Part
1432R Exterior
1433AR to 1433CR Pneumatic bending actuator
1434R Exterior
1435R Tube
1501 Hand display
2001 Remote operation control system
2011-1 to 2011-m Robot
2012-1 to 2012-m Operation terminal
2013 Server
2021 Network
2101 Information processing unit
2102 Input unit
2103 Sensing unit
2104 Communication unit
2111 Action module
2112 Task execution module group
2121 Action planning unit
2122 Action control unit
212.3 Learning unit
231 State recognition unit
2132 Autonomous action control unit
2133 Remote action control unit
2141a Interaction module
2141b Observation module
2141c Work module
2141d Movement module
2151a to 2151d Execution unit
2152a to 2152d Learning unit
2161a Autonomous interaction unit
2161b Autonomous observation unit
2161c Autonomous work unit
2161d Autonomous movement unit
2162a Remote interaction unit
2162b Remote observation unit
2162c Remote work unit
2162d Remote movement unit
2302 Information processing unit
2311 Remote control unit
2312 Matching unit

1. An information processing device comprising:
an action control unit that controls at least one of a provision method or a material of a content to be provided in an application for a nursing care robot to care for a nursing care target person on a basis of target person data including data regarding a characteristic of the target person.

2. The information processing device according to claim 1, further comprising
a recognition unit that recognizes a state of the target person,
wherein the action control unit controls at least one of the provision method or the material of the content on a further basis of the state of the target person.

3. The information processing device according to claim 2,
wherein the action control unit controls the nursing care robot to interact with the target person before the content is provided,
the recognition unit recognizes a reaction of the target person during the interaction, and
the action control unit controls at least one of the provision method or the material of the content on a further basis of the reaction of the target person during the interaction.

4. The information processing device according to claim 3,
wherein the action control unit controls an interval of the interaction with the target person on a basis of a response time of the target person for an utterance of the nursing care robot.

5. The information processing device according to claim 4,
wherein the utterance of the nursing care robot includes a question for the target person.

6. The information processing device according to claim 2,
wherein the recognition unit recognizes a reaction of the target person to the content, and
the information processing device further comprises a learning unit that learns the characteristic of the target person on a basis of the reaction of the target person to the content.

7. The information processing device according to claim 2,
wherein the action control unit controls the nursing care robot to output an uttered voice related to the recognized state of the target person before the content is provided.

8. The information processing device according to claim 1,
wherein the provision method of the content includes at least one of an interval of an interaction with the target person, whether or not conversation with the target person is possible, whether or not body contact of the target person is possible, or a feature amount of an uttered voice, a motion speed, a relative position with respect to the target person, a face orientation, or a line-of-sight direction of the nursing care robot.

9. The information processing device according to claim 8,
wherein the feature amount of the uttered voice includes at least one of a volume, a speed, or a pitch.

10. The information processing device according to claim 1,
wherein the characteristic of the target person includes a preference of the target person, and
the action control unit controls the material of the content on a basis of the preference of the target person.

11. The information processing device according to claim 1,
wherein the action control unit performs control in such a way as to use a recorded voice as an uttered voice of the nursing care robot and to use a synthesized voice based on the recorded voice for an appellation of the target person.

12. The information processing device according to claim 11,
wherein the action control unit performs control in such a way as to modulate a tone of an uttered voice of a remote operator who remotely operates the nursing care robot to a tone similar to the recorded voice and output the voice with the modulated tone.

13. The information processing device according to claim 1, further comprising
a communication unit that receives the target person data from another information processing device.

14. The information processing device according to claim 13, further comprising
a recognition unit that recognizes a feature amount of the target person,
wherein the communication unit transmits feature amount information including the feature amount to the another information processing device, and receives the target person data that is searched for on a basis of the feature amount from the another information processing device.

15. A nursing care robot control method comprising:
controlling at least one of a provision method or a material of a content to be provided in an application for a nursing care robot to care for a nursing care target person on a basis of target person data including data regarding a characteristic of the target person.
